(19) United States
(12) Patent Application Publication
(10) Pub. No.: US 2023/0365774 A1
(43) Pub. Date: Nov. 16, 2023

(54) FOAMABLE THERMOPLASTIC COMPOSITIONS, THERMOPLASTIC FOAMS AND METHODS OF MAKING SAME

(71) Applicant: HONEYWELL INTERNATIONAL INC., Charlotte, NC (US)

(72) Inventors: Hayim Abrevaya, Charlotte, NC (US); Erin Broderick, Charlotte, NC (US); Alexey Kruglov, Charlotte, NC (US); Keith Lehuta, Charlotte, NC (US); Tianyu Liu, Charlotte, NC (US); Rodrigo Lobo, Charlotte, NC (US); David Mackowiak, Charlotte, NC (US); Susie Martins, Charlotte, NC (US); Peter Nickl, Charlotte, NC (US); Mark Triezenberg, Charlotte, NC (US); Bin Yu, Charlotte, NC (US); Syed Hassan Mahmood, Charlotte, NC (US); Rajiv Singh, 300 S. Tryon Street, NC (US); Steven Chmura, Charlotte, NC (US)

(73) Assignee: HONEYWELL INTERNATIONAL INC., Charlotte, NC (US)

(21) Appl. No.: 18/030,080

(22) PCT Filed: Aug. 16, 2022
(86) PCT No.: PCT/US2022/040504

§ 371 Date: Apr. 4, 2023

Related U.S. Application Data
(60) Provisional application No. 63/223,720, filed on Jul. 20, 2021.
(60) Provisional application No. 63/252,110, filed on Oct. 4, 2021.
(60) Provisional application No. 63/278,497, filed on Nov. 12, 2021.

(51) Int. Cl. C08J 9/14; C08G 63/676

(52) U.S. Cl. CPC C08J 9/146; C08G 63/676; C08J 2203/162; C08J 2201/03; C08J 2205/052; C08J 2367/06

(57) ABSTRACT

Low-density, thermoplastic foams comprising: (a) thermoplastic polymer cells comprising cell walls comprising polyethylene furanoate, wherein at least about 50% by volume of the cells are closed cells; and (b) at least HFO-1234ze(E) contained in said closed cells.

### CROSS REFERENCE

This application is related to and incorporates by reference each of: U.S. Provisional Application 63/233,720, filed Aug. 16, 2021; U.S. Provisional Application 63/252,110, filed Oct. 4, 2021; and U.S. Provisional Application 63/278,497, filed Nov. 12, 2021.

### FIELD OF THE INVENTION

This invention relates to foamable thermoplastic compositions, thermoplastic foams, foaming methods, and systems and articles made from same.

### BACKGROUND

While foams are used in a wide variety of applications, developing a foam that has excellent performance properties and is cost-effective to produce is a derisible but difficult goal to achieve. It is even more difficult to achieve this goal while at the same time developing a foam that is environmentally friendly. Producing environmentally friendly foams is especially difficult because they comprise both a blowing agent component and a resin component forming the foam structure, and each of these components has an impact on foam performance and on environmental properties. Environmental considerations include not only the recyclability and sustainability of the polymeric resin that forms the structure of the foam but also the low environmental impact of blowing agents used to form the foam, such as the Global Warming Potential (GWP) and Ozone Depletion Potential (ODP) of the blowing agent. It is therefore a major challenge to develop a foam that simultaneously has excellent performance and can be produced cost-effectively from an environmentally friend blowing agent and an environmentally friendly resin.

Foams based on certain thermoplastic resins, including polyester resins, have been investigated for potential advantage from the perspective of being recyclable and/or sustainably-sourced. However, difficulties have been encountered in connection with the development of such materials. For example, it has been a challenge to develop polyester resins that are truly recyclable, can be produced from sustainable sources, and which are compatible with blowing agents that are able, in combination with the thermoplastic, to produce foams with good performance properties. In many applications the performance properties that are considered highly desirable include the production of high-quality closed cell foams that are low density (and therefore have a low weight in use) and, at the same time, have relatively high mechanical integrity and strength.

With respect to the selection of thermoplastic resin, EP 3,231,836 acknowledges that while there has been interest in thermoplastic resins, in particularly polyester-based resins, this interest has encountered difficulty in development, including difficulty in identifying suitable foaming grades of such resins. Moreover, while EP 3,231,836 notes that certain polyethylene terephthalate (PET) resins, including recycled versions of PET, can be melt-extruded with a suitable physical and/or chemical blowing agent to yield closed-cell foams with the potential for low density and good mechanical properties, it is not disclosed that any such resins are at once are able to produce foams with good environmental properties and good performance properties, and are also able to be formed from sustainable sources. The '836 application identifies several possible polyester resins to be used in the formation of open-celled foams, including polyethylene terephthalate, poly butylene terephthalate, poly cyclohexane terephthalate, polyethylene naphthalate, polyethylene furanoate or a mixture of two or more of these. While the use of polyester materials to make foams that have essentially no closed cells, as required by EP '836, may be beneficial for some applications, a disadvantage of such structures is that, in general, open cell foams will exhibit relatively poor mechanical strength properties.

While plastics based on 2,5-furandicarboxylic-acid-based polyester have been noted to have some potential advantages in certain applications, such as having good gas barrier properties, there has also been a recognition of substantial problems with forming foam materials from such plastic materials. For example, CN108410000 teaches that 2,5-furandicarboxylic-acid-based polyesters have foaming performance that is very poor and processing conditions that are extremely unfavorable. These problems are said to be addressed by using a glassy (i.e., amorphous) polymer sheet and then exposing the sheet to a special, relatively complex and cumbersome dual blowing agent process.

The process described in CN108410000 suffers from several disadvantages, including requiring an undesirably long processing time to produce the specialized, treated preform and the use of a relatively complicated dual blowing agent process. This process is also highly disadvantageous in that it is not readily adaptable for use in connection with currently used commercial extrusion equipment, thus having an undesirably high new capital cost requirement to implement.

CN 108484959 also recognizes that 2,5-furandicarboxylic-acid-based polyesters (such as PEF) have poor foamability and attempts to address this significant problem by forming a high melt viscosity polymer by blend-reacting 2,5-furandicarboxylic acid ethylene glycol ester with a multifunctional monomer selected from alcohols, esters, alkanes, carboxylic acids and anhydrides. Foaming properties of this material are said to be improved relative to PEF, but no information on the foaming process is provided.

US 2020/0308363 and US 2020/0308396 each disclose the production of amorphous polyester copolymers that comprise starting with a recycled polyester, of which only PET is exemplified, as the main component and then proceeding through a series of processing steps to achieve an amorphous co-polymer, that is, as copolymer having no crystallinity. These publications indicate that it is not possible to readily form low density polyester foams from crystalline or semi-crystalline polymers and indicates that this problem can be solved by forming amorphous copolyester polymer material and using such amorphous material to form the foam. The synthesis of poly(ethylene furanoate) (PEF) using ethylene glycol and 2,5-furandicarboxylic acid is mentioned but is not exemplified. Essentially amorphous (i.e., no crystallinity as per 0 J/G ΔH before foaming) ternary copolymers formed from PET, polytrimethylene furanoate and polycarbonate are said to have been foamed using CO₂ as the blowing agent. No foam properties are disclosed. A wide variety of different classes of blowing agent are mentioned for use with amorphous polymers generally, including CO₂, HFO-1233zd, cyclopentane, acetone and methanol.

U.S. Pat. No. 9,790,342 discloses foams formed from the polyphenolic tannin, which may be combined with a large number of possible monomers, and among the list of monomers is 2,5-furandicarboxylic acid. The foams are said to be partially open cell and partially closed cell, with open cell content being less than 50%. Numerous potential blowing agents are disclosed, including the halogenated olefin HFO-1336mmz.

With respect to blowing agents, the use generally of halogenated olefin blowing agents, including hydrofluoroolefins (HFOs) and hydrochlorofluorolefins (HCFOs), for several specific thermoplastic foams is known, as disclosed for example in US 2009/0305876, which is assigned to the assignee of the present invention, and which is incorporated herein by reference. While the '876 application discloses the use of HFO and HFCO blowing agents with various thermoplastic materials to form foams, including PET, there is no disclosure or suggestion to use any of such blowing agents with any other type of polyester resin.

Applicants have overcome the problem of forming a high performance foam that is also has favorable environmental features (i.e., high sustainability and low atmospheric impact) and in so doing have come to appreciate that these problems can be overcome and that one or more unexpected advantages can be achieved by the formation of thermoplastic foams, and in particular extruded thermoplastic foams, using a polyester resin as disclosed herein in combination with a blowing agent comprising one of more hydrohaloolefin as disclosed herein.

### SUMMARY

As described above, a continuing need exists for polymeric materials, and particularly polymeric foams, that are sustainable and environmentally friendly, and simultaneously a continuing need exists for such polymeric foams that at once are able to provide low density and high strength. Such a combination of properties is especially important in many applications which require a foam that has a low weight for a given volume (i.e., has low density) but are required to provide strength in use. One example of such a use is in connection with the construction of wind turbine blades, where both light weight and high strength are important, and in such applications sustainability and environment friendliness are also both very important. As outlined above, for example, prior efforts to address this need have encountered a myriad of technical problems and deficiencies, and a fully acceptable solution has heretofore not been achieved.

The present invention satisfies one or more of the above noted needs and overcomes prior technical problems and includes low-density, thermoplastic foam comprising:
(a) thermoplastic polymer cells comprising cell walls comprising polyethylene furanoate having a crystallinity of at least 15%, wherein at least 25% of said cells are closed cells; and
(b) one or more HFOs having three or four carbon atoms and/or one or more HFCOs having three or four carbon atoms contained in the closed cells.
   For the purposes of convenience, foams in accordance with this paragraph are referred to herein as Foam 1A.

The present invention includes low-density, thermoplastic foam comprising:
(a) thermoplastic polymer cells comprising cell walls comprising polyethylene furanoate having a crystallinity of at least 15%, wherein at least 25% by volume of said cells are closed cells; and
(b) one or more HFOs having three or four carbon atoms and/or one or more HFCOs having three or four carbon atoms contained in the closed cells, provided that 1336mzz is not contained in the closed cells.
   For the purposes of convenience, foams in accordance with this paragraph are referred to herein as Foam 1B.

The present invention includes low-density, thermoplastic foam comprising:
(a) thermoplastic polymer cells comprising cell walls comprising polyethylene furanoate having a crystallinity of at least 15%, wherein at least 25% by volume of said cells are closed cells; and
(b) one or more HFOs having three or four carbon atoms and/or one or more HFCOs having three or four carbon atoms contained in the closed cells, provided that 1233zd is not contained in the closed cells.
   For the purposes of convenience, foams in accordance with this paragraph are referred to herein as Foam 1C.

The present invention includes low-density, thermoplastic foam comprising:
(a) thermoplastic polymer cells comprising cell walls comprising polyethylene furanoate having a crystallinity of at least 15%, wherein at least 15% by volume of said cells are closed cells and wherein ethylene furanoate moieties are at least 85% by weight of the thermoplastic polymer; and
(b) one or more HFOs having three or four carbon atoms and/or one or more HFCOs having three or four carbon atoms contained in the closed cells.
   For the purposes of convenience, foams in accordance with this paragraph are referred to herein as Foam 1D.

Reference will be made at various locations herein to a numbered foam (e.g., Foam 1) or to group of numbered foams that have been defined herein, and such reference means each of such numbered systems, including each system having a number within the group, including any suffixed numbered system. For example, reference to Foam 1 includes a separate reference to each of Foams 1A, 1B, 1C and 1D, and reference to Foams 1-2 is understood to include a separate reference to each of Foams 1A, 1B, 1C, 1D, 2A, 2B, 2C, 2D, 2E and 2F. Further, this convention is used throughout the present specification for other defined materials, including Blowing Agents.

The present invention includes low-density, thermoplastic foam comprising:
(a) thermoplastic polymer cells comprising cell walls comprising polyethylene furanoate wherein at least 25% of said cells are closed cells; and
(b) 1234ze(E) contained in the closed cells.
   For the purposes of convenience, foams in accordance with this paragraph are referred to herein as Foam 2A.

The present invention includes low-density, thermoplastic foam comprising:
(a) thermoplastic polymer cells comprising cell walls comprising polyethylene furanoate having a crystallinity of at least 15%, wherein at least 25% of said cells are closed cells; and
(b) 1234ze(E) contained in the closed cells.
   For the purposes of convenience, foams in accordance with this paragraph are referred to herein as Foam 2B.

The present invention includes low-density, thermoplastic foam comprising:
(a) thermoplastic polymer cells comprising cell walls comprising polyethylene furanoate having a crystallinity of at least 35%, wherein at least 50% of said cells are closed cells; and
(b) gas in said closed cell, wherein said gas comprises 1234ze(E).
   For the purposes of convenience, foams in accordance with this paragraph are referred to herein as Foam 2C.

The present invention includes low-density, thermoplastic foam comprising:
(a) thermoplastic polymer cells comprising cell walls comprising polyethylene furanoate having a crystallinity of at least 35%, wherein at least 50% of said cells are closed cells; and
(b) gas in said closed cell, wherein said gas comprises from about 25% by weight to 100% by weight of 1234ze(E). For the purposes of convenience, foams in accordance with this paragraph are referred to herein as Foam 2D.

The present invention includes low-density, thermoplastic foam comprising:
(a) thermoplastic polymer cells comprising cell walls comprising polyethylene furanoate having a crystallinity of at least 35%, wherein at least 50% of said cells are closed cells; and
(b) gas in said closed cell, wherein said gas comprises 1234ze(E) and at least one co-blowing agent. For the purposes of convenience, foams in accordance with this paragraph are referred to herein as Foam 2E.

The present invention includes low-density, thermoplastic foam comprising:
(a) thermoplastic polymer cells comprising cell walls comprising polyethylene furanoate having a crystallinity of at least 35%, wherein at least 50% of said cells are closed cells; and
(b) gas in said closed cell, wherein said gas consists essentially of 1234ze(E). For the purposes of convenience, foams in accordance with this paragraph are referred to herein as Foam 2F.

The present invention includes low-density, thermoplastic foam comprising:
(a) thermoplastic polymer cells comprising cell walls comprising polyethylene furanoate having a crystallinity of at least 15% wherein at least about 50% by volume of the cells are closed cells and wherein ethylene furanoate moieties are at least 85% by weight of the thermoplastic polymer; and
(b) one or more HFOs having three or four carbon atoms and/or one or more HFCOs having three or four carbon atoms contained in the closed cells.
   For the purposes of convenience, foams in accordance with this paragraph are referred to herein as Foam 3A.

The present invention includes low-density, thermoplastic foam comprising:
(a) thermoplastic polymer cells comprising cell walls comprising polyethylene furanoate that has a crystallinity of at least 15% and a molecular weight of from about 25,000 to about 170,000, wherein at least about 25% by volume of the cells are closed cells; and
(b) one or more HFOs having three or four carbon atoms and/or one or more HFCOs having three or four carbon atoms contained in the closed cells.
   For the purposes of convenience, foams in accordance with this paragraph are referred to herein as Foam 3B.

The present invention includes low-density, thermoplastic foam comprising:
(a) thermoplastic polymer cells comprising cell walls comprising polyethylene furanoate having a crystallinity of at least 15% and a molecular weight of from about 80,000 to about 170,000, wherein at least about 25% by volume of the cells are closed cells; and
(b) one or more HFOs having three or four carbon atoms and/or one or more HFCOs having three or four carbon atoms contained in the closed cells.
   For the purposes of convenience, foams in accordance with this paragraph are referred to herein as Foam 3C.

The present invention includes low-density, thermoplastic foam comprising:
(a) thermoplastic polymer cells comprising cell walls comprising polyethylene furanoate having a crystallinity of at least 25% and a molecular weight of from about 80,000 to about 170,000, wherein from about 35% by volume to about 90% by volume of the cells are closed cells; and
(b) one or more HFOs having three or four carbon atoms and/or one or more HFCOs having three or four carbon atoms contained in the closed cells.
   For the purposes of convenience, foams in accordance with this paragraph are referred to herein as Foam 3D.

The present invention includes low-density, thermoplastic foam comprising:
(a) thermoplastic polymer cells comprising cell walls comprising polyethylene furanoate having a crystallinity of from about 35% to about 65% and a molecular weight of from about 80,000 to about 170,000, wherein from about 35% by volume to about 90% by volume of the cells are closed cells; and
(b) one or more HFOs having three or four carbon atoms and/or one or more HFCOs having three or four carbon atoms contained in the closed cells.
   For the purposes of convenience, foams in accordance with this paragraph are referred to herein as Foam 3E.

The present invention includes low-density, closed-cell thermoplastic foam comprising:
(a) closed thermoplastic cells comprising cell walls comprising polyethylene furanoate and
(b) a blowing agent contained in said closed cells, wherein said foam has a relative foam density (RFD) of about 0.1 or less and a foam density of less than 0.3 g/cc. For the purposes of convenience, foams in accordance with this paragraph are referred to herein as Foam 4A.

As used herein, the term “relative foam density,” and its abbreviation “RFD” mean the density of the foam divided by the density of the polymer used to form the foam.

The present invention includes low-density, closed-cell thermoplastic foam comprising:
(a) closed thermoplastic cells comprising cell walls consisting essentially of polyethylene furanoate that has been treated with a chain extender; and
(b) a blowing agent contained in said closed cells,
   wherein said foam has an RFD of about 0.1 or less and a density of less than 0.3 g/cc. For the purposes of convenience, foams in accordance with this paragraph are referred to herein as Foam 4B.

The present invention includes low-density, closed-cell thermoplastic foam comprising:
(a) thermoplastic polymer cells comprising cell walls forming closed cells, wherein said thermoplastic comprises polyethylene furanoate-based polymer having a crystallinity of at least about 15% and a molecular weight of greater than 25,000; and
(b) blowing agent contained in said closed cells, said blowing agent comprising 1234ze(E). For the purposes of convenience, foams in accordance with this paragraph are referred to herein as Foam 5A.

The present invention includes low-density, closed-cell thermoplastic foam comprising:
(a) thermoplastic polymer cells comprising cell walls forming closed cells, wherein said thermoplastic comprises polyethylene furanoate-based polymer having a crystallinity of at least about 25% and a molecular weight of from about 25,000 to about 170,000; and
(b) blowing agents contained in said closed cells, said blowing agent comprising 1234ze(E). For the purposes of convenience, foams in accordance with this paragraph are referred to herein as Foam 5B.

The present invention includes low-density, closed-cell thermoplastic foam comprising:
(a) closed thermoplastic cells comprising cell walls consisting essentially of polyethylene furanoate; and
(b) trans-1234ze contained in said closed cells,
   wherein said foam has a density of less than 0.3 g/cc. For the purposes of convenience, foams in accordance with this paragraph are referred to herein as Foam 6A.

The present invention includes closed-cell thermoplastic foam comprising:
(a) closed thermoplastic cells comprising cells walls consisting essentially of polyethylene furanoate wherein at least about 50% by volume of the cells are closed cells; and
(b) 1234ze(E) contained in said closed cells. For the purposes of convenience, foams in accordance with this paragraph are referred to herein as Foam 6B.

The present invention includes closed-cell thermoplastic foam comprising:
(a) closed thermoplastic cells comprising cells walls consisting essentially of polyethylene furanoate wherein at least about 75% by volume of the cells are closed cells; and
(b) 1234ze(E) contained in said closed cells. For the purposes of convenience, foams in accordance with this paragraph are referred to herein as Foam 6C.

The present invention includes closed-cell thermoplastic foam comprising:
(a) closed thermoplastic cells comprising cells walls consisting essentially of polyethylene furanoate wherein at least about 90% by volume of the cells are closed cells; and
(b) 1234ze(E) contained in said closed cells. For the purposes of convenience, foams in accordance with this paragraph are referred to herein as Foam 6D.

The present invention also provides the foamable compositions, foaming methods and additional foams as described hereinafter.

### BRIEF DESCRIPTION OF THE DRAWING

FIG. 1 is a schematic representation of an extrusion system and process according to one embodiment of the invention and according to the examples herein.

FIG. 2 is an SEM of the foam of Example 4.

### DEFINITIONS

1234ze means 1,1,1,3-tetrafluoropropene, without limitation as to isomeric form.
Trans1234ze and 1234ze(E) each means trans1,3,3,3-tetrafluoropropene.
Cis1234ze and 1234ze(Z) each means cis1,3,3,3-tetrafluoropropene.
1234yf means 2,3,3,3-tetrafluoropropene.
1233zd means 1-chloro-3,3,3-trifluoropropene, without limitation as to isomeric form.
Trans1233zd and 1233zd(E) each means trans1-chloro-3,3,3-trifluoropropene.
1224yd means 1-chloro-2,3,3,3-tetrafluoropropane, without limitation as to isomeric form.
cis1224yd and 1224yd(Z) means cis1-chloro-2,3,3,3-tetrafluoropropane.
1336mzz means 1,1,1,4,4,4-hexafluorobutene, without limitation as to isomeric form.
Trans1336mzz and 1336mzz(E) each means trans1,1,1,4,4,4-hexafluorobutene.
Cis1336mzz and 1336mzz(Z) each means cis1,1,1,4,4,4-hexafluorobutene.
Closed cell foam means that a substantial volume percentage of the cells in the foam are closed, for example, about 20% by volume or more.
Crystallinity means the degree of crystallinity of a polymer measured by differential scanning calorimetry (DSC) according to ASTM D3418 and ASTM E1356.
Ethylene furanoate moiety means the following structure:

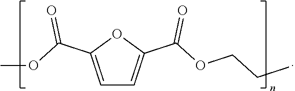

FDCA means 2,5-furandicarboxylic acid and has the following structure:

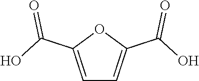 [SMILES: O=C(O)c1ccc(C(=O)O)o1]

FDME means dimethyl 2,5-furandicarboxylate and has the following structure:

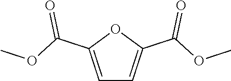

MEG means monoethylene glycol and has the following structure:

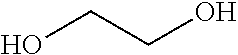

Moiety as used herein means a distinct repeating unit in a polymer. For clarity, a copolymer having two repeating units A and B present in a 1:1 ratio would have 50 molar % A moieties and 50 molar % of B moieties.
Other Moiety as used herein means a moiety that is not ethylene furanoate and not formed from tannin.
Methylal means dimethoxymethane ((CH3O)2CH2).
PEF homopolymer means a polymer consisting of ethylene furanoate moieties. For avoidance of doubt, the PEF homopolymer may include impurity levels of materials that may be present.
PEF copolymer means a polymer having at least 50% by weight of ethylene furanoate moieties and some amount a moiety other than ethylene furanoate moieties.
PEF means poly (ethylene furanoate) and encompasses and is intended to reflect a description of PEF homopolymer and PEF coploymer.
SSP means solid-state polymerization.
PMDA means pyromellitic dianhydride having the following structure:

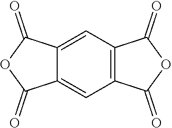 [SMILES: O=c1oc(=O)c2cc3c(=O)oc(=O)c3cc12]

Relative foam density and its abbreviation “RFD” mean the density of the foam divided by the density of the polymer used to form the foam.
Tannin moiety as used herein means a polymeric repeating unit corresponding to the tannin used to form the polymer, including as disclosed in U.S. Pat. No. 9,890,342.

### DETAILED DESCRIPTION

### Poly (Ethylene Furanoate)

The present invention relates to foams and foam articles that comprise cell walls that comprise PEF.

The PEF which forms the cells walls of the foams and foam articles of the present invention can be PEF homopolymer or PEF copolymer.

PEF homopolymer is a known material that is known to be formed by either: (a) esterification and polycondensation of FDCA with MEG; or (b) transesterification and polycondensation of FDME with MEG as illustrated below for example:

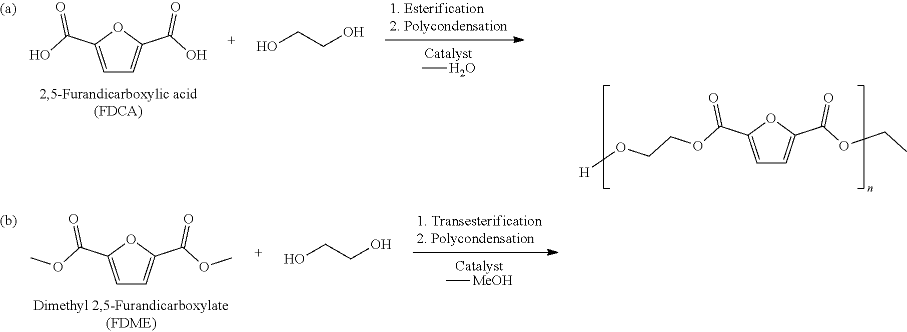

A detailed description of such known esterification and polycondensation synthesis methods is provided in GB Patent 621971 (Drewitt, J. G. N., and Lincocoln, J., entitled “Improvements in Polymers”), which is incorporated herein by reference. A detailed description of such known transesterification and polycondensation synthesis methods is provided in Gandini, A., Silvestre, A. J. D., Neto, C. P., Sousa, A. F., and Gomes, M. (2009), “The furan counterpart of poly(ethylene terephthalate): an alternative material based on renewable resources.”, J. Polym. Sci. Polym. Chem. 47, 295-298. doi: 10.1002/pola.23130, which is incorporated herein by reference.

### Foams

The foams of the present invention are formed from either PEF homopolymers, PEF copolymers, or a combination/mixture of these.

The foams may be formed in preferred embodiments from PEF homopolymer in which the polymer has at least 99.5% by weight, or at least 99.9% of by weight, of ethylene furanoate moieties.

It is contemplated that the foams may be formed in preferred embodiments from PEF copolymer in which the polymer, including PEF copolymer that has from about 60% to about 99% by weight of ethylene furanoate moieties, or from about 70% to about 99% by weight of ethylene furanoate moieties, or from about 80% to about 99% by weight of ethylene furanoate moieties, or from about 90% to about 99% by weight of ethylene furanoate moieties or from about 95% to about 99.5% by weight of ethylene furanoate moieties.

For those embodiments of the present invention involving PEF copolymers, it is contemplated that those skilled in the art will be able, in view of the teachings contained herein, to select the type and amount of co-polymeric materials to be used within each of the ranges described herein to achieve the desired enhancement/modification of the polymer without undue experimentation.

For those embodiments of the present invention involving the use of PEF homopolymer or PEF copolymer, it is contemplated that such material may be formed with a wide variety of molecular weights and physical properties within the scope of the present invention. In preferred embodiments, the foams, including each of Foams 1-6, are formed from PEF having the ranges of characteristics identified in Table 1 below, which are measured as described in the Examples hereof:

TABLE 1

| | | Intermediate | |
|---|---|---|---|
| Polymer property | Broad Range | Range | Narrow Range |
| Molecular weight | 25,000-150,000 | 45,000-130,000 | 55,000-120,000 |
| Glass Transition Temperature, T_{g}, ° C. | 75-100 | 75-95 | 75-95 |
| Melting Temperature, Tₘ, ° C. | 180-250 | 190-240 | 200-230 |
| Decomposition Temperature, T_{d}, ° C. | 300-420 | 320-400 | 330-380 |
| Crystallinity, % | 25-75 | 30-60 | 40-50 |

In general, it is contemplated that those skilled in the art will be able to formulate PEF polymers within the range of properties described above without undue experimentation in view of the teachings contained herein. In preferred embodiments, however, PEF in general and PEF homopolymer in particular having these properties is achieved using one or more of the synthesis methods described above, in combination with a variety of known supplemental processing techniques, including by treatment with chain extenders, such as PMDA, and/or SSP processing. It is believed that, in view of the disclosures contained herein, including the polymer synthesis described in the Examples below, a person skilled in the art will be able to produce PEF polymers within the range of characteristics described in the table above and elsewhere herein.

An example of the process for chain extension treatment of polyesters is provided in the article “Recycled poly(ethylene terephthalate) chain extension by a reactive extrusion process,” Firas Awaja, Fugen Daver, Edward Kosior, 16 Aug. 2004, available at https://doi.org/10.1002/pen.20155, which is incorporated herein by reference. As explained in US 1009/0264545, which is incorporated herein by reference, chain extenders generally are typically compounds that are at least di-functional with respect to reactive groups which can react with end groups or functional groups in the polyester to extend the length of the polymer chains. In certain cases, as disclosed herein, such a treatment can advantageously increases the average molecular weight of the polyester to improve its melt strength and/or other important properties. The degree of chain extension achieved is related, at least in part, to the structure and functionalities of the compounds used. Various compounds are useful as chain extenders. Non-limiting examples of chain extenders include trimellitic anhydride, pyromellitic dianhydride (PMDA), trimellitic acid, haloformyl derivatives thereof, or compounds containing multi-functional epoxy (e.g., glycidyl), or oxazoline functional groups. Nanocomposite material such as finely dispersed nanoclay may optionally be used for controlling viscosity. Commercial chain extenders include CESA-Extend from Clariant, Joncryl from BASF, or

Lotader from Arkema. The amount of chain extender can vary depending on the type and molecular weight of the polyester components. The amount of chain extender used to treat the polymer can vary widely, and in preferred embodiments ranges from about 0.1 to about 5 wt. %, or preferably from about 0.1 to about 1.5 wt. %. Examples of chain extenders are also described in U.S. Pat. No. 4,219,527, which is incorporated herein by reference.

An example of the process for SSP processing of poly(ethylene furanoate) is provided in the article “Solid-State Polymerization of Poly(ethylene furanoate) Biobased Polyester, I: Effect of Catalyst Type on Molecular Weight Increase,” Nejib Kasmi, Mustapha Majdoub, George Z. Papageorgiou, Dimitris S. Achilias, and Dimitrios N. Bikiaris, which is incorporated herein by reference.

The PEF thermoplastic polymers which are especially advantageous for making foamable compositions and foams of the present invention are identified in the following Thermoplastic Polymer Table (Table 2), wherein all numerical values in the table are understood to be preceded by the word “about.”

TABLE 2
THERMOPLASTIC POLYMER TABLE

| | Ethylene | | | | |
|---|---|---|---|---|---|
| Thermoplastic | furanoate | Tannin | Other | | Crystal- |
| Polymer (TPP) | moieties, | moieties, | moieties, | MW, | linity, |
| Number | wt % | wt % | wt % | Kg/mol | % |
| TPP1A | 100 | 0 | 0 | 25-180 | 25-100 |
| TPP1B | 100 | 0 | 0 | 25-75 | 30-60 |
| TPP1C | 100 | 0 | 0 | 80-130 | 30-60 |
| TPP1D | 100 | 0 | 0 | 90-120 | 35-50 |
| TPP1E | 100 | 0 | 0 | 90-110 | 35-45 |
| TPP2A | 85 to <100 | >0 to <15 | 10 | 25-180 | 25-100 |
| TPP2B | 85 to <100 | >0 to <15 | 10 | 25-75 | 30-60 |
| TPP2C | 85 to <100 | >0 to <15 | 10 | 80-130 | 30-60 |
| TPP2D | 85 to <100 | >0 to <15 | 0 | 90-120 | 35-50 |
| TPP2E | 85 to <100 | >0 to <15 | 0 | 90-110 | 35-45 |
| TPP3A | 5 to 95 | 0 | 5 to 95 | 25-180 | 25-100 |
| TPP3B | 5 to 95 | 10 | 5 to 95 | 25-75 | 30-60 |
| TPP3C | 5 to 95 | 0 | 5 to 95 | 80-130 | 30-60 |
| TPP3D | 5 to 95 | 0 | 5 to 95 | 90-120 | 35-50 |
| TPP3E | 5 to 95 | 10 | 5 to 95 | 90-110 | 35-45 |
| TPP4A | 5 to 95 | >0-<15 | 5 to 95 | 25-180 | 25-100 |
| TPP4B | 5 to 95 | >0-<15 | 5 to 95 | 25-75 | 30-60 |
| TPP4C | 5 to 95 | >0-<15 | 5 to 95 | 80-130 | 30-60 |
| TPP4D | 5 to 95 | >0-<15 | 5 to 95 | 90-120 | 35-50 |
| TPP4E | 5 to 95 | >0-<15 | 5 to 95 | 90-110 | 35-45 |
| TPP5A | 10 | 0 | 90 | 25-180 | 25-100 |
| TPP5B | 10 | 10 | 190 | 25-75 | 30-60 |
| TPP5C | 10 | 0 | 90 | 80-130 | 30-60 |
| TPP5D | 10 | 0 | 190 | 90-120 | 35-50 |
| TPP5E | 10 | 0 | 190 | 90-110 | 35-45 |
| TPP6A | 90 | 0 | 10 | 25-180 | 25-100 |
| TPP6B | 90 | 10 | 10 | 25-75 | 30-60 |
| TPP6C | 90 | 0 | 10 | 80-130 | 30-60 |
| TPP6D | 90 | 0 | 10 | 90-120 | 35-50 |
| TPP6E | 90 | 0 | 10 | 90-110 | 35-45 |

For the purposes of definition of terms used herein, it is to be noted that reference will be made at various locations herein to the thermoplastic polymers identified in the first column in each of rows in the TPP table above, and reference to each of these numbers is a reference to a thermoplastic polymer as defined in the corresponding columns of that row. Reference to a group of TPPs that have been defined in the table above by reference to a TPP number means separately and individually each such numbered TPP, including each TPP having the indicated number, including any such number that has a suffix. So for example, reference to TPP1 is a separate and independent reference to TPP1A, TPP1B, TPP1C, TPP1D and TPP1E. Reference to TPP1-TPP2 is a separate and independent reference to TPP1A, TPP1B, TPP1C, TPP1D, TTP1E, TPP2A, TPP2B, TPP2C, TPP2D and TPP1E. This use convention is used for the Foamable Composition Table and the Foam Table below as well.

### Blowing Agent

As explained in detail herein, the present invention includes, but is not limited to, applicant's discovery that a select group of blowing agents are capable of providing foamable PEF foamable compositions and PEF foams having a difficult-to-achieve and surprising combination of physical properties, including low density as well as good mechanical strength properties.

The blowing agent used in accordance with the present invention preferably comprises one or more hydrohaloolefins having three or four carbon atoms. For the purposes of convenience, a blowing agent in accordance with this paragraph is sometimes referred to herein as Blowing Agent 1.

The blowing agent used in accordance with of the present invention preferably comprises one or more of 1234ze, 1234yf, 1336mzz, 1233zd and 1224ydf (referred to hereinafter for convenience as Blowing Agent 2); or comprises one or more of trans1234ze, 1336mzz, trans1233zd and cis1224yd (referred to hereinafter for convenience as Blowing Agent 3); or comprises one or more of trans1234ze, trans1336mzz, trans1233zd and cis1224yd (referred to hereinafter for convenience as Blowing Agent 4); or comprises one or more of trans1234ze and trans1336mzz (referred to hereinafter for convenience as Blowing Agent 5); or comprises trans1234ze (referred to hereinafter for convenience as Blowing Agent 6); or comprises trans1336mzz (referred to hereinafter for convenience as Blowing Agent 7); or comprises cis1336mzz (referred to hereinafter for convenience as Blowing Agent 8); or comprises 1234yf (referred to hereinafter for convenience as Blowing Agent 9); or comprises 1224yd (referred to hereinafter for convenience as Blowing Agent 10); or comprises trans1233zd (referred to hereinafter for convenience as Blowing Agent 11).

It is thus contemplated that the blowing agent of the present invention, including each of Blowing Agents 1-11, can include, in addition to each of the above-identified blowing agent(s), co-blowing agent including in one or more of the optional potential co-blowing agents as described below. In preferred embodiments, the present foamable compositions, foams, and foaming methods include a blowing agent as described according described herein, wherein the indicated blowing agent (including the compound or group of compound(s) specifically identified in each of Blowing Agent 1-11) is present in an amount, based upon the total weight of all blowing agent present, of at least about 50% by weight, or preferably at least about 60% by weight, preferably at least about 70% by weight, or preferably at least about 80% by weight, or preferably at least about 90% by weight, or preferably at least about 95% by weight, or preferably at least about 99% by weight, based on the total of all blowing agent components.

The blowing agent used in accordance with of the present invention also preferably consists essentially of one or more of 1234ze, 1234yf, 1336mzz, 1233zd and 1224ydf (referred to hereinafter for convenience as Blowing Agent 12); or consists essentially of one or more of trans1234ze, 1336mzz, trans1233zd and cis1224yd (referred to hereinafter for convenience as Blowing Agent 13); or consists essentially of one or more of trans1234ze, trans1336mzz, trans1233zd and cis1224yd (referred to hereinafter for convenience as Blowing Agent 14); or consists essentially of one or more of trans1234ze and trans1336mzz (referred to hereinafter for convenience as Blowing Agent 15); or consists essentially of trans1234ze (referred to hereinafter for convenience as Blowing Agent 16); or consists essentially of trans1336mzz (referred to hereinafter for convenience as Blowing Agent 17); or consists essentially of cis1336mzz (referred to hereinafter for convenience as Blowing Agent 18); or consists essentially of 1234yf (referred to hereinafter for convenience as Blowing Agent 19); or consists essentially of 1224yd (referred to hereinafter for convenience as Blowing Agent 20); or consists essentially of trans1233zd (referred to hereinafter for convenience as Blowing Agent 21).

It is contemplated and understood that blowing agent of the present invention, including each of Blowing Agents 1-21, can include one or more co-blowing agents which are not included in the indicated selection, provided that such co-blowing agent in the amount used does not interfere with or negate the ability to achieve relatively low-density foams as described herein, including each of Foams 1-6, and preferably further does not interfere with or negate the ability to achieve foam with mechanical strengths properties as described herein. It is contemplated, therefore, that given the teachings contained herein a person of skill in the art will be able to select, by way of example, one or more of the following potential co-blowing agents for use with a particular application without undue experimentation: one or more saturated hydrocarbons or hydrofluorocarbons (HFCs), particularly C4-C6 hydrocarbons or C1-C4 HFCs, that are known in the art. Examples of such HFC co-blowing agents include, but are not limited to, one or a combination of difluoromethane (HFC-32), fluoroethane (HFC-161), difluoroethane (HFC-152), trifluoroethane (HFC-143), tetrafluoroethane (HFC-134), pentafluoroethane (HFC-125), pentafluoropropane (HFC-245), hexafluoropropane (HFC-236), heptafluoropropane (HFC-227ea), pentafluorobutane (HFC-365), hexafluorobutane (HFC-356) and all isomers of all such HFC's. With respect to hydrocarbons, the present blowing agent compositions also may include in certain preferred embodiments, for example, iso, normal and/or cyclopentane and butane and/or isobutane. Other materials, such as water, CO₂, CFCs (such as trichlorofluoromethane (CFC-11) and dichlorodifluoromethane (CFC-12)), hydrochlorocarbons (HCCs such as dichloroethylene (preferably trans-dichloroethylene), ethyl chloride and chloropropane), HCFCs, C1-C5 alcohols (such as, for example, ethanol and/or propanol and/or butanol), C1-C4 aldehydes, C1-C4 ketones, C1-C4 ethers (including ethers (such as dimethyl ether and diethyl ether), diethers (such as dimethoxy methane and diethoxy methane)), and methyl formate, organic acids (such as but not limited to formic acid), including combinations of any of these may be included, although such components are not necessarily preferred in many embodiments due to negative environmental impact.

The blowing agent used in accordance with the present invention also preferably consists of one or more of 1234ze, 1234yf, 1336mzz, 1233zd and 1224ydf (referred to hereinafter for convenience as Blowing Agent 22); or consists of one or more of trans1234ze, 1336mzz, trans1233zd and cis1224yd (referred to hereinafter for convenience as Blowing Agent 23); or consists of one or more of trans1234ze, trans1336mzz, trans1233zd and cis1224yd (referred to hereinafter for convenience as Blowing Agent 24); or consists of one or more of trans1234ze and trans1336mzz (referred to hereinafter for convenience as Blowing Agent 25); or consists of trans1234ze (referred to hereinafter for convenience as Blowing Agent 26); or consists of trans1336mzz (referred to hereinafter for convenience as Blowing Agent 27); or consists of cis1336mzz (referred to hereinafter for convenience as Blowing Agent 28); or consists of 1234yf (referred to hereinafter for convenience as Blowing Agent 29); or consists of 1224yd (referred to hereinafter for convenience as Blowing Agent 30); or consists of trans1233zd (referred to hereinafter for convenience as Blowing Agent 31).

### Foams and Foaming Process

The foams of the present invention may generally be formed from a foamable composition of the present invention. In general, the foamable compositions of the present invention may be formed by combining a PEF polymer with a blowing agent of the present invention, including each of Blowing Agents 1-31.

Foamable compositions that are included within the present invention and which provide particular advantage in connection with forming the foams of the present invention, are described in the following Foamable Composition Table (Table 3), in which all numerical values in the table are understood to be preceded by the word “about” and in which the following terms used in the table have the following meanings:

CBAG1 means co-blowing agent selected from the group consisting of 1336mzz(Z), 1336mzzm(E), 1224yd(Z), 1233zd(E), 1234yf and combinations of two or more of these.

CBAG2 means co-blowing agent selected from the group consisting of water, CO₂, C1-C6 hydrocarbons (HCs) HCFCs, C1-C5 HFCs, C2-C4 hydrohaloolefins, C1-C5 alcohols, C1-C4 aldehydes, C1-C4 ketones, C1-C4 ethers, C1-C4 esters, organic acids and combinations of two or more of these.

CCBAG3 means co-blowing agent selected from the group consisting of water, CO₂, isobutane, n-butane, isopentane, cyclopentane, cyclohexane, trans-dichloroethylene, ethanol, propanol, butanol, acetone, dimethyl ether, diethyl ether, dimethoxy methane, diethoxy methane, methyl formate, difluoromethane (HFC-32), fluoroethane (HFC-161), 1,1-difluoroethane (HFC-152a), trifluoroethane (HFC-143), 1,1,1,2-tetrafluoroethane (HFC-134a), pentafluoroethane (HFC-125), pentafluoropropane (HFC-245), hexafluoropropane (HFC-236), heptafluoropropane (HFC-227ea), pentafluorobutane (HFC-365), hexafluorobutane (HFC-356), and combinations of any two or more of these.

NR means not required.

TABLE 3
FOAMABLE COMPOSITION TABLE

| | Foamable Composition Components | | | | |
|---|---|---|---|---|---|
| | | Blowing Agent(s) and Amounts, wt % of | | | |
| | | All Blowing Agents | | | |
| Foamable | | Blowing | | Co Blowing | |
| Composition | Polymer, | Agent 1 | Wt % | Agent(s) | Wt % |
| Number | TPP No. | (BA1) | BA1 | (CB) | CB |
| FC1A1 | TPP1A | 1234ze(E) | 100 | NR | 0 |
| FC1B1 | TPP1B | 1234ze(E) | 100 | NR | 0 |
| FC1C1 | TPP1C | 1234ze(E) | 100 | NR | 0 |
| FC1D1 | TPP1D | 1234ze(E) | 100 | NR | 0 |
| FC1E1 | TPP1E | 1234ze(E) | 100 | NR | 0 |
| FC1A2 | TPP2A | 1234ze(E) | 100 | NR | 0 |
| FC1B2 | TPP2B | 1234ze(E) | 100 | NR | 0 |
| FC1C2 | TPP2C | 1234ze(E) | 100 | NR | 0 |
| FC1D2 | TPP2D | 1234ze(E) | 100 | NR | 0 |
| FC1E2 | TPP2E | 1234ze(E) | 100 | NR | 0 |
| FC1A3 | TPP3A | 1234ze(E) | 100 | NR | 0 |
| FC1B3 | TPP3B | 1234ze(E) | 100 | NR | 0 |
| FC1C3 | TPP3C | 1234ze(E) | 100 | NR | 0 |
| FC1D3 | TPP3D | 1234ze(E) | 100 | NR | 0 |
| FC1E3 | TPP3E | 1234ze(E) | 100 | NR | 0 |
| FC1A4 | TPP4A | 1234ze(E) | 100 | NR | 0 |
| FC1B4 | TPP4B | 1234ze(E) | 100 | NR | 0 |
| FC1C4 | TPP4C | 1234ze(E) | 100 | NR | 0 |
| FC1D4 | TPP4D | 1234ze(E) | 100 | NR | 0 |
| FC1E4 | TPP4E | 1234ze(E) | 100 | NR | 0 |
| FC1A5 | TPP5A | 1234ze(E) | 100 | NR | 0 |
| FC1B5 | TPP5B | 1234ze(E) | 100 | NR | 0 |
| FC1C5 | TPP5C | 1234ze(E) | 100 | NR | 0 |
| FC1D5 | TPP5D | 1234ze(E) | 100 | NR | 0 |
| FC1E5 | TPP5E | 1234ze(E) | 100 | NR | 0 |
| FC1A6 | TPP6A | 1234ze(E) | 100 | NR | 0 |
| FC1B6 | TPP6B | 1234ze(E) | 100 | NR | 0 |
| FC1C6 | TPP6C | 1234ze(E) | 100 | NR | 0 |
| FC1D6 | TPP6D | 1234ze(E) | 100 | NR | 0 |
| FC1E6 | TPP6E | 1234ze(E) | 100 | NR | 0 |
| FC2A1 | TPP1A | 1234ze(E) | 5-95 | CBAG1 | 5-95 |
| FC2B1 | TPP1B | 1234ze(E) | 5-95 | CBAG1 | 5-95 |
| FC2C1 | TPP1C | 1234ze(E) | 5-95 | CBAG1 | 5-95 |
| FC2D1 | TPP1D | 1234ze(E) | 5-95 | CBAG1 | 5-95 |
| FC2E1 | TPP1E | 1234ze(E) | 5-95 | CBAG1 | 5-95 |
| FC2A2 | TPP2A | 1234ze(E) | 5-95 | CBAG1 | 5-95 |
| FC2B2 | TPP2B | 1234ze(E) | 5-95 | CBAG1 | 5-95 |
| FC2C2 | TPP2C | 1234ze(E) | 5-95 | CBAG1 | 5-95 |
| FC2D2 | TPP2D | 1234ze(E) | 5-95 | CBAG1 | 5-95 |
| FC2E2 | TPP2E | 1234ze(E) | 5-95 | CBAG1 | 5-95 |
| FC2A3 | TPP3A | 1234ze(E) | 5-95 | CBAG1 | 5-95 |
| FC2B3 | TPP3B | 1234ze(E) | 5-95 | CBAG1 | 5-95 |
| FC2C3 | TPP3C | 1234ze(E) | 5-95 | CBAG1 | 5-95 |
| FC2D3 | TPP3D | 1234ze(E) | 5-95 | CBAG1 | 5-95 |
| FC2E3 | TPP3E | 1234ze(E) | 5-95 | CBAG1 | 5-95 |
| FC2A4 | TPP4A | 1234ze(E) | 5-95 | CBAG1 | 5-95 |
| FC2B4 | TPP4B | 1234ze(E) | 5-95 | CBAG1 | 5-95 |
| FC2C4 | TPP4C | 1234ze(E) | 5-95 | CBAG1 | 5-95 |
| FC2D4 | TPP4D | 1234ze(E) | 5-95 | CBAG1 | 5-95 |
| FC2E4 | TPP4E | 1234ze(E) | 5-95 | CBAG1 | 5-95 |
| FC2A5 | TPP5A | 1234ze(E) | 5-95 | CBAG1 | 5-95 |
| FC2B5 | TPP5B | 1234ze(E) | 5-95 | CBAG1 | 5-95 |
| FC2C5 | TPP5C | 1234ze(E) | 5-95 | CBAG1 | 5-95 |
| FC2D5 | TPP5D | 1234ze(E) | 5-95 | CBAG1 | 5-95 |
| FC2E5 | TPP5E | 1234ze(E) | 5-95 | CBAG1 | 5-95 |
| FC2A6 | TPP6A | 1234ze(E) | 5-95 | CBAG1 | 5-95 |
| FC2B6 | TPP6B | 1234ze(E) | 5-95 | CBAG1 | 5-95 |
| FC2C6 | TPP6C | 1234ze(E) | 5-95 | CBAG1 | 5-95 |
| FC2D6 | TPP6D | 1234ze(E) | 5-95 | CBAG1 | 5-95 |
| FC2E6 | TPP6E | 1234ze(E) | 5-95 | CBAG1 | 5-95 |
| FC3A1 | TPP1A | 1234ze(E) | 5-95 | CBAG2 | 5-95 |
| FC3B1 | TPP1B | 1234ze(E) | 5-95 | CBAG2 | 5-95 |
| FC3C1 | TPP1C | 1234ze(E) | 5-95 | CBAG2 | 5-95 |
| FC3D1 | TPP1D | 1234ze(E) | 5-95 | CBAG2 | 5-95 |
| FC3E1 | TPP1E | 1234ze(E) | 5-95 | CBAG2 | 5-95 |
| FC3A2 | TPP2A | 1234ze(E) | 5-95 | CBAG2 | 5-95 |
| FC3B2 | TPP2B | 1234ze(E) | 5-95 | CBAG2 | 5-95 |
| FC3C2 | TPP2C | 1234ze(E) | 5-95 | CBAG2 | 5-95 |
| FC3D2 | TPP2D | 1234ze(E) | 5-95 | CBAG2 | 5-95 |
| FC3E2 | TPP2E | 1234ze(E) | 5-95 | CBAG2 | 5-95 |
| FC3A3 | TPP3A | 1234ze(E) | 5-95 | CBAG2 | 5-95 |
| FC3B3 | TPP3B | 1234ze(E) | 5-95 | CBAG2 | 5-95 |
| FC3C3 | TPP3C | 1234ze(E) | 5-95 | CBAG2 | 5-95 |
| FC3D3 | TPP3D | 1234ze(E) | 5-95 | CBAG2 | 5-95 |
| FC3E3 | TPP3E | 1234ze(E) | 5-95 | CBAG2 | 5-95 |
| FC3A4 | TPP4A | 1234ze(E) | 5-95 | CBAG2 | 5-95 |
| FC3B4 | TPP4B | 1234ze(E) | 5-95 | CBAG2 | 5-95 |
| FC3C4 | TPP4C | 1234ze(E) | 5-95 | CBAG2 | 5-95 |
| FC3D4 | TPP4D | 1234ze(E) | 5-95 | CBAG2 | 5-95 |
| FC3E4 | TPP4E | 1234ze(E) | 5-95 | CBAG2 | 5-95 |
| FC3A5 | TPP5A | 1234ze(E) | 5-95 | CBAG2 | 5-95 |
| FC3B5 | TPP5B | 1234ze(E) | 5-95 | CBAG2 | 5-95 |
| FC3C5 | TPP5C | 1234ze(E) | 5-95 | CBAG2 | 5-95 |
| FC3D5 | TPP5D | 1234ze(E) | 5-95 | CBAG2 | 5-95 |
| FC3E5 | TPP5E | 1234ze(E) | 5-95 | CBAG2 | 5-95 |
| FC3A6 | TPP6A | 1234ze(E) | 5-95 | CBAG2 | 5-95 |
| FC3B6 | TPP6B | 1234ze(E) | 5-95 | CBAG2 | 5-95 |
| FC3C6 | TPP6C | 1234ze(E) | 5-95 | CBAG2 | 5-95 |
| FC3D6 | TPP6D | 1234ze(E) | 5-95 | CBAG2 | 5-95 |
| FC3E6 | TPP6E | 1234ze(E) | 5-95 | CBAG2 | 5-95 |
| FC4A1 | TPP1A | 1234ze(E) | 5-95 | CBAG3 | 5-95 |
| FC4B1 | TPP1B | 1234ze(E) | 5-95 | CBAG3 | 5-95 |
| FC4C1 | TPP1C | 1234ze(E) | 5-95 | CBAG3 | 5-95 |
| FC4D1 | TPP1D | 1234ze(E) | 5-95 | CBAG3 | 5-95 |
| FC4E1 | TPP1E | 1234ze(E) | 5-95 | CBAG3 | 5-95 |
| FC4A2 | TPP2A | 1234ze(E) | 5-95 | CBAG3 | 5-95 |
| FC4B2 | TPP2B | 1234ze(E) | 5-95 | CBAG3 | 5-95 |
| FC4C2 | TPP2C | 1234ze(E) | 5-95 | CBAG3 | 5-95 |
| FC4D2 | TPP2D | 1234ze(E) | 5-95 | CBAG3 | 5-95 |
| FC4E2 | TPP2E | 1234ze(E) | 5-95 | CBAG3 | 5-95 |
| FC4A3 | TPP3A | 1234ze(E) | 5-95 | CBAG3 | 5-95 |
| FC4B3 | TPP3B | 1234ze(E) | 5-95 | CBAG3 | 5-95 |
| FC4C3 | TPP3C | 1234ze(E) | 5-95 | CBAG3 | 5-95 |
| FC4D3 | TPP3D | 1234ze(E) | 5-95 | CBAG3 | 5-95 |
| FC4E3 | TPP3E | 1234ze(E) | 5-95 | CBAG3 | 5-95 |
| FC4A4 | TPP4A | 1234ze(E) | 5-95 | CBAG3 | 5-95 |
| FC4B4 | TPP4B | 1234ze(E) | 5-95 | CBAG3 | 5-95 |
| FC4C4 | TPP4C | 1234ze(E) | 5-95 | CBAG3 | 5-95 |
| FC4D4 | TPP4D | 1234ze(E) | 5-95 | CBAG3 | 5-95 |
| FC4E4 | TPP4E | 1234ze(E) | 5-95 | CBAG3 | 5-95 |
| FC4A5 | TPP5A | 1234ze(E) | 5-95 | CBAG3 | 5-95 |
| FC4B5 | TPP5B | 1234ze(E) | 5-95 | CBAG3 | 5-95 |
| FC4C5 | TPP5C | 1234ze(E) | 5-95 | CBAG3 | 5-95 |
| FC4D5 | TPP5D | 1234ze(E) | 5-95 | CBAG3 | 5-95 |
| FC4E5 | TPP5E | 1234ze(E) | 5-95 | CBAG3 | 5-95 |
| FC4A6 | TPP6A | 1234ze(E) | 5-95 | CBAG3 | 5-95 |
| FC4B6 | TPP6B | 1234ze(E) | 5-95 | CBAG3 | 5-95 |
| FC4C6 | TPP6C | 1234ze(E) | 5-95 | CBAG3 | 5-95 |
| FC4D6 | TPP6D | 1234ze(E) | 5-95 | CBAG3 | 5-95 |
| FC4E6 | TPP6E | 1234ze(E) | 5-95 | CBAG3 | 5-95 |
| FC5A1 | TPP1A | 1234ze(E) | 5-95 | cyclopentane | 5-95 |
| FC5B1 | TPP1B | 1234ze(E) | 5-95 | cyclopentane | 5-95 |
| FC5C1 | TPP1C | 1234ze(E) | 5-95 | cyclopentane | 5-95 |
| FC5D1 | TPP1D | 1234ze(E) | 5-95 | cyclopentane | 5-95 |
| FC5E1 | TPP1E | 1234ze(E) | 5-95 | cyclopentane | 5-95 |
| FC5A2 | TPP2A | 1234ze(E) | 5-95 | cyclopentane | 5-95 |
| FC5B2 | TPP2B | 1234ze(E) | 5-95 | cyclopentane | 5-95 |
| FC5C2 | TPP2C | 1234ze(E) | 5-95 | cyclopentane | 5-95 |
| FC5D2 | TPP2D | 1234ze(E) | 5-95 | cyclopentane | 5-95 |
| FC5E2 | TPP2E | 1234ze(E) | 5-95 | cyclopentane | 5-95 |
| FC5A3 | TPP3A | 1234ze(E) | 5-95 | cyclopentane | 5-95 |
| FC5B3 | TPP3B | 1234ze(E) | 5-95 | cyclopentane | 5-95 |
| FC5C3 | TPP3C | 1234ze(E) | 5-95 | cyclopentane | 5-95 |
| FC5D3 | TPP3D | 1234ze(E) | 5-95 | cyclopentane | 5-95 |
| FC5E3 | TPP3E | 1234ze(E) | 5-95 | cyclopentane | 5-95 |
| FC5A4 | TPP4A | 1234ze(E) | 5-95 | cyclopentane | 5-95 |
| FC5B4 | TPP4B | 1234ze(E) | 5-95 | cyclopentane | 5-95 |
| FC5C4 | TPP4C | 1234ze(E) | 5-95 | cyclopentane | 5-95 |
| FC5D4 | TPP4D | 1234ze(E) | 5-95 | cyclopentane | 5-95 |
| FC5E4 | TPP4E | 1234ze(E) | 5-95 | cyclopentane | 5-95 |
| FC5A5 | TPP5A | 1234ze(E) | 5-95 | cyclopentane | 5-95 |
| FC5B5 | TPP5B | 1234ze(E) | 5-95 | cyclopentane | 5-95 |
| FC5C5 | TPP5C | 1234ze(E) | 5-95 | cyclopentane | 5-95 |
| FC5D5 | TPP5D | 1234ze(E) | 5-95 | cyclopentane | 5-95 |
| FC5E5 | TPP5E | 1234ze(E) | 5-95 | cyclopentane | 5-95 |
| FC5A6 | TPP6A | 1234ze(E) | 5-95 | cyclopentane | 5-95 |
| FC5B6 | TPP6B | 1234ze(E) | 5-95 | cyclopentane | 5-95 |
| FC5C6 | TPP6C | 1234ze(E) | 5-95 | cyclopentane | 5-95 |
| FC5D6 | TPP6D | 1234ze(E) | 5-95 | cyclopentane | 5-95 |
| FC5E6 | TPP6E | 1234ze(E) | 5-95 | cyclopentane | 5-95 |
| FC6A1 | TPP1A | 1234ze(E) | 5-95 | HFC-134a | 5-95 |
| FC6B1 | TPP1B | 1234ze(E) | 5-95 | HFC-134a | 5-95 |
| FC6C1 | TPP1C | 1234ze(E) | 5-95 | HFC-134a | 5-95 |
| FC6D1 | TPP1D | 1234ze(E) | 5-95 | HFC-134a | 5-95 |
| FC6E1 | TPP1E | 1234ze(E) | 5-95 | HFC-134a | 5-95 |
| FC6A2 | TPP2A | 1234ze(E) | 5-95 | HFC-134a | 5-95 |
| FC6B2 | TPP2B | 1234ze(E) | 5-95 | HFC-134a | 5-95 |
| FC6C2 | TPP2C | 1234ze(E) | 5-95 | HFC-134a | 5-95 |
| FC6D2 | TPP2D | 1234ze(E) | 5-95 | HFC-134a | 5-95 |
| FC6E2 | TPP2E | 1234ze(E) | 5-95 | HFC-134a | 5-95 |
| FC6A3 | TPP3A | 1234ze(E) | 5-95 | HFC-134a | 5-95 |
| FC6B3 | TPP3B | 1234ze(E) | 5-95 | HFC-134a | 5-95 |
| FC6C3 | TPP3C | 1234ze(E) | 5-95 | HFC-134a | 5-95 |
| FC6D3 | TPP3D | 1234ze(E) | 5-95 | HFC-134a | 5-95 |
| FC6E3 | TPP3E | 1234ze(E) | 5-95 | HFC-134a | 5-95 |
| FC6A4 | TPP4A | 1234ze(E) | 5-95 | HFC-134a | 5-95 |
| FC6B4 | TPP4B | 1234ze(E) | 5-95 | HFC-134a | 5-95 |
| FC6C4 | TPP4C | 1234ze(E) | 5-95 | HFC-134a | 5-95 |
| FC6D4 | TPP4D | 1234ze(E) | 5-95 | HFC-134a | 5-95 |
| FC6E4 | TPP4E | 1234ze(E) | 5-95 | HFC-134a | 5-95 |
| FC6A5 | TPP5A | 1234ze(E) | 5-95 | HFC-134a | 5-95 |
| FC6B5 | TPP5B | 1234ze(E) | 5-95 | HFC-134a | 5-95 |
| FC6C5 | TPP5C | 1234ze(E) | 5-95 | HFC-134a | 5-95 |
| FC6D5 | TPP5D | 1234ze(E) | 5-95 | HFC-134a | 5-95 |
| FC6E5 | TPP5E | 1234ze(E) | 5-95 | HFC-134a | 5-95 |
| FC6A6 | TPP6A | 1234ze(E) | 5-95 | HFC-134a | 5-95 |
| FC6B6 | TPP6B | 1234ze(E) | 5-95 | HFC-134a | 5-95 |
| FC6C6 | TPP6C | 1234ze(E) | 5-95 | HFC-134a | 5-95 |
| FC6D6 | TPP6D | 1234ze(E) | 5-95 | HFC-134a | 5-95 |
| FC6E6 | TPP6E | 1234ze(E) | 5-95 | HFC-134a | 5-95 |
| FC7A1 | TPP1A | 1234ze(E) | 5-95 | CO₂ | 5-95 |
| FC7B1 | TPP1B | 1234ze(E) | 5-95 | CO₂ | 5-95 |
| FC7C1 | TPP1C | 1234ze(E) | 5-95 | CO₂ | 5-95 |
| FC7D1 | TPP1D | 1234ze(E) | 5-95 | CO₂ | 5-95 |
| FC7E1 | TPP1E | 1234ze(E) | 5-95 | CO₂ | 5-95 |
| FC7A2 | TPP2A | 1234ze(E) | 5-95 | CO₂ | 5-95 |
| FC7B2 | TPP2B | 1234ze(E) | 5-95 | CO₂ | 5-95 |
| FC7C2 | TPP2C | 1234ze(E) | 5-95 | CO₂ | 5-95 |
| FC7D2 | TPP2D | 1234ze(E) | 5-95 | CO₂ | 5-95 |
| FC7E2 | TPP2E | 1234ze(E) | 5-95 | CO₂ | 5-95 |
| FC7A3 | TPP3A | 1234ze(E) | 5-95 | CO₂ | 5-95 |
| FC7B3 | TPP3B | 1234ze(E) | 5-95 | CO₂ | 5-95 |
| FC7C3 | TPP3C | 1234ze(E) | 5-95 | CO₂ | 5-95 |
| FC7D3 | TPP3D | 1234ze(E) | 5-95 | CO₂ | 5-95 |
| FC7E3 | TPP3E | 1234ze(E) | 5-95 | CO₂ | 5-95 |
| FC7A4 | TPP4A | 1234ze(E) | 5-95 | CO₂ | 5-95 |
| FC7B4 | TPP4B | 1234ze(E) | 5-95 | CO₂ | 5-95 |
| FC7C4 | TPP4C | 1234ze(E) | 5-95 | CO₂ | 5-95 |
| FC7D4 | TPP4D | 1234ze(E) | 5-95 | CO₂ | 5-95 |
| FC7E4 | TPP4E | 1234ze(E) | 5-95 | CO₂ | 5-95 |
| FC7A5 | TPP5A | 1234ze(E) | 5-95 | CO₂ | 5-95 |
| FC7B5 | TPP5B | 1234ze(E) | 5-95 | CO₂ | 5-95 |
| FC7C5 | TPP5C | 1234ze(E) | 5-95 | CO₂ | 5-95 |
| FC7D5 | TPP5D | 1234ze(E) | 5-95 | CO₂ | 5-95 |
| FC7E5 | TPP5E | 1234ze(E) | 5-95 | CO₂ | 5-95 |
| FC7A6 | TPP6A | 1234ze(E) | 5-95 | CO₂ | 5-95 |
| FC7B6 | TPP6B | 1234ze(E) | 5-95 | CO₂ | 5-95 |
| FC7C6 | TPP6C | 1234ze(E) | 5-95 | CO₂ | 5-95 |
| FC7D6 | TPP6D | 1234ze(E) | 5-95 | CO₂ | 5-95 |
| FC7E6 | TPP6E | 1234ze(E) | 5-95 | CO₂ | 5-95 |
| FC8A1 | TPP1A | 1234ze(E) | 5-95 | 1233zd(E) | 5-95 |
| FC8B1 | TPP1B | 1234ze(E) | 5-95 | 1233zd(E) | 5-95 |
| FC8C1 | TPP1C | 1234ze(E) | 5-95 | 1233zd(E) | 5-95 |
| FC8D1 | TPP1D | 1234ze(E) | 5-95 | 1233zd(E) | 5-95 |
| FC8E1 | TPP1E | 1234ze(E) | 5-95 | 1233zd(E) | 5-95 |
| FC8A2 | TPP2A | 1234ze(E) | 5-95 | 1233zd(E) | 5-95 |
| FC8B2 | TPP2B | 1234ze(E) | 5-95 | 1233zd(E) | 5-95 |
| FC8C2 | TPP2C | 1234ze(E) | 5-95 | 1233zd(E) | 5-95 |
| FC8D2 | TPP2D | 1234ze(E) | 5-95 | 1233zd(E) | 5-95 |
| FC8E2 | TPP2E | 1234ze(E) | 5-95 | 1233zd(E) | 5-95 |
| FC8A3 | TPP3A | 1234ze(E) | 5-95 | 1233zd(E) | 5-95 |
| FC8B3 | TPP3B | 1234ze(E) | 5-95 | 1233zd(E) | 5-95 |
| FC8C3 | TPP3C | 1234ze(E) | 5-95 | 1233zd(E) | 5-95 |
| FC8D3 | TPP3D | 1234ze(E) | 5-95 | 1233zd(E) | 5-95 |
| FC8E3 | TPP3E | 1234ze(E) | 5-95 | 1233zd(E) | 5-95 |
| FC8A4 | TPP4A | 1234ze(E) | 5-95 | 1233zd(E) | 5-95 |
| FC8B4 | TPP4B | 1234ze(E) | 5-95 | 1233zd(E) | 5-95 |
| FC8C4 | TPP4C | 1234ze(E) | 5-95 | 1233zd(E) | 5-95 |
| FC8D4 | TPP4D | 1234ze(E) | 5-95 | 1233zd(E) | 5-95 |
| FC8E4 | TPP4E | 1234ze(E) | 5-95 | 1233zd(E) | 5-95 |
| FC8A5 | TPP5A | 1234ze(E) | 5-95 | 1233zd(E) | 5-95 |
| FC8B5 | TPP5B | 1234ze(E) | 5-95 | 1233zd(E) | 5-95 |
| FC8C5 | TPP5C | 1234ze(E) | 5-95 | 1233zd(E) | 5-95 |
| FC8D5 | TPP5D | 1234ze(E) | 5-95 | 1233zd(E) | 5-95 |
| FC8E5 | TPP5E | 1234ze(E) | 5-95 | 1233zd(E) | 5-95 |
| FC8A6 | TPP6A | 1234ze(E) | 5-95 | 1233zd(E) | 5-95 |
| FC8B6 | TPP6B | 1234ze(E) | 5-95 | 1233zd(E) | 5-95 |
| FC8C6 | TPP6C | 1234ze(E) | 5-95 | 1233zd(E) | 5-95 |
| FC8D6 | TPP6D | 1234ze(E) | 5-95 | 1233zd(E) | 5-95 |
| FC8E6 | TPP6E | 1234ze(E) | 5-95 | 1233zd(E) | 5-95 |

### Foam Forming Methods

It is contemplated that any one or more of a variety of known techniques for forming a thermoplastic foam can be used in view of the disclosures contained herein to form a foam of the present invention, including each of Foams 1-6 and each of foams F1-F8, and all such techniques and all foams formed thereby or within the broad scope of the present invention. For clarity, it will be noted that definition of the foams in the Table below all begin with only the letter F, in contrast to the foams defined by the paragraphs in the summary above, which begin with the capitalized word Foam.

In general, the forming step involves first introducing into a PEF polymer of the present invention, including each of TPP1-TPP6, a blowing agent of the present invention, including each of Blowing Agents 1-31, to form a foamable PEF composition comprising PEF and blowing agent. One example of a preferred method for forming a foamable PEF composition of the present invention is to plasticize the PEF, preferably comprising heating the PEF to its melt temperature, preferably above its melt temperature, and thereafter exposing the PEF melt to the blowing agent under conditions effective to incorporate (preferably by solubilizing) the desired amount of blowing agent into the polymer melt.

In preferred embodiments, the foaming methods of the present invention comprise providing a foamable composition of the present invention, including each of FC1-FC8 and foaming the provided foamable composition. In preferred embodiments, the foaming methods of the present invention comprising providing a foamable composition of the present invention, including each of FC1-FC8, and extruding the provided foamable composition to form a foam of the present invention, including each of Foams 1-6 and each of foams F1-F8.

Foaming processes of the present invention can include batch, semi-batch, continuous processes, and combinations of two or more of these. Batch processes generally involve preparation of at least one portion of the foamable polymer composition, including each of FC1-FC8, in a storable state and then using that portion of foamable polymer composition at some future point in time to prepare a foam. Semi-batch process involves preparing at least a portion of a foamable polymer composition, including each of FC1-FC8, and intermittently expanding that foamable polymer composition into a foam including each of Foams 1-6 and each of foams F1-F8, all in a single process. For example, U.S. Pat. No. 4,323,528, herein incorporated by reference, discloses a process for making thermoplastic foams via an accumulating extrusion process. The present invention thus includes processes that comprises: 1) mixing PEF thermoplastic polymer, including each of TPP1-TPP6, and a blowing agent of the present invention, including each of Blowing Agents 1-31, under conditions to form a foamable PEF composition; 2) extruding the foamable PEF composition, including each of FC1-FC8, into a holding zone maintained at a temperature and pressure which does not allow the foamable composition to foam, where the holding zone preferably comprises a die defining an orifice opening into a zone of lower pressure at which the foamable polymer composition, including each of FC1-FC8, foams and an openable gate closing the die orifice; 3) periodically opening the gate while substantially concurrently applying mechanical pressure by means of a movable ram on the foamable polymer composition, including each of FC1-FC8, to eject it from the holding zone through the die orifice into the zone of lower pressure, and 4) allowing the ejected foamable polymer composition to expand, under the influence of the blowing agent, to form the foam, including each of Foams 1-6 and each of foams F1-F8.

The present invention also can use continuous processes for forming the foam. By way of example such a continuous process involves forming a foamable PEF composition, including each of FC1-FC8, and then expanding that foamable PEF composition without substantial interruption. For example, a foamable PEF composition, including each of FC1-FC8, may be prepared in an extruder by heating the selected PEF polymer resin, including each of TPP1-TPP6, to form a PEF melt, incorporating into the PEF melt a blowing agent of the present invention, including each of Blowing Agents 1-31, preferably by solubilizing the blowing agent into the PEF melt, at an initial pressure to form a foamable PEF composition comprising a substantially homogeneous combination of PEF and blowing agent, including each of FC1-FC8, and then extruding that foamable PEF composition through a die into a zone at a selected foaming pressure and allowing the foamable PEF composition to expand into a foam, including each of Foams 1-6 and each of foams F1-F8 described below, under the influence of the blowing agent. Optionally, the foamable PEF composition which comprises the PEF polymer, including each of FC1-FC8, and the incorporated blowing agent, including each of Blowing Agents 1-31, may be cooled prior to extruding the composition through the die to enhance certain desired properties of the resulting foam, including each of Foams 1-6 and each of foams F1-F8.

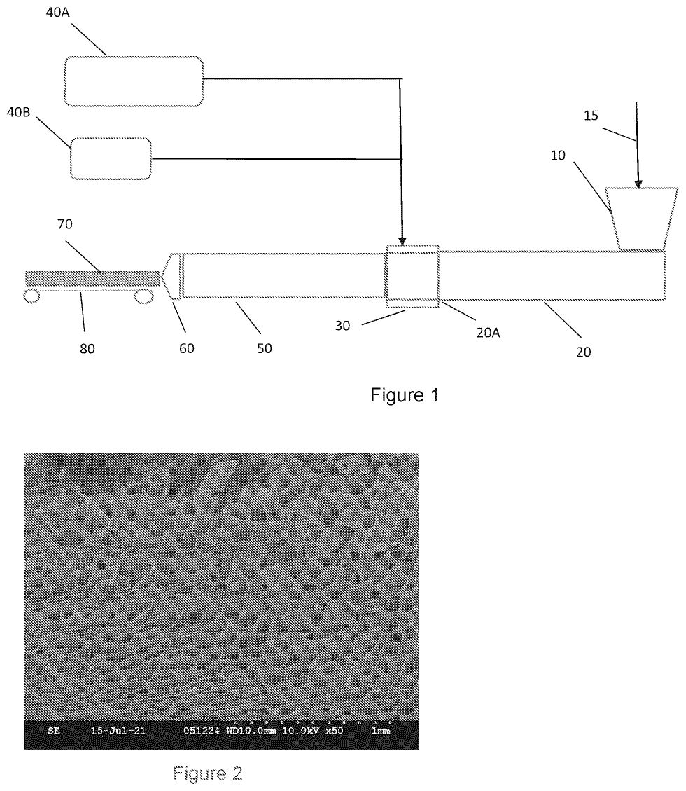

The methods can be carried out, by way of example, using extrusion equipment of the general type disclosed in FIG. 1. In particular, the extrusion apparatus can include a raw material feed hopper 10 for holding the PEF polymer 15 of the present invention, including each of TPP1-TPP6, and one or more optional components (which may be added with the PEF in the hopper or optionally elsewhere in the process depending on the particular needs of the user). The feed materials 15, excluding the blowing agent, can be charged to the hopper and delivered to the screw extruder 10. The extruder 20 can include thermocouples (not shown) located at three points along the length thereof and a pressure sensor (not shown) at the discharge end 20A of the extruder. A mixer section 30 can be located at the discharge end 20A of the extruder for receiving blowing agent components of the present invention, including each of Blowing Agents 1-31, via one or more metering pumps 40A and 40B and mixing those blowing agents into the PEF melt in the mixer section. Sensors (not shown) can be included for monitoring the temperature and pressure of the mixer section 30. The mixer section 30 can then discharge the foamable composition melt of the present invention, including each of FC1-FC8, into a pair of melt coolers 50 oriented in series, with temperature sensors (not shown) located in each cooler to monitor the melt temperature. The melt is then extruded through a die 60, which also had temperature and pressure sensors (not shown) for monitoring the pressure and temperature at the die. The die pressure and temperature can be varied, according to the needs of each particular extrusion application to produce a foam 70 of the present invention, including each of including each of Foams 1-6 and each of foams F1-F8 described below. The foam can then be carried away from the extrusion equipment by a conveyor belt 80.

The foamable polymer compositions of the present invention, including each of FC1-FC8, may optionally contain additional additives such as nucleating agents, cell-controlling agents, glass and carbon fibers, dyes, pigments, fillers, antioxidants, extrusion aids, stabilizing agents, antistatic agents, fire retardants, IR attenuating agents and thermally insulating additives. Nucleating agents include, among others, materials such as talc, calcium carbonate, sodium benzoate, and chemical blowing agents such azodicarbonamide or sodium bicarbonate and citric acid. IR attenuating agents and thermally insulating additives can include carbon black, graphite, silicon dioxide, metal flake or powder, among others. Flame retardants can include, among others, brominated materials such as hexabromocyclodecane and polybrominated biphenyl ether. Each of the above-noted additional optional additives can be introduced into the foam at various times and that various locations in the process according to known techniques, and all such additives and methods of addition or within the broad scope of the present invention.

### Foams

In preferred embodiments, the foams of the present invention are formed in a commercial extrusion apparatus and have the properties as indicated in the following Table 4, with the values being measured as described in the Examples hereof:

TABLE 4

| | | First | Second | First | Second |
|---|---|---|---|---|---|
| | Broad | Intermediate | Intermediate | Narrow | Narrow |
| Foam property | Range | Range | Range | Range | Range |
| Foam density, g/cc (ISO 845) | 0.05-.16 | .06-0.14 | .06-0.14 | 0.06-0.11 | 0.06-0.11 |
| Compressive Strength | 0.5-2.5 | 0.6-1.5 | 0.9-2.3 | 0.6-1.1 | 0.9-1.7 |
| (perpendicular to the | | | | | |
| plane) (ISO 844), Mpa | | | | | |
| Tensile strength perpendicular | 1.0-6.2 | 1.2-3.7 | 1.8-5.6 | 1.2-3.1 | 1.8-4.7 |
| to the plane (ASTM C297), Mpa | | | | | |
| Average Cell Size, (SEM) | 10-200 | 20-150 | 20-150 | 20-100 | 20-100 |

Foams that are included within the present invention and which provide particular advantage are described in the following Table 5, and in which all numerical values in the table are understood to be preceded by the word “about” and in which the designation NR means “not required.”

TABLE 5
FOAM TABLE

| | | Foam Properties | | | |
|---|---|---|---|---|---|
| | | | | | Tensile |
| | Foamable | | | Compressive | Strength, |
| | Compo- | % | | Strength, | ((ASTM |
| Foam | sition, | Closed | Density, | (ISO 844), | C297), |
| Number | No. | Cell | g/cc³ | megapascal | megapascal |
| F1A1A | FC1A1 | >25 | NR | NR | NR |
| F1B1A | FC1B1 | >25 | NR | NR | NR |
| F1C1A | FC1C1 | >25 | NR | NR | NR |
| F1D1A | FC1D1 | >25 | NR | NR | NR |
| F1E1A | FC1E1 | >25 | NR | NR | NR |
| F1A2A | FC1A2 | >25 | NR | NR | NR |
| F1B2A | FC1B2 | >25 | NR | NR | NR |
| F1C2A | FC1C2 | >25 | NR | NR | NR |
| F1D2A | FC1D2 | >25 | NR | NR | NR |
| F1E2A | FC1E2 | >25 | NR | NR | NR |
| F1A3A | FC1A3 | >25 | NR | NR | NR |
| F1B3A | FC1B3 | >25 | NR | NR | NR |
| F1C3A | FC1C3 | >25 | NR | NR | NR |
| F1D3A | FC1D3 | >25 | NR | NR | NR |
| F1E3A | FC1E3 | >25 | NR | NR | NR |
| F1A4A | FC1A4 | >25 | NR | NR | NR |
| F1B4A | FC1B4 | >25 | NR | NR | NR |
| F1C4A | FC1C4 | >25 | NR | NR | NR |
| F1D4A | FC1D4 | >25 | NR | NR | NR |
| F1E4A | FC1E4 | >25 | NR | NR | NR |
| F1A5A | FC1A5 | >25 | NR | NR | NR |
| F1B5A | FC1B5 | >25 | NR | NR | NR |
| F1C5A | FC1C5 | >25 | NR | NR | NR |
| F1D5A | FC1D5 | >25 | NR | NR | NR |
| F1E5A | FC1E5 | >25 | NR | NR | NR |
| F1A6A | FC1A6 | >25 | NR | NR | NR |
| F1B6A | FC1B6 | >25 | NR | NR | NR |
| F1C6A | FC1C6 | >25 | NR | NR | NR |
| F1D6A | FC1D6 | >25 | NR | NR | NR |
| F1E6A | FC1E6 | >25 | NR | NR | NR |
| F2A1A | FC2A1 | >25 | NR | NR | NR |
| F2B1A | FC2B1 | >25 | NR | NR | NR |
| F2C1A | FC2C1 | >25 | NR | NR | NR |
| F2D1A | FC2D1 | >25 | NR | NR | NR |
| F2E1A | FC2E1 | >25 | NR | NR | NR |
| F2A2A | FC2A2 | >25 | NR | NR | NR |
| F2B2A | FC2B2 | >25 | NR | NR | NR |
| F2C2A | FC2C2 | >25 | NR | NR | NR |
| F2D2A | FC2D2 | >25 | NR | NR | NR |
| F2E2A | FC2E2 | >25 | NR | NR | NR |
| F2A3A | FC2A3 | >25 | NR | NR | NR |
| F2B3A | FC2B3 | >25 | NR | NR | NR |
| F2C3A | FC2C3 | >25 | NR | NR | NR |
| F2D3A | FC2D3 | >25 | NR | NR | NR |
| F2E3A | FC2E3 | >25 | NR | NR | NR |
| F2A4A | FC2A4 | >25 | NR | NR | NR |
| F2B4A | FC2B4 | >25 | NR | NR | NR |
| F2C4A | FC2C4 | >25 | NR | NR | NR |
| F2D4A | FC2D4 | >25 | NR | NR | NR |
| F2E4A | FC2E4 | >25 | NR | NR | NR |
| F2A5A | FC2A5 | >25 | NR | NR | NR |
| F2B5A | FC2B5 | >25 | NR | NR | NR |
| F2C5A | FC2C5 | >25 | NR | NR | NR |
| F2D5A | FC2D5 | >25 | NR | NR | NR |
| F2E5A | FC2E5 | >25 | NR | NR | NR |
| F2A6A | FC2A6 | >25 | NR | NR | NR |
| F2B6A | FC2B6 | >25 | NR | NR | NR |
| F2C6A | FC2C6 | >25 | NR | NR | NR |
| F2D6A | FC2D6 | >25 | NR | NR | NR |
| F2E6A | FC2E6 | >25 | NR | NR | NR |
| F3A1A | FC3A1 | >25 | NR | NR | NR |
| F3B1A | FC3B1 | >25 | NR | NR | NR |
| F3C1A | FC3C1 | >25 | NR | NR | NR |
| F3D1A | FC3D1 | >25 | NR | NR | NR |
| F3E1A | FC3E1 | >25 | NR | NR | NR |
| F3A2A | FC3A2 | >25 | NR | NR | NR |
| F3B2A | FC3B2 | >25 | NR | NR | NR |
| F3C2A | FC3C2 | >25 | NR | NR | NR |
| F3D2A | FC3D2 | >25 | NR | NR | NR |
| F3E2A | FC3E2 | >25 | NR | NR | NR |
| F3A3A | FC3A3 | >25 | NR | NR | NR |
| F3B3A | FC3B3 | >25 | NR | NR | NR |
| F3C3A | FC3C3 | >25 | NR | NR | NR |
| F3D3A | FC3D3 | >25 | NR | NR | NR |
| F3E3A | FC3E3 | >25 | NR | NR | NR |
| F3A4A | FC3A4 | >25 | NR | NR | NR |
| F3B4A | FC3B4 | >25 | NR | NR | NR |
| F3C4A | FC3C4 | >25 | NR | NR | NR |
| F3D4A | FC3D4 | >25 | NR | NR | NR |
| F3E4A | FC3E4 | >25 | NR | NR | NR |
| F3A5A | FC3A5 | >25 | NR | NR | NR |
| F3B5A | FC3B5 | >25 | NR | NR | NR |
| F3C5A | FC3C5 | >25 | NR | NR | NR |
| F3D5A | FC3D5 | >25 | NR | NR | NR |
| F3E5A | FC3E5 | >25 | NR | NR | NR |
| F3A6A | FC3A6 | >25 | NR | NR | NR |
| F3B6A | FC3B6 | >25 | NR | NR | NR |
| F3C6A | FC3C6 | >25 | NR | NR | NR |
| F3D6A | FC3D6 | >25 | NR | NR | NR |
| F3E6A | FC3E6 | >25 | NR | NR | NR |
| F4A1A | FC4A1 | >25 | R | NR | NR |
| F4B1A | FC4B1 | >25 | NR | NR | NR |
| F4C1A | FC4C1 | >25 | NR | NR | NR |
| F4D1A | FC4D1 | >25 | NR | NR | NR |
| F4E1A | FC4E1 | >25 | NR | NR | NR |
| F4A2A | FC4A2 | >25 | NR | NR | NR |
| F4B2A | FC4B2 | >25 | NR | NR | NR |
| F4C2A | FC4C2 | >25 | NR | NR | NR |
| F4D2A | FC4D2 | >25 | NR | NR | NR |
| F4E2A | FC4E2 | >25 | NR | NR | NR |
| F4A3A | FC4A3 | >25 | NR | NR | NR |
| F4B3A | FC4B3 | >25 | NR | NR | NR |
| FC4C3A | FC4C3 | >25 | NR | NR | NR |
| F4D3A | FC4D3 | >25 | NR | NR | NR |
| F4E3A | FC4E3 | >25 | NR | NR | NR |
| F4A4A | FC4A4 | >25 | NR | NR | NR |
| F4B4A | FC4B4 | >25 | NR | NR | NR |
| F4C4A | FC4C4 | >25 | NR | NR | NR |
| F4D4A | FC4D4 | >25 | NR | NR | NR |
| F4E4A | FC4E4 | >25 | NR | NR | NR |
| F4A5A | FC4A5 | >25 | NR | NR | NR |
| F4B5A | FC4B5 | >25 | NR | NR | NR |
| F4C5A | FC4C5 | >25 | NR | NR | NR |
| F4D5A | FC4D5 | >25 | NR | NR | NR |
| F4E5A | FC4E5 | >25 | NR | NR | NR |
| F4A6A | FC4A6 | >25 | NR | NR | NR |
| F4B6A | FC4B6 | >25 | NR | NR | NR |
| F4C6A | FC4C6 | >25 | NR | NR | NR |
| F4D6A | FC4D6 | >25 | NR | NR | NR |
| F4E6A | FC4E6 | >25 | NR | NR | NR |
| F5A1A | FC5A1 | >25 | NR | NR | NR |
| F5B1A | FC5B1 | >25 | NR | NR | NR |
| F5C1A | FC5C1 | >25 | NR | NR | NR |
| F5D1A | FC5D1 | >25 | NR | NR | NR |
| F5E1A | FC5E1 | >25 | NR | NR | NR |
| F5A2A | FC5A2 | >25 | NR | NR | NR |
| F5B2A | FC5B2 | >25 | NR | NR | NR |
| F5C2A | FC5C2 | >25 | NR | NR | NR |
| F5D2A | FC5D2 | >25 | NR | NR | NR |
| F5E2A | FC5E2 | >25 | NR | NR | NR |
| F5A3A | FC5A3 | >25 | NR | NR | NR |
| F5B3A | FC5B3 | >25 | NR | NR | NR |
| F5C3A | FC5C3 | >25 | NR | NR | NR |
| F5D3A | FC5D3 | >25 | NR | NR | NR |
| F5E3A | FC5E3 | >25 | NR | NR | NR |
| F5A4A | FC5A4 | >25 | NR | NR | NR |
| F5B4A | FC5B4 | >25 | NR | NR | NR |
| F5C4A | FC5C4 | >25 | NR | NR | NR |
| F5D4A | FC5D4 | >25 | NR | NR | NR |
| F5E4A | FC5E4 | >25 | NR | NR | NR |
| F5A5A | FC5A5 | >25 | NR | NR | NR |
| F5B5A | FC5B5 | >25 | NR | NR | NR |
| F5C5A | FC5C5 | >25 | NR | NR | NR |
| F5D5A | FC5D5 | >25 | NR | NR | NR |
| F5E5A | FC5E5 | >25 | NR | NR | NR |
| F5A6A | FC5A6 | >25 | NR | NR | NR |
| F5B6A | FC5B6 | >25 | NR | NR | NR |
| F5C6A | FC5C6 | >25 | NR | NR | NR |
| F5D6A | FC5D6 | >25 | NR | NR | NR |
| F5E6A | FC5E6 | >25 | NR | NR | NR |
| F6A1A | FC6A1 | >25 | NR | NR | NR |
| F6B1A | FC6B1 | >25 | NR | NR | NR |
| F6C1A | FC6C1 | >25 | NR | NR | NR |
| F6D1A | FC6D1 | >25 | NR | NR | NR |
| F6E1A | FC6E1 | >25 | NR | NR | NR |
| F6A2A | FC6A2 | >25 | NR | NR | NR |
| F6B2A | FC6B2 | >25 | NR | NR | NR |
| F6C2A | FC6C2 | >25 | NR | NR | NR |
| F6D2A | FC6D2 | >25 | NR | NR | NR |
| F6E2A | FC6E2 | >25 | NR | NR | NR |
| F6A3A | FC6A3 | >25 | NR | NR | NR |
| F6B3A | FC6B3 | >25 | NR | NR | NR |
| F6C3A | FC6C3 | >25 | NR | NR | NR |
| F6D3A | FC6D3 | >25 | NR | NR | NR |
| F6E3A | FC6E3 | >25 | NR | NR | NR |
| F6B4A | FC6B4 | >25 | NR | NR | NR |
| F6C4A | FC6C4 | >25 | NR | NR | NR |
| F6D4A | FC6D4 | >25 | NR | NR | NR |
| F6E4A | FC6E4 | >25 | NR | NR | NR |
| F6A5A | FC6A5 | >25 | NR | NR | NR |
| F6B5A | FC6B5 | >25 | NR | NR | NR |
| F6C5A | FC6C5 | >25 | NR | NR | NR |
| F6D5A | FC6D5 | >25 | NR | NR | NR |
| F6E5A | FC6E5 | >25 | NR | NR | NR |
| F6A6A | FC6A6 | >25 | NR | NR | NR |
| F6B6A | FC6B6 | >25 | NR | NR | NR |
| F6C6A | FC6C6 | >25 | NR | NR | NR |
| F6D6A | FC6D6 | >25 | NR | NR | NR |
| F6E6A | FC6E6 | >25 | NR | NR | NR |
| F7A1A | FC7A1 | >25 | NR | NR | NR |
| F7B1A | FC7B1 | >25 | NR | NR | NR |
| F7C1A | FC7C1 | >25 | NR | NR | NR |
| F7D1A | FC7D1 | >25 | NR | NR | NR |
| F7E1A | FC7E1 | >25 | NR | NR | NR |
| F7A2A | FC7A2 | >25 | NR | NR | NR |
| F7B2 | FC7B2 | >25 | NR | NR | NR |
| F7C2A | FC7C2 | >25 | NR | NR | NR |
| F7D2A | FC7D2 | >25 | NR | NR | NR |
| F7E2A | FC7E2 | >25 | NR | NR | NR |
| F7A3A | FC7A3 | >25 | NR | NR | NR |
| F7B3A | FC7B3 | >25 | NR | NR | NR |
| F7C3A | FC7C3 | >25 | NR | NR | NR |
| F7D3A | FC7D3 | >25 | NR | NR | NR |
| F7E3A | FC7E3 | >25 | NR | NR | NR |
| F7A4A | FC7A4 | >25 | NR | NR | NR |
| F7B4A | FC7B4 | >25 | NR | NR | NR |
| F7C4A | FC7C4 | >25 | NR | NR | NR |
| F7D4A | FC7D4 | >25 | NR | NR | NR |
| F7E4A | FC7E4 | >25 | NR | NR | NR |
| F7A5A | FC7A5 | >25 | NR | NR | NR |
| F7B5A | FC7B5 | >25 | NR | NR | NR |
| F7C5A | FC7C5 | >25 | NR | NR | NR |
| F7D5A | FC7D5 | >25 | NR | NR | NR |
| F7E5A | FC7E5 | >25 | NR | NR | NR |
| F7A6A | FC7A6 | >25 | NR | NR | NR |
| F7B6A | FC7B6 | >25 | NR | NR | NR |
| F7C6A | FC7C6 | >25 | NR | NR | NR |
| F7D6A | FC7D6 | >25 | NR | NR | NR |
| F7E6A | FC7E6 | >25 | NR | NR | NR |
| F8A1A | FC8A1 | >25 | NR | NR | NR |
| F8B1A | FC8B1 | >25 | NR | NR | NR |
| F8C1A | FC8C1 | >25 | NR | NR | NR |
| F8D1A | FC8D1 | >25 | NR | NR | NR |
| F8E1A | FC8E1 | >25 | NR | NR | NR |
| F8A2A | FC8A2 | >25 | NR | NR | NR |
| F8B2A | FC8B2 | >25 | NR | NR | NR |
| F8C2A | FC8C2 | >25 | NR | NR | NR |
| F8D2A | FC8D2 | >25 | NR | NR | NR |
| F8E2A | FC8E2 | >25 | NR | NR | NR |
| F8A3A | FC8A3 | >25 | NR | NR | NR |
| F8B3A | FC8B3 | >25 | NR | NR | NR |
| F8C3A | FC8C3 | >25 | NR | NR | NR |
| F8D3A | FC8D3 | >25 | NR | NR | NR |
| F8E3A | FC8E3 | >25 | NR | NR | NR |
| F8A4A | FC8A4 | >25 | NR | NR | NR |
| F8B4A | FC8B4 | >25 | NR | NR | NR |
| F8C4A | FC8C4 | >25 | NR | NR | NR |
| F8D4A | FC8D4 | >25 | NR | NR | NR |
| F8E4A | FC8E4 | >25 | NR | NR | NR |
| F8A5A | FC8A5 | >25 | NR | NR | NR |
| F8B5A | FC8B5 | >25 | NR | NR | NR |
| F8C5A | FC8C5 | >25 | NR | NR | NR |
| F8D5A | FC8D5 | >25 | NR | NR | NR |
| F8E5A | FC8E5 | >25 | NR | NR | NR |
| F8A6A | FC8A6 | >25 | NR | NR | NR |
| F8B6A | FC8B6 | >25 | NR | NR | NR |
| F8C6A | FC8C6 | >25 | NR | NR | NR |
| F8D6A | FC8D6 | >25 | NR | NR | NR |
| F8E6A | FC8E6 | >25 | NR | NR | NR |
| F1A1B | FC1A1 | NR | <0.16 | NR | NR |
| F1B1B | FC1B1 | NR | <0.16 | NR | NR |
| F1C1B | FC1C1 | NR | <0.16 | NR | NR |
| F1D1B | FC1D1 | NR | <0.16 | NR | NR |
| F1E1B | FC1E1 | NR | <0.16 | NR | NR |
| F1A2B | FC1A2 | NR | <0.16 | NR | NR |
| F1B2B | FC1B2 | NR | <0.16 | NR | NR |
| F1C2B | FC1C2 | NR | <0.16 | NR | NR |
| F1D2B | FC1D2 | NR | <0.16 | NR | NR |
| F1E2B | FC1E2 | NR | <0.16 | NR | NR |
| F1A3B | FC1A3 | NR | <0.16 | NR | NR |
| F1B3B | FC1B3 | NR | <0.16 | NR | NR |
| F1C3B | FC1C3 | NR | <0.16 | NR | NR |
| F1D3B | FC1D3 | NR | <0.16 | NR | NR |
| F1E3B | FC1E3 | NR | <0.16 | NR | NR |
| F1A4B | FC1A4 | NR | <0.16 | NR | NR |
| F1B4B | FC1B4 | NR | <0.16 | NR | NR |
| F1C4B | FC1C4 | NR | <0.16 | NR | NR |
| F1D4B | FC1D4 | NR | <0.16 | NR | NR |
| F1E4B | FC1E4 | NR | <0.16 | NR | NR |
| F1A5B | FC1A5 | NR | <0.16 | NR | NR |
| F1B5B | FC1B5 | NR | <0.16 | NR | NR |
| F1C5B | FC1C5 | NR | <0.16 | NR | NR |
| F1D5B | FC1D5 | NR | <0.16 | NR | NR |
| F1E5B | FC1E5 | NR | <0.16 | NR | NR |
| F1A6B | FC1A6 | NR | <0.16 | NR | NR |
| F1B6B | FC1B6 | NR | <0.16 | NR | NR |
| F1C6B | FC1C6 | NR | <0.16 | NR | NR |
| F1D6B | FC1D6 | NR | <0.16 | NR | NR |
| F1E6B | FC1E6 | NR | <0.16 | NR | NR |
| F2A1B | FC2A1 | NR | <0.16 | NR | NR |
| F2B1B | FC2B1 | NR | <0.16 | NR | NR |
| F2C1B | FC2C1 | NR | <0.16 | NR | NR |
| F2D1B | FC2D1 | NR | <0.16 | NR | NR |
| F2E1B | FC2E1 | NR | <0.16 | NR | NR |
| F2A2B | FC2A2 | NR | <0.16 | NR | NR |
| F2B2B | FC2B2 | NR | <0.16 | NR | NR |
| F2C2B | FC2C2 | NR | <0.16 | NR | NR |
| F2D2B | FC2D2 | NR | <0.16 | NR | NR |
| F2E2B | FC2E2 | NR | <0.16 | NR | NR |
| F2A3B | FC2A3 | NR | <0.16 | NR | NR |
| F2B3B | FC2B3 | NR | <0.16 | NR | NR |
| F2C3B | FC2C3 | NR | <0.16 | NR | NR |
| F2D3B | FC2D3 | NR | <0.16 | NR | NR |
| F2E3B | FC2E3 | NR | <0.16 | NR | NR |
| F2A4B | FC2A4 | NR | <0.16 | NR | NR |
| F2B4B | FC2B4 | NR | <0.16 | NR | NR |
| F2C4B | FC2C4 | NR | <0.16 | NR | NR |
| F2D4B | FC2D4 | NR | <0.16 | NR | NR |
| F2E4B | FC2E4 | NR | <0.16 | NR | NR |
| F2A5B | FC2A5 | NR | <0.16 | NR | NR |
| F2B5B | FC2B5 | NR | <0.16 | NR | NR |
| F2C5B | FC2C5 | NR | <0.16 | NR | NR |
| F2D5B | FC2D5 | NR | <0.16 | NR | NR |
| F2E5B | FC2E5 | NR | <0.16 | NR | NR |
| F2A6B | FC2A6 | NR | <0.16 | NR | NR |
| F2B6B | FC2B6 | NR | <0.16 | NR | NR |
| F2C6B | FC2C6 | NR | <0.16 | NR | NR |
| F2D6B | FC2D6 | NR | <0.16 | NR | NR |
| F2E6B | FC2E6 | NR | <0.16 | NR | NR |
| F3A1B | FC3A1 | NR | <0.16 | NR | NR |
| F3B1B | FC3B1 | NR | <0.16 | NR | NR |
| F3C1B | FC3C1 | NR | <0.16 | NR | NR |
| F3D1B | FC3D1 | NR | <0.16 | NR | NR |
| F3E1B | FC3E1 | NR | <0.16 | NR | NR |
| F3A2B | FC3A2 | NR | <0.16 | NR | NR |
| F3B2B | FC3B2 | NR | <0.16 | NR | NR |
| F3C2B | FC3C2 | NR | <0.16 | NR | NR |
| F3D2B | FC3D2 | NR | <0.16 | NR | NR |
| F3E2B | FC3E2 | NR | <0.16 | NR | NR |
| F3A3B | FC3A3 | NR | <0.16 | NR | NR |
| F3B3B | FC3B3 | NR | <0.16 | NR | NR |
| F3C3B | FC3C3 | NR | <0.16 | NR | NR |
| F3D3B | FC3D3 | NR | <0.16 | NR | NR |
| F3E3B | FC3E3 | NR | <0.16 | NR | NR |
| F3A4B | FC3A4 | NR | <0.16 | NR | NR |
| F3B4B | FC3B4 | NR | <0.16 | NR | NR |
| F3C4B | FC3C4 | NR | <0.16 | NR | NR |
| F3D4B | FC3D4 | NR | <0.16 | NR | NR |
| F3E4B | FC3E4 | NR | <0.16 | NR | NR |
| F3A5B | FC3A5 | NR | <0.16 | NR | NR |
| F3B5B | FC3B5 | NR | <0.16 | NR | NR |
| F3C5B | FC3C5 | NR | <0.16 | NR | NR |
| F3D5B | FC3D5 | NR | <0.16 | NR | NR |
| F3E5B | FC3E5 | NR | <0.16 | NR | NR |
| F3A6B | FC3A6 | NR | <0.16 | NR | NR |
| F3B6B | FC3B6 | NR | <0.16 | NR | NR |
| F3C6B | FC3C6 | NR | <0.16 | NR | NR |
| F3D6B | FC3D6 | NR | <0.16 | NR | NR |
| F3E6B | FC3E6 | NR | <0.16 | NR | NR |
| F4A1B | FC4A1 | NR | <0.16 | NR | NR |
| F4B1B | FC4B1 | NR | <0.16 | NR | NR |
| F4C1B | FC4C1 | NR | <0.16 | NR | NR |
| F4D1B | FC4D1 | NR | <0.16 | NR | NR |
| F4E1B | FC4E1 | NR | <0.16 | NR | NR |
| F4A2B | FC4A2 | NR | <0.16 | NR | NR |
| F4B2B | FC4B2 | NR | <0.16 | NR | NR |
| F4C2B | FC4C2 | NR | <0.16 | NR | NR |
| F4D2B | FC4D2 | NR | <0.16 | NR | NR |
| F4E2B | FC4E2 | NR | <0.16 | NR | NR |
| F4A3B | FC4A3 | NR | <0.16 | NR | NR |
| F4B3B | FC4B3 | NR | <0.16 | NR | NR |
| F4C3B | FC4C3 | NR | <0.16 | NR | NR |
| F4D3B | FC4D3 | NR | <0.16 | NR | NR |
| F4E3B | FC4E3 | NR | <0.16 | NR | NR |
| F4A4B | FC4A4 | NR | <0.16 | NR | NR |
| F4B4B | FC4B4 | NR | <0.16 | NR | NR |
| F4C4B | FC4C4 | NR | <0.16 | NR | NR |
| F4D4B | FC4D4 | NR | <0.16 | NR | NR |
| F4E4B | FC4E4 | NR | <0.16 | NR | NR |
| F4A5B | FC4A5 | NR | <0.16 | NR | NR |
| F4B5B | FC4B5 | NR | <0.16 | NR | NR |
| F4C5B | FC4C5 | NR | <0.16 | NR | NR |
| F4D5B | FC4D5 | NR | <0.16 | NR | NR |
| F4E5B | FC4E5 | NR | <0.16 | NR | NR |
| F4A6B | FC4A6 | NR | <0.16 | NR | NR |
| F4B6B | FC4B6 | NR | <0.16 | NR | NR |
| F4C6B | FC4C6 | NR | <0.16 | NR | NR |
| F4D6B | FC4D6 | NR | <0.16 | NR | NR |
| F4E6B | FC4E6 | NR | <0.16 | NR | NR |
| F5A1B | FC5A1 | NR | <0.16 | NR | NR |
| F5B1B | FC5B1 | NR | <0.16 | NR | NR |
| F5C1B | FC5C1 | NR | <0.16 | NR | NR |
| F5D1B | FC5D1 | NR | <0.16 | NR | NR |
| F5E1B | FC5E1 | NR | <0.16 | NR | NR |
| F5A2B | FC5A2 | NR | <0.16 | NR | NR |
| F5B2B | FC5B2 | NR | <0.16 | NR | NR |
| F5C2B | FC5C2 | NR | <0.16 | NR | NR |
| F5D2B | FC5D2 | NR | <0.16 | NR | NR |
| F5E2B | FC5E2 | NR | <0.16 | NR | NR |
| F5A3B | FC5A3 | NR | <0.16 | NR | NR |
| F5B3B | FC5B3 | NR | <0.16 | NR | NR |
| F5C3B | FC5C3 | NR | <0.16 | NR | NR |
| F5D3B | FC5D3 | NR | <0.16 | NR | NR |
| F5E3B | FC5E3 | NR | <0.16 | NR | NR |
| F5A4B | FC5A4 | NR | <0.16 | NR | NR |
| F5B4B | FC5B4 | NR | <0.16 | NR | NR |
| F5C4B | FC5C4 | NR | <0.16 | NR | NR |
| F5D4B | FC5D4 | NR | <0.16 | NR | NR |
| F5E4B | FC5E4 | NR | <0.16 | NR | NR |
| F5A5B | FC5A5 | NR | <0.16 | NR | NR |
| F5B5B | FC5B5 | NR | <0.16 | NR | NR |
| F5C5B | FC5C5 | NR | <0.16 | NR | NR |
| F5D5B | FC5D5 | NR | <0.16 | NR | NR |
| F5E5B | FC5E5 | NR | <0.16 | NR | NR |
| F5A6B | FC5A6 | NR | <0.16 | NR | NR |
| F5B6B | FC5B6 | NR | <0.16 | NR | NR |
| F5C6B | FC5C6 | NR | <0.16 | NR | NR |
| F5D6B | FC5D6 | NR | <0.16 | NR | NR |
| F5E6B | FC5E6 | NR | <0.16 | NR | NR |
| F6A1B | FC6A1 | NR | <0.16 | NR | NR |
| F6B1B | FC6B1 | NR | <0.16 | NR | NR |
| F6C1B | FC6C1 | NR | <0.16 | NR | NR |
| F6D1B | FC6D1 | NR | <0.16 | NR | NR |
| F6E1B | FC6E1 | NR | <0.16 | NR | NR |
| F6A2B | FC6A2 | NR | <0.16 | NR | NR |
| F6B2B | FC6B2 | NR | <0.16 | NR | NR |
| F6C2B | FC6C2 | NR | <0.16 | NR | NR |
| F6D2B | FC6D2 | NR | <0.16 | NR | NR |
| F6E2B | FC6E2 | NR | <0.16 | NR | NR |
| F6A3B | FC6A3 | NR | <0.16 | NR | NR |
| F6B3B | FC6B3 | NR | <0.16 | NR | NR |
| F6C3B | FC6C3 | NR | <0.16 | NR | NR |
| F6D3B | FC6D3 | NR | <0.16 | NR | NR |
| F6E3B | FC6E3 | NR | <0.16 | NR | NR |
| F6B4B | FC6B4 | NR | <0.16 | NR | NR |
| F6C4B | FC6C4 | NR | <0.16 | NR | NR |
| F6D4B | FC6D4 | NR | <0.16 | NR | NR |
| F6E4B | FC6E4 | NR | <0.16 | NR | NR |
| F6A5B | FC6A5 | NR | <0.16 | NR | NR |
| F6B5B | FC6B5 | NR | <0.16 | NR | NR |
| F6C5B | FC6C5 | NR | <0.16 | NR | NR |
| F6D5B | FC6D5 | NR | <0.16 | NR | NR |
| F6E5B | FC6E5 | NR | <0.16 | NR | NR |
| F6A6B | FC6A6 | NR | <0.16 | NR | NR |
| F6B6B | FC6B6 | NR | <0.16 | NR | NR |
| F6C6B | FC6C6 | NR | <0.16 | NR | NR |
| F6D6B | FC6D6 | NR | <0.16 | NR | NR |
| F6E6B | FC6E6 | NR | <0.16 | NR | NR |
| F7A1B | FC7A1 | NR | <0.16 | NR | NR |
| F7B1B | FC7B1 | NR | <0.16 | NR | NR |
| F7C1B | FC7C1 | NR | <0.16 | NR | NR |
| F7D1B | FC7D1 | NR | <0.16 | NR | NR |
| F7E1B | FC7E1 | NR | <0.16 | NR | NR |
| F7A2B | FC7A2 | NR | <0.16 | NR | NR |
| F7B2B | FC7B2 | NR | <0.16 | NR | NR |
| F7C2B | FC7C2 | NR | <0.16 | NR | NR |
| F7D2B | FC7D2 | NR | <0.16 | NR | NR |
| F7E2B | FC7E2 | NR | <0.16 | NR | NR |
| F7A3B | FC7A3 | NR | <0.16 | NR | NR |
| F7B3B | FC7B3 | NR | <0.16 | NR | NR |
| F7C3B | FC7C3 | NR | <0.16 | NR | NR |
| F7D3B | FC7D3 | NR | <0.16 | NR | NR |
| F7E3B | FC7E3 | NR | <0.16 | NR | NR |
| F7A4B | FC7A4 | NR | <0.16 | NR | NR |
| F7B4B | FC7B4 | NR | <0.16 | NR | NR |
| F7C4B | FC7C4 | NR | <0.16 | NR | NR |
| F7D4B | FC7D4 | NR | <0.16 | NR | NR |
| F7E4B | FC7E4 | NR | <0.16 | NR | NR |
| F7A5B | FC7A5 | NR | <0.16 | NR | NR |
| F7B5B | FC7B5 | NR | <0.16 | NR | NR |
| F7C5B | FC7C5 | NR | <0.16 | NR | NR |
| F7D5B | FC7D5 | NR | <0.16 | NR | NR |
| F7E5B | FC7E5 | NR | <0.16 | NR | NR |
| F7A6B | FC7A6 | NR | <0.16 | NR | NR |
| F7B6B | FC7B6 | NR | <0.16 | NR | NR |
| F7C6B | FC7C6 | NR | <0.16 | NR | NR |
| F7D6B | FC7D6 | NR | <0.16 | NR | NR |
| F7E6B | FC7E6 | NR | <0.16 | NR | NR |
| F8A1B | FC8A1 | NR | <0.16 | NR | NR |
| F8B1B | FC8B1 | NR | <0.16 | NR | NR |
| F8C1B | FC8C1 | NR | <0.16 | NR | NR |
| F8D1B | FC8D1 | NR | <0.16 | NR | NR |
| F8E1B | FC8E1 | NR | <0.16 | NR | NR |
| F8A2B | FC8A2 | NR | <0.16 | NR | NR |
| F8B2B | FC8B2 | NR | <0.16 | NR | NR |
| F8C2B | FC8C2 | NR | <0.16 | NR | NR |
| F8D2B | FC8D2 | NR | <0.16 | NR | NR |
| F8E2B | FC8E2 | NR | <0.16 | NR | NR |
| F8A3B | FC8A3 | NR | <0.16 | NR | NR |
| F8B3B | FC8B3 | NR | <0.16 | NR | NR |
| F8C3B | FC8C3 | NR | <0.16 | NR | NR |
| F8D3B | FC8D3 | NR | <0.16 | NR | NR |
| F8E3B | FC8E3 | NR | <0.16 | NR | NR |
| F8A4B | FC8A4 | NR | <0.16 | NR | NR |
| F8B4B | FC8B4 | NR | <0.16 | NR | NR |
| F8C4B | FC8C4 | NR | <0.16 | NR | NR |
| F8D4B | FC8D4 | NR | <0.16 | NR | NR |
| F8E4B | FC8E4 | NR | <0.16 | NR | NR |
| F8A5B | FC8A5 | NR | <0.16 | NR | NR |
| F8B5B | FC8B5 | NR | <0.16 | NR | NR |
| F8C5B | FC8C5 | NR | <0.16 | NR | NR |
| F8D5B | FC8D5 | NR | <0.16 | NR | NR |
| F8E5B | FC8E5 | NR | <0.16 | NR | NR |
| F8A6B | FC8A6 | NR | <0.16 | NR | NR |
| F8B6B | FC8B6 | NR | <0.16 | NR | NR |
| F8C6B | FC8C6 | NR | <0.16 | NR | NR |
| F8D6B | FC8D6 | NR | <0.16 | NR | NR |
| F8E6B | FC8E6 | NR | <0.16 | NR | NR |
| F1A1C | FC1A1 | NR | 0.05-0.16 | NR | NR |
| F1B1C | FC1B1 | NR | 0.05-0.16 | NR | NR |
| F1C1C | FC1C1 | NR | 0.05-0.16 | NR | NR |
| F1D1C | FC1D1 | NR | 0.05-0.16 | NR | NR |
| F1E1C | FC1E1 | NR | 0.05-0.16 | NR | NR |
| F1A2C | FC1A2 | NR | 0.05-0.16 | NR | NR |
| F1B2C | FC1B2 | NR | 0.05-0.16 | NR | NR |
| F1C2C | FC1C2 | NR | 0.05-0.16 | NR | NR |
| F1D2C | FC1D2 | NR | 0.05-0.16 | NR | NR |
| F1E2C | FC1E2 | NR | 0.05-0.16 | NR | NR |
| F1A3C | FC1A3 | NR | 0.05-0.16 | NR | NR |
| F1B3C | FC1B3 | NR | 0.05-0.16 | NR | NR |
| F1C3C | FC1C3 | NR | 0.05-0.16 | NR | NR |
| F1D3C | FC1D3 | NR | 0.05-0.16 | NR | NR |
| F1E3C | FC1E3 | NR | 0.05-0.16 | NR | NR |
| F1A4C | FC1A4 | NR | 0.05-0.16 | NR | NR |
| F1B4C | FC1B4 | NR | 0.05-0.16 | NR | NR |
| F1C4C | FC1C4 | NR | 0.05-0.16 | NR | NR |
| F1D4C | FC1D4 | NR | 0.05-0.16 | NR | NR |
| F1E4C | FC1E4 | NR | 0.05-0.16 | NR | NR |
| F1A5C | FC1A5 | NR | 0.05-0.16 | NR | NR |
| F1B5C | FC1B5 | NR | 0.05-0.16 | NR | NR |
| F1C5C | FC1C5 | NR | 0.05-0.16 | NR | NR |
| F1D5C | FC1D5 | NR | 0.05-0.16 | NR | NR |
| F1E5C | FC1E5 | NR | 0.05-0.16 | NR | NR |
| F1A6C | FC1A6 | NR | 0.05-0.16 | NR | NR |
| F1B6C | FC1B6 | NR | 0.05-0.16 | NR | NR |
| F1C6C | FC1C6 | NR | 0.05-0.16 | NR | NR |
| F1D6C | FC1D6 | NR | 0.05-0.16 | NR | NR |
| F1E6C | FC1E6 | NR | 0.05-0.16 | NR | NR |
| F2A1C | FC2A1 | NR | 0.05-0.16 | NR | NR |
| F2B1C | FC2B1 | NR | 0.05-0.16 | NR | NR |
| F2C1C | FC2C1 | NR | 0.05-0.16 | NR | NR |
| F2D1C | FC2D1 | NR | 0.05-0.16 | NR | NR |
| F2E1C | FC2E1 | NR | 0.05-0.16 | NR | NR |
| F2A2C | FC2A2 | NR | 0.05-0.16 | NR | NR |
| F2B2C | FC2B2 | NR | 0.05-0.16 | NR | NR |
| F2C2C | FC2C2 | NR | 0.05-0.16 | NR | NR |
| F2D2C | FC2D2 | NR | 0.05-0.16 | NR | NR |
| F2E2C | FC2E2 | NR | 0.05-0.16 | NR | NR |
| F2A3C | FC2A3 | NR | 0.05-0.16 | NR | NR |
| F2B3C | FC2B3 | NR | 0.05-0.16 | NR | NR |
| F2C3C | FC2C3 | NR | 0.05-0.16 | NR | NR |
| F2D3C | FC2D3 | NR | 0.05-0.16 | NR | NR |
| F2E3C | FC2E3 | NR | 0.05-0.16 | NR | NR |
| F2A4C | FC2A4 | NR | 0.05-0.16 | NR | NR |
| F2B4C | FC2B4 | NR | 0.05-0.16 | NR | NR |
| F2C4C | FC2C4 | NR | 0.05-0.16 | NR | NR |
| F2D4C | FC2D4 | NR | 0.05-0.16 | NR | NR |
| F2E4C | FC2E4 | NR | 0.05-0.16 | NR | NR |
| F2A5C | FC2A5 | NR | 0.05-0.16 | NR | NR |
| F2B5C | FC2B5 | NR | 0.05-0.16 | NR | NR |
| F2C5C | FC2C5 | NR | 0.05-0.16 | NR | NR |
| F2D5C | FC2D5 | NR | 0.05-0.16 | NR | NR |
| F2E5C | FC2E5 | NR | 0.05-0.16 | NR | NR |
| F2A6C | FC2A6 | NR | 0.05-0.16 | NR | NR |
| F2B6C | FC2B6 | NR | 0.05-0.16 | NR | NR |
| F2C6C | FC2C6 | NR | 0.05-0.16 | NR | NR |
| F2D6C | FC2D6 | NR | 0.05-0.16 | NR | NR |
| F2E6C | FC2E6 | NR | 0.05-0.16 | NR | NR |
| F3A1C | FC3A1 | NR | 0.05-0.16 | NR | NR |
| F3B1C | FC3B1 | NR | 0.05-0.16 | NR | NR |
| F3C1C | FC3C1 | NR | 0.05-0.16 | NR | NR |
| F3D1C | FC3D1 | NR | 0.05-0.16 | NR | NR |
| F3E1C | FC3E1 | NR | 0.05-0.16 | NR | NR |
| F3A2C | FC3A2 | NR | 0.05-0.16 | NR | NR |
| F3B2C | FC3B2 | NR | 0.05-0.16 | NR | NR |
| F3C2C | FC3C2 | NR | 0.05-0.16 | NR | NR |
| F3D2C | FC3D2 | NR | 0.05-0.16 | NR | NR |
| F3E2C | FC3E2 | NR | 0.05-0.16 | NR | NR |
| F3A3C | FC3A3 | NR | 0.05-0.16 | NR | NR |
| F3B3C | FC3B3 | NR | 0.05-0.16 | NR | NR |
| F3C3C | FC3C3 | NR | 0.05-0.16 | NR | NR |
| F3D3C | FC3D3 | NR | 0.05-0.16 | NR | NR |
| F3E3C | FC3E3 | NR | 0.05-0.16 | NR | NR |
| F3A4C | FC3A4 | NR | 0.05-0.16 | NR | NR |
| F3B4C | FC3B4 | NR | 0.05-0.16 | NR | NR |
| F3C4C | FC3C4 | NR | 0.05-0.16 | NR | NR |
| F3D4C | FC3D4 | NR | 0.05-0.16 | NR | NR |
| F3E4C | FC3E4 | NR | 0.05-0.16 | NR | NR |
| F3A5C | FC3A5 | NR | 0.05-0.16 | NR | NR |
| F3B5C | FC3B5 | NR | 0.05-0.16 | NR | NR |
| F3C5C | FC3C5 | NR | 0.05-0.16 | NR | NR |
| F3D5C | FC3D5 | NR | 0.05-0.16 | NR | NR |
| F3E5C | FC3E5 | NR | 0.05-0.16 | NR | NR |
| F3A6C | FC3A6 | NR | 0.05-0.16 | NR | NR |
| F3B6C | FC3B6 | NR | 0.05-0.16 | NR | NR |
| F3C6C | FC3C6 | NR | 0.05-0.16 | NR | NR |
| F3D6C | FC3D6 | NR | 0.05-0.16 | NR | NR |
| F3E6C | FC3E6 | NR | 0.05-0.16 | NR | NR |
| F4A1C | FC4A1 | NR | 0.05-0.16 | NR | NR |
| F4B1C | FC4B1 | NR | 0.05-0.16 | NR | NR |
| F4C1C | FC4C1 | NR | 0.05-0.16 | NR | NR |
| F4D1C | FC4D1 | NR | 0.05-0.16 | NR | NR |
| F4E1C | FC4E1 | NR | 0.05-0.16 | NR | NR |
| F4A2C | FC4A2 | NR | 0.05-0.16 | NR | NR |
| F4B2C | FC4B2 | NR | 0.05-0.16 | NR | NR |
| F4C2C | FC4C2 | NR | 0.05-0.16 | NR | NR |
| F4D2C | FC4D2 | NR | 0.05-0.16 | NR | NR |
| F4E2C | FC4E2 | NR | 0.05-0.16 | NR | NR |
| F4A3C | FC4A3 | NR | 0.05-0.16 | NR | NR |
| F4B3C | FC4B3 | NR | 0.05-0.16 | NR | NR |
| F4C3C | FC4C3 | NR | 0.05-0.16 | NR | NR |
| F4D3C | FC4D3 | NR | 0.05-0.16 | NR | NR |
| F4E3C | FC4E3 | NR | 0.05-0.16 | NR | NR |
| F4A4C | FC4A4 | NR | 0.05-0.16 | NR | NR |
| F4B4C | FC4B4 | NR | 0.05-0.16 | NR | NR |
| F4C4C | FC4C4 | NR | 0.05-0.16 | NR | NR |
| F4D4C | FC4D4 | NR | 0.05-0.16 | NR | NR |
| F4E4C | FC4E4 | NR | 0.05-0.16 | NR | NR |
| F4A5C | FC4A5 | NR | 0.05-0.16 | NR | NR |
| F4B5C | FC4B5 | NR | 0.05-0.16 | NR | NR |
| F4C5C | FC4C5 | NR | 0.05-0.16 | NR | NR |
| F4D5C | FC4D5 | NR | 0.05-0.16 | NR | NR |
| F4E5C | FC4E5 | NR | 0.05-0.16 | NR | NR |
| F4A6C | FC4A6 | NR | 0.05-0.16 | NR | NR |
| F4B6C | FC4B6 | NR | 0.05-0.16 | NR | NR |
| F4C6C | FC4C6 | NR | 0.05-0.16 | NR | NR |
| F4D6C | FC4D6 | NR | 0.05-0.16 | NR | NR |
| F4E6C | FC4E6 | NR | 0.05-0.16 | NR | NR |
| F5A1C | FC5A1 | NR | 0.05-0.16 | NR | NR |
| F5B1C | FC5B1 | NR | 0.05-0.16 | NR | NR |
| F5C1C | FC5C1 | NR | 0.05-0.16 | NR | NR |
| F5D1C | FC5D1 | NR | 0.05-0.16 | NR | NR |
| F5E1C | FC5E1 | NR | 0.05-0.16 | NR | NR |
| F5A2C | FC5A2 | NR | 0.05-0.16 | NR | NR |
| F5B2C | FC5B2 | NR | 0.05-0.16 | NR | NR |
| F5C2C | FC5C2 | NR | 0.05-0.16 | NR | NR |
| F5D2C | FC5D2 | NR | 0.05-0.16 | NR | NR |
| F5E2C | FC5E2 | NR | 0.05-0.16 | NR | NR |
| F5A3C | FC5A3 | NR | 0.05-0.16 | NR | NR |
| F5B3C | FC5B3 | NR | 0.05-0.16 | NR | NR |
| F5C3C | FC5C3 | NR | 0.05-0.16 | NR | NR |
| F5D3C | FC5D3 | NR | 0.05-0.16 | NR | NR |
| F5E3C | FC5E3 | NR | 0.05-0.16 | NR | NR |
| F5A4C | FC5A4 | NR | 0.05-0.16 | NR | NR |
| F5B4C | FC5B4 | NR | 0.05-0.16 | NR | NR |
| F5C4C | FC5C4 | NR | 0.05-0.16 | NR | NR |
| F5D4C | FC5D4 | NR | 0.05-0.16 | NR | NR |
| F5E4C | FC5E4 | NR | 0.05-0.16 | NR | NR |
| F5A5C | FC5A5 | NR | 0.05-0.16 | NR | NR |
| F5B5C | FC5B5 | NR | 0.05-0.16 | NR | NR |
| F5C5C | FC5C5 | NR | 0.05-0.16 | NR | NR |
| F5D5C | FC5D5 | NR | 0.05-0.16 | NR | NR |
| F5E5C | FC5E5 | NR | 0.05-0.16 | NR | NR |
| F5A6C | FC5A6 | NR | 0.05-0.16 | NR | NR |
| F5B6C | FC5B6 | NR | 0.05-0.16 | NR | NR |
| F5C6C | FC5C6 | NR | 0.05-0.16 | NR | NR |
| F5D6C | FC5D6 | NR | 0.05-0.16 | NR | NR |
| F5E6C | FC5E6 | NR | 0.05-0.16 | NR | NR |
| F6A1C | FC6A1 | NR | 0.05-0.16 | NR | NR |
| F6B1C | FC6B1 | NR | 0.05-0.16 | NR | NR |
| F6C1C | FC6C1 | NR | 0.05-0.16 | NR | NR |
| F6D1C | FC6D1 | NR | 0.05-0.16 | NR | NR |
| F6E1C | FC6E1 | NR | 0.05-0.16 | NR | NR |
| F6A2C | FC6A2 | NR | 0.05-0.16 | NR | NR |
| F6B2C | FC6B2 | NR | 0.05-0.16 | NR | NR |
| F6C2C | FC6C2 | NR | 0.05-0.16 | NR | NR |
| F6D2C | FC6D2 | NR | 0.05-0.16 | NR | NR |
| F6E2C | FC6E2 | NR | 0.05-0.16 | NR | NR |
| F6A3C | FC6A3 | NR | 0.05-0.16 | NR | NR |
| F6B3C | FC6B3 | NR | 0.05-0.16 | NR | NR |
| F6C3C | FC6C3 | NR | 0.05-0.16 | NR | NR |
| F6D3C | FC6D3 | NR | 0.05-0.16 | NR | NR |
| F6E3C | FC6E3 | NR | 0.05-0.16 | NR | NR |
| F6B4C | FC6B4 | NR | 0.05-0.16 | NR | NR |
| F6C4C | FC6C4 | NR | 0.05-0.16 | NR | NR |
| F6D4C | FC6D4 | NR | 0.05-0.16 | NR | NR |
| F6E4C | FC6E4 | NR | 0.05-0.16 | NR | NR |
| F6A5C | FC6A5 | NR | 0.05-0.16 | NR | NR |
| F6B5C | FC6B5 | NR | 0.05-0.16 | NR | NR |
| F6C5C | FC6C5 | NR | 0.05-0.16 | NR | NR |
| F6D5C | FC6D5 | NR | 0.05-0.16 | NR | NR |
| F6E5C | FC6E5 | NR | 0.05-0.16 | NR | NR |
| F6A6C | FC6A6 | NR | 0.05-0.16 | NR | NR |
| F6B6C | FC6B6 | NR | 0.05-0.16 | NR | NR |
| F6C6C | FC6C6 | NR | 0.05-0.16 | NR | NR |
| F6D6C | FC6D6 | NR | 0.05-0.16 | NR | NR |
| F6E6C | FC6E6 | NR | 0.05-0.16 | NR | NR |
| F7A1C | FC7A1 | NR | 0.05-0.16 | NR | NR |
| F7B1C | FC7B1 | NR | 0.05-0.16 | NR | NR |
| F7C1C | FC7C1 | NR | 0.05-0.16 | NR | NR |
| F7D1C | FC7D1 | NR | 0.05-0.16 | NR | NR |
| F7E1C | FC7E1 | NR | 0.05-0.16 | NR | NR |
| F7A2C | FC7A2 | NR | 0.05-0.16 | NR | NR |
| F7B2C | FC7B2 | NR | 0.05-0.16 | NR | NR |
| F7C2C | FC7C2 | NR | 0.05-0.16 | NR | NR |
| F7D2C | FC7D2 | NR | 0.05-0.16 | NR | NR |
| F7E2C | FC7E2 | NR | 0.05-0.16 | NR | NR |
| F7A3C | FC7A3 | NR | 0.05-0.16 | NR | NR |
| F7B3C | FC7B3 | NR | 0.05-0.16 | NR | NR |
| F7C3C | FC7C3 | NR | 0.05-0.16 | NR | NR |
| F7D3C | FC7D3 | NR | 0.05-0.16 | NR | NR |
| F7E3C | FC7E3 | NR | 0.05-0.16 | NR | NR |
| F7A4C | FC7A4 | NR | 0.05-0.16 | NR | NR |
| F7B4C | FC7B4 | NR | 0.05-0.16 | NR | NR |
| F7C4C | FC7C4 | NR | 0.05-0.16 | NR | NR |
| F7D4C | FC7D4 | NR | 0.05-0.16 | NR | NR |
| F7E4C | FC7E4 | NR | 0.05-0.16 | NR | NR |
| F7A5C | FC7A5 | NR | 0.05-0.16 | NR | NR |
| F7B5C | FC7B5 | NR | 0.05-0.16 | NR | NR |
| F7C5C | FC7C5 | NR | 0.05-0.16 | NR | NR |
| F7D5C | FC7D5 | NR | 0.05-0.16 | NR | NR |
| F7E5C | FC7E5 | NR | 0.05-0.16 | NR | NR |
| F7A6C | FC7A6 | NR | 0.05-0.16 | NR | NR |
| F7B6C | FC7B6 | NR | 0.05-0.16 | NR | NR |
| F7C6C | FC7C6 | NR | 0.05-0.16 | NR | NR |
| F7D6C | FC7D6 | NR | 0.05-0.16 | NR | NR |
| F7E6C | FC7E6 | NR | 0.05-0.16 | NR | NR |
| F8A1C | FC8A1 | NR | 0.05-0.16 | NR | NR |
| F8B1C | FC8B1 | NR | 0.05-0.16 | NR | NR |
| F8C1C | FC8C1 | NR | 0.05-0.16 | NR | NR |
| F8D1C | FC8D1 | NR | 0.05-0.16 | NR | NR |
| F8E1C | FC8E1 | NR | 0.05-0.16 | NR | NR |
| F8A2C | FC8A2 | NR | 0.05-0.16 | NR | NR |
| F8B2C | FC8B2 | NR | 0.05-0.16 | NR | NR |
| F8C2C | FC8C2 | NR | 0.05-0.16 | NR | NR |
| F8D2C | FC8D2 | NR | 0.05-0.16 | NR | NR |
| F8E2C | FC8E2 | NR | 0.05-0.16 | NR | NR |
| F8A3C | FC8A3 | NR | 0.05-0.16 | NR | NR |
| F8B3C | FC8B3 | NR | 0.05-0.16 | NR | NR |
| F8C3C | FC8C3 | NR | 0.05-0.16 | NR | NR |
| F8D3C | FC8D3 | NR | 0.05-0.16 | NR | NR |
| F8E3C | FC8E3 | NR | 0.05-0.16 | NR | NR |
| F8A4C | FC8A4 | NR | 0.05-0.16 | NR | NR |
| F8B4C | FC8B4 | NR | 0.05-0.16 | NR | NR |
| F8C4C | FC8C4 | NR | 0.05-0.16 | NR | NR |
| F8D4C | FC8D4 | NR | 0.05-0.16 | NR | NR |
| F8E4C | FC8E4 | NR | 0.05-0.16 | NR | NR |
| F8A5C | FC8A5 | NR | 0.05-0.16 | NR | NR |
| F8B5C | FC8B5 | NR | 0.05-0.16 | NR | NR |
| F8C5C | FC8C5 | NR | 0.05-0.16 | NR | NR |
| F8D5C | FC8D5 | NR | 0.05-0.16 | NR | NR |
| F8E5C | FC8E5 | NR | 0.05-0.16 | NR | NR |
| F8A6C | FC8A6 | NR | 0.05-0.16 | NR | NR |
| F8B6C | FC8B6 | NR | 0.05-0.16 | NR | NR |
| F8C6C | FC8C6 | NR | 0.05-0.16 | NR | NR |
| F8D6C | FC8D6 | NR | 0.05-0.16 | NR | NR |
| F8E6C | FC8E6 | NR | 0.05-0.16 | NR | NR |
| F1A1D | FC1A1 | NR | NR | 0.6-2.5 | 1.0-6.2 |
| F1B1D | FC1B1 | NR | NR | 0.6-2.5 | 1.0-6.2 |
| F1C1D | FC1C1 | NR | NR | 0.6-2.5 | 1.0-6.2 |
| F1D1D | FC1D1 | NR | NR | 0.6-2.5 | 1.0-6.2 |
| F1E1D | FC1E1 | NR | NR | 0.6-2.5 | 1.0-6.2 |
| F1A2D | FC1A2 | NR | NR | 0.6-2.5 | 1.0-6.2 |
| F1B2D | FC1B2 | NR | NR | 0.6-2.5 | 1.0-6.2 |
| F1C2D | FC1C2 | NR | NR | 0.6-2.5 | 1.0-6.2 |
| F1D2D | FC1D2 | NR | NR | 0.6-2.5 | 1.0-6.2 |
| F1E2D | FC1E2 | NR | NR | 0.6-2.5 | 1.0-6.2 |
| F1A3D | FC1A3 | NR | NR | 0.6-2.5 | 1.0-6.2 |
| F1B3D | FC1B3 | NR | NR | 0.6-2.5 | 1.0-6.2 |
| F1C3D | FC1C3 | NR | NR | 0.6-2.5 | 1.0-6.2 |
| F1D3D | FC1D3 | NR | NR | 0.6-2.5 | 1.0-6.2 |
| F1E3D | FC1E3 | NR | NR | 0.6-2.5 | 1.0-6.2 |
| F1A4D | FC1A4 | NR | NR | 0.6-2.5 | 1.0-6.2 |
| F1B4D | FC1B4 | NR | NR | 0.6-2.5 | 1.0-6.2 |
| F1C4D | FC1C4 | NR | NR | 0.6-2.5 | 1.0-6.2 |
| F1D4D | FC1D4 | NR | NR | 0.6-2.5 | 1.0-6.2 |
| F1E4D | FC1E4 | NR | NR | 0.6-2.5 | 1.0-6.2 |
| F1A5D | FC1A5 | NR | NR | 0.6-2.5 | 1.0-6.2 |
| F1B5D | FC1B5 | NR | NR | 0.6-2.5 | 1.0-6.2 |
| F1C5D | FC1C5 | NR | NR | 0.6-2.5 | 1.0-6.2 |
| F1D5D | FC1D5 | NR | NR | 0.6-2.5 | 1.0-6.2 |
| F1E5D | FC1E5 | NR | NR | 0.6-2.5 | 1.0-6.2 |
| F1A6D | FC1A6 | NR | NR | 0.6-2.5 | 1.0-6.2 |
| F1B6D | FC1B6 | NR | NR | 0.6-2.5 | 1.0-6.2 |
| F1C6D | FC1C6 | NR | NR | 0.6-2.5 | 1.0-6.2 |
| F1D6D | FC1D6 | NR | NR | 0.6-2.5 | 1.0-6.2 |
| F1E6D | FC1E6 | NR | NR | 0.6-2.5 | 1.0-6.2 |
| F2A1D | FC2A1 | NR | NR | 0.6-2.5 | 1.0-6.2 |
| F2B1D | FC2B1 | NR | NR | 0.6-2.5 | 1.0-6.2 |
| F2C1D | FC2C1 | NR | NR | 0.6-2.5 | 1.0-6.2 |
| F2D1D | FC2D1 | NR | NR | 0.6-2.5 | 1.0-6.2 |
| F2E1D | FC2E1 | NR | NR | 0.6-2.5 | 1.0-6.2 |
| F2A2D | FC2A2 | NR | NR | 0.6-2.5 | 1.0-6.2 |
| F2B2D | FC2B2 | NR | NR | 0.6-2.5 | 1.0-6.2 |
| F2C2D | FC2C2 | NR | NR | 0.6-2.5 | 1.0-6.2 |
| F2D2D | FC2D2 | NR | NR | 0.6-2.5 | 1.0-6.2 |
| F2E2D | FC2E2 | NR | NR | 0.6-2.5 | 1.0-6.2 |
| F2A3D | FC2A3 | NR | NR | 0.6-2.5 | 1.0-6.2 |
| F2B3D | FC2B3 | NR | NR | 0.6-2.5 | 1.0-6.2 |
| F2C3D | FC2C3 | NR | NR | 0.6-2.5 | 1.0-6.2 |
| F2D3D | FC2D3 | NR | NR | 0.6-2.5 | 1.0-6.2 |
| F2E3D | FC2E3 | NR | NR | 0.6-2.5 | 1.0-6.2 |
| F2A4D | FC2A4 | NR | NR | 0.6-2.5 | 1.0-6.2 |
| F2B4D | FC2B4 | NR | NR | 0.6-2.5 | 1.0-6.2 |
| F2C4D | FC2C4 | NR | NR | 0.6-2.5 | 1.0-6.2 |
| F2D4D | FC2D4 | NR | NR | 0.6-2.5 | 1.0-6.2 |
| F2E4D | FC2E4 | NR | NR | 0.6-2.5 | 1.0-6.2 |
| F2A5D | FC2A5 | NR | NR | 0.6-2.5 | 1.0-6.2 |
| F2B5D | FC2B5 | NR | NR | 0.6-2.5 | 1.0-6.2 |
| F2C5D | FC2C5 | NR | NR | 0.6-2.5 | 1.0-6.2 |
| F2D5D | FC2D5 | NR | NR | 0.6-2.5 | 1.0-6.2 |
| F2E5D | FC2E5 | NR | NR | 0.6-2.5 | 1.0-6.2 |
| F2A6D | FC2A6 | NR | NR | 0.6-2.5 | 1.0-6.2 |
| F2B6D | FC2B6 | NR | NR | 0.6-2.5 | 1.0-6.2 |
| F2C6D | FC2C6 | NR | NR | 0.6-2.5 | 1.0-6.2 |
| F2D6D | FC2D6 | NR | NR | 0.6-2.5 | 1.0-6.2 |
| F2E6D | FC2E6 | NR | NR | 0.6-2.5 | 1.0-6.2 |
| F3A1D | FC3A1 | NR | NR | 0.6-2.5 | 1.0-6.2 |
| F3B1D | FC3B1 | NR | NR | 0.6-2.5 | 1.0-6.2 |
| F3C1D | FC3C1 | NR | NR | 0.6-2.5 | 1.0-6.2 |
| F3D1D | FC3D1 | NR | NR | 0.6-2.5 | 1.0-6.2 |
| F3E1D | FC3E1 | NR | NR | 0.6-2.5 | 1.0-6.2 |
| F3A2D | FC3A2 | NR | NR | 0.6-2.5 | 1.0-6.2 |
| F3B2D | FC3B2 | NR | NR | 0.6-2.5 | 1.0-6.2 |
| F3C2D | FC3C2 | NR | NR | 0.6-2.5 | 1.0-6.2 |
| F3D2D | FC3D2 | NR | NR | 0.6-2.5 | 1.0-6.2 |
| F3E2D | FC3E2 | NR | NR | 0.6-2.5 | 1.0-6.2 |
| F3A3D | FC3A3 | NR | NR | 0.6-2.5 | 1.0-6.2 |
| F3B3D | FC3B3 | NR | NR | 0.6-2.5 | 1.0-6.2 |
| F3C3D | FC3C3 | NR | NR | 0.6-2.5 | 1.0-6.2 |
| F3D3D | FC3D3 | NR | NR | 0.6-2.5 | 1.0-6.2 |
| F3E3D | FC3E3 | NR | NR | 0.6-2.5 | 1.0-6.2 |
| F3A4D | FC3A4 | NR | NR | 0.6-2.5 | 1.0-6.2 |
| F3B4D | FC3B4 | NR | NR | 0.6-2.5 | 1.0-6.2 |
| F3C4D | FC3C4 | NR | NR | 0.6-2.5 | 1.0-6.2 |
| F3D4D | FC3D4 | NR | NR | 0.6-2.5 | 1.0-6.2 |
| F3E4D | FC3E4 | NR | NR | 0.6-2.5 | 1.0-6.2 |
| F3A5D | FC3A5 | NR | NR | 0.6-2.5 | 1.0-6.2 |
| F3B5D | FC3B5 | NR | NR | 0.6-2.5 | 1.0-6.2 |
| F3C5D | FC3C5 | NR | NR | 0.6-2.5 | 1.0-6.2 |
| F3D5D | FC3D5 | NR | NR | 0.6-2.5 | 1.0-6.2 |
| F3E5D | FC3E5 | NR | NR | 0.6-2.5 | 1.0-6.2 |
| F3A6D | FC3A6 | NR | NR | 0.6-2.5 | 1.0-6.2 |
| F3B6D | FC3B6 | NR | NR | 0.6-2.5 | 1.0-6.2 |
| F3C6D | FC3C6 | NR | NR | 0.6-2.5 | 1.0-6.2 |
| F3D6D | FC3D6 | NR | NR | 0.6-2.5 | 1.0-6.2 |
| F3E6D | FC3E6 | NR | NR | 0.6-2.5 | 1.0-6.2 |
| F4A1D | FC4A1 | NR | NR | 0.6-2.5 | 1.0-6.2 |
| F4B1D | FC4B1 | NR | NR | 0.6-2.5 | 1.0-6.2 |
| F4C1D | FC4C1 | NR | NR | 0.6-2.5 | 1.0-6.2 |
| F4D1D | FC4D1 | NR | NR | 0.6-2.5 | 1.0-6.2 |
| F4E1D | FC4E1 | NR | NR | 0.6-2.5 | 1.0-6.2 |
| F4A2D | FC4A2 | NR | NR | 0.6-2.5 | 1.0-6.2 |
| F4B2D | FC4B2 | NR | NR | 0.6-2.5 | 1.0-6.2 |
| F4C2D | FC4C2 | NR | NR | 0.6-2.5 | 1.0-6.2 |
| F4D2D | FC4D2 | NR | NR | 0.6-2.5 | 1.0-6.2 |
| F4E2D | FC4E2 | NR | NR | 0.6-2.5 | 1.0-6.2 |
| F4A3D | FC4A3 | NR | NR | 0.6-2.5 | 1.0-6.2 |
| F4B3D | FC4B3 | NR | NR | 0.6-2.5 | 1.0-6.2 |
| FC4C3D | FC4C3 | NR | NR | 0.6-2.5 | 1.0-6.2 |
| F4D3D | FC4D3 | NR | NR | 0.6-2.5 | 1.0-6.2 |
| F4E3D | FC4E3 | NR | NR | 0.6-2.5 | 1.0-6.2 |
| F4A4D | FC4A4 | NR | NR | 0.6-2.5 | 1.0-6.2 |
| F4B4D | FC4B4 | NR | NR | 0.6-2.5 | 1.0-6.2 |
| F4C4D | FC4C4 | NR | NR | 0.6-2.5 | 1.0-6.2 |
| F4D4D | FC4D4 | NR | NR | 0.6-2.5 | 1.0-6.2 |
| F4E4D | FC4E4 | NR | NR | 0.6-2.5 | 1.0-6.2 |
| F4A5D | FC4A5 | NR | NR | 0.6-2.5 | 1.0-6.2 |
| F4B5D | FC4B5 | NR | NR | 0.6-2.5 | 1.0-6.2 |
| F4C5D | FC4C5 | NR | NR | 0.6-2.5 | 1.0-6.2 |
| F4D5D | FC4D5 | NR | NR | 0.6-2.5 | 1.0-6.2 |
| F4E5D | FC4E5 | NR | NR | 0.6-2.5 | 1.0-6.2 |
| F4A6D | FC4A6 | NR | NR | 0.6-2.5 | 1.0-6.2 |
| F4B6D | FC4B6 | NR | NR | 0.6-2.5 | 1.0-6.2 |
| F4C6D | FC4C6 | NR | NR | 0.6-2.5 | 1.0-6.2 |
| F4D6D | FC4D6 | NR | NR | 0.6-2.5 | 1.0-6.2 |
| F4E6D | FC4E6 | NR | NR | 0.6-2.5 | 1.0-6.2 |
| F5A1D | FC5A1 | NR | NR | 0.6-2.5 | 1.0-6.2 |
| F5B1D | FC5B1 | NR | NR | 0.6-2.5 | 1.0-6.2 |
| F5C1D | FC5C1 | NR | NR | 0.6-2.5 | 1.0-6.2 |
| F5D1D | FC5D1 | NR | NR | 0.6-2.5 | 1.0-6.2 |
| F5E1D | FC5E1 | NR | NR | 0.6-2.5 | 1.0-6.2 |
| F5A2D | FC5A2 | NR | NR | 0.6-2.5 | 1.0-6.2 |
| F5B2D | FC5B2 | NR | NR | 0.6-2.5 | 1.0-6.2 |
| F5C2D | FC5C2 | NR | NR | 0.6-2.5 | 1.0-6.2 |
| F5D2D | FC5D2 | NR | NR | 0.6-2.5 | 1.0-6.2 |
| F5E2D | FC5E2 | NR | NR | 0.6-2.5 | 1.0-6.2 |
| F5A3D | FC5A3 | NR | NR | 0.6-2.5 | 1.0-6.2 |
| F5B3D | FC5B3 | NR | NR | 0.6-2.5 | 1.0-6.2 |
| F5C3D | FC5C3 | NR | NR | 0.6-2.5 | 1.0-6.2 |
| F5D3D | FC5D3 | NR | NR | 0.6-2.5 | 1.0-6.2 |
| F5E3D | FC5E3 | NR | NR | 0.6-2.5 | 1.0-6.2 |
| F5A4D | FC5A4 | NR | NR | 0.6-2.5 | 1.0-6.2 |
| F5B4D | FC5B4 | NR | NR | 0.6-2.5 | 1.0-6.2 |
| F5C4D | FC5C4 | NR | NR | 0.6-2.5 | 1.0-6.2 |
| F5D4D | FC5D4 | NR | NR | 0.6-2.5 | 1.0-6.2 |
| F5E4D | FC5E4 | NR | NR | 0.6-2.5 | 1.0-6.2 |
| F5A5D | FC5A5 | NR | NR | 0.6-2.5 | 1.0-6.2 |
| F5B5D | FC5B5 | NR | NR | 0.6-2.5 | 1.0-6.2 |
| F5C5D | FC5C5 | NR | NR | 0.6-2.5 | 1.0-6.2 |
| F5D5D | FC5D5 | NR | NR | 0.6-2.5 | 1.0-6.2 |
| F5E5D | FC5E5 | NR | NR | 0.6-2.5 | 1.0-6.2 |
| F5A6D | FC5A6 | NR | NR | 0.6-2.5 | 1.0-6.2 |
| F5B6D | FC5B6 | NR | NR | 0.6-2.5 | 1.0-6.2 |
| F5C6D | FC5C6 | NR | NR | 0.6-2.5 | 1.0-6.2 |
| F5D6D | FC5D6 | NR | NR | 0.6-2.5 | 1.0-6.2 |
| F5E6D | FC5E6 | NR | NR | 0.6-2.5 | 1.0-6.2 |
| F6A1D | FC6A1 | NR | NR | 0.6-2.5 | 1.0-6.2 |
| F6B1D | FC6B1 | NR | NR | 0.6-2.5 | 1.0-6.2 |
| F6C1D | FC6C1 | NR | NR | 0.6-2.5 | 1.0-6.2 |
| F6D1D | FC6D1 | NR | NR | 0.6-2.5 | 1.0-6.2 |
| F6E1D | FC6E1 | NR | NR | 0.6-2.5 | 1.0-6.2 |
| F6A2D | FC6A2 | NR | NR | 0.6-2.5 | 1.0-6.2 |
| F6B2D | FC6B2 | NR | NR | 0.6-2.5 | 1.0-6.2 |
| F6C2D | FC6C2 | NR | NR | 0.6-2.5 | 1.0-6.2 |
| F6D2D | FC6D2 | NR | NR | 0.6-2.5 | 1.0-6.2 |
| F6E2D | FC6E2 | NR | NR | 0.6-2.5 | 1.0-6.2 |
| F6A3D | FC6A3 | NR | NR | 0.6-2.5 | 1.0-6.2 |
| F6B3D | FC6B3 | NR | NR | 0.6-2.5 | 1.0-6.2 |
| F6C3D | FC6C3 | NR | NR | 0.6-2.5 | 1.0-6.2 |
| F6D3D | FC6D3 | NR | NR | 0.6-2.5 | 1.0-6.2 |
| F6E3D | FC6E3 | NR | NR | 0.6-2.5 | 1.0-6.2 |
| F6B4D | FC6B4 | NR | NR | 0.6-2.5 | 1.0-6.2 |
| F6C4D | FC6C4 | NR | NR | 0.6-2.5 | 1.0-6.2 |
| F6D4D | FC6D4 | NR | NR | 0.6-2.5 | 1.0-6.2 |
| F6E4D | FC6E4 | NR | NR | 0.6-2.5 | 1.0-6.2 |
| F6A5D | FC6A5 | NR | NR | 0.6-2.5 | 1.0-6.2 |
| F6B5D | FC6B5 | NR | NR | 0.6-2.5 | 1.0-6.2 |
| F6C5D | FC6C5 | NR | NR | 0.6-2.5 | 1.0-6.2 |
| F6D5D | FC6D5 | NR | NR | 0.6-2.5 | 1.0-6.2 |
| F6E5D | FC6E5 | NR | NR | 0.6-2.5 | 1.0-6.2 |
| F6A6D | FC6A6 | NR | NR | 0.6-2.5 | 1.0-6.2 |
| F6B6D | FC6B6 | NR | NR | 0.6-2.5 | 1.0-6.2 |
| F6C6D | FC6C6 | NR | NR | 0.6-2.5 | 1.0-6.2 |
| F6D6D | FC6D6 | NR | NR | 0.6-2.5 | 1.0-6.2 |
| F6E6D | FC6E6 | NR | NR | 0.6-2.5 | 1.0-6.2 |
| F7A1D | FC7A1 | NR | NR | 0.6-2.5 | 1.0-6.2 |
| F7B1D | FC7B1 | NR | NR | 0.6-2.5 | 1.0-6.2 |
| F7C1D | FC7C1 | NR | NR | 0.6-2.5 | 1.0-6.2 |
| F7D1D | FC7D1 | NR | NR | 0.6-2.5 | 1.0-6.2 |
| F7E1D | FC7E1 | NR | NR | 0.6-2.5 | 1.0-6.2 |
| F7A2D | FC7A2 | NR | NR | 0.6-2.5 | 1.0-6.2 |
| F7B2D | FC7B2 | NR | NR | 0.6-2.5 | 1.0-6.2 |
| F7C2D | FC7C2 | NR | NR | 0.6-2.5 | 1.0-6.2 |
| F7D2D | FC7D2 | NR | NR | 0.6-2.5 | 1.0-6.2 |
| F7E2D | FC7E2 | NR | NR | 0.6-2.5 | 1.0-6.2 |
| F7A3D | FC7A3 | NR | NR | 0.6-2.5 | 1.0-6.2 |
| F7B3D | FC7B3 | NR | NR | 0.6-2.5 | 1.0-6.2 |
| F7C3D | FC7C3 | NR | NR | 0.6-2.5 | 1.0-6.2 |
| F7D3D | FC7D3 | NR | NR | 0.6-2.5 | 1.0-6.2 |
| F7E3D | FC7E3 | NR | NR | 0.6-2.5 | 1.0-6.2 |
| F7A4D | FC7A4 | NR | NR | 0.6-2.5 | 1.0-6.2 |
| F7B4D | FC7B4 | NR | NR | 0.6-2.5 | 1.0-6.2 |
| F7C4D | FC7C4 | NR | NR | 0.6-2.5 | 1.0-6.2 |
| F7D4D | FC7D4 | NR | NR | 0.6-2.5 | 1.0-6.2 |
| F7E4D | FC7E4 | NR | NR | 0.6-2.5 | 1.0-6.2 |
| F7A5D | FC7A5 | NR | NR | 0.6-2.5 | 1.0-6.2 |
| F7B5D | FC7B5 | NR | NR | 0.6-2.5 | 1.0-6.2 |
| F7C5D | FC7C5 | NR | NR | 0.6-2.5 | 1.0-6.2 |
| F7D5D | FC7D5 | NR | NR | 0.6-2.5 | 1.0-6.2 |
| F7E5D | FC7E5 | NR | NR | 0.6-2.5 | 1.0-6.2 |
| F7A6D | FC7A6 | NR | NR | 0.6-2.5 | 1.0-6.2 |
| F7B6D | FC7B6 | NR | NR | 0.6-2.5 | 1.0-6.2 |
| F7C6D | FC7C6 | NR | NR | 0.6-2.5 | 1.0-6.2 |
| F7D6D | FC7D6 | NR | NR | 0.6-2.5 | 1.0-6.2 |
| F7E6D | FC7E6 | NR | NR | 0.6-2.5 | 1.0-6.2 |
| F8A1D | FC8A1 | NR | NR | 0.6-2.5 | 1.0-6.2 |
| F8B1D | FC8B1 | NR | NR | 0.6-2.5 | 1.0-6.2 |
| F8C1D | FC8C1 | NR | NR | 0.6-2.5 | 1.0-6.2 |
| F8D1B | FC8D1 | NR | NR | 0.6-2.5 | 1.0-6.2 |
| F8E1D | FC8E1 | NR | NR | 0.6-2.5 | 1.0-6.2 |
| F8A2B | FC8A2 | NR | NR | 0.6-2.5 | 1.0-6.2 |
| F8B2D | FC8B2 | NR | NR | 0.6-2.5 | 1.0-6.2 |
| F8C2D | FC8C2 | NR | NR | 0.6-2.5 | 1.0-6.2 |
| F8D2D | FC8D2 | NR | NR | 0.6-2.5 | 1.0-6.2 |
| F8E2D | FC8E2 | NR | NR | 0.6-2.5 | 1.0-6.2 |
| F8A3D | FC8A3 | NR | NR | 0.6-2.5 | 1.0-6.2 |
| F8B3D | FC8B3 | NR | NR | 0.6-2.5 | 1.0-6.2 |
| F8C3D | FC8C3 | NR | NR | 0.6-2.5 | 1.0-6.2 |
| F8D3D | FC8D3 | NR | NR | 0.6-2.5 | 1.0-6.2 |
| F8E3D | FC8E3 | NR | NR | 0.6-2.5 | 1.0-6.2 |
| F8A4D | FC8A4 | NR | NR | 0.6-2.5 | 1.0-6.2 |
| F8B4D | FC8B4 | NR | NR | 0.6-2.5 | 1.0-6.2 |
| F8C4D | FC8C4 | NR | NR | 0.6-2.5 | 1.0-6.2 |
| F8D4D | FC8D4 | NR | NR | 0.6-2.5 | 1.0-6.2 |
| F8E4D | FC8E4 | NR | NR | 0.6-2.5 | 1.0-6.2 |
| F8A5D | FC8A5 | NR | NR | 0.6-2.5 | 1.0-6.2 |
| F8B5D | FC8B5 | NR | NR | 0.6-2.5 | 1.0-6.2 |
| F8C5D | FC8C5 | NR | NR | 0.6-2.5 | 1.0-6.2 |
| F8D5D | FC8D5 | NR | NR | 0.6-2.5 | 1.0-6.2 |
| F8E5D | FC8E5 | NR | NR | 0.6-2.5 | 1.0-6.2 |
| F8A6D | FC8A6 | NR | NR | 0.6-2.5 | 1.0-6.2 |
| F8B6D | FC8B6 | NR | NR | 0.6-2.5 | 1.0-6.2 |
| F8C6D | FC8C6 | NR | NR | 0.6-2.5 | 1.0-6.2 |
| F8D6D | FC8D6 | NR | NR | 0.6-2.5 | 1.0-6.2 |
| F8E6D | FC8E6 | NR | NR | 0.6-2.5 | 1.0-6.2 |
| F1A1E | FC1A1 | >25% | 0.05-0.1 | 0.6-2.5 | 1.0-6.2 |
| F1B1E | FC1B1 | NR | NR | 0.6-2.5 | 1.0-6.2 |
| F1C1E | FC1C1 | NR | NR | 0.6-2.5 | 1.0-6.2 |
| F1D1E | FC1D1 | NR | NR | 0.6-2.5 | 1.0-6.2 |
| F1E1E | FC1E1 | NR | NR | 0.6-2.5 | 1.0-6.2 |
| F1A2E | FC1A2 | NR | NR | 0.6-2.5 | 1.0-6.2 |
| F1B2E | FC1B2 | NR | NR | 0.6-2.5 | 1.0-6.2 |
| F1C2E | FC1C2 | NR | NR | 0.6-2.5 | 1.0-6.2 |
| F1D2E | FC1D2 | NR | NR | 0.6-2.5 | 1.0-6.2 |
| F1E2E | FC1E2 | NR | NR | 0.6-2.5 | 1.0-6.2 |
| F1A3E | FC1A3 | NR | NR | 0.6-2.5 | 1.0-6.2 |
| F1B3E | FC1B3 | NR | NR | 0.6-2.5 | 1.0-6.2 |
| F1C3E | FC1C3 | NR | NR | 0.6-2.5 | 1.0-6.2 |
| F1D3E | FC1D3 | NR | NR | 0.6-2.5 | 1.0-6.2 |
| F1E3E | FC1E3 | NR | NR | 0.6-2.5 | 1.0-6.2 |
| F1A4E | FC1A4 | NR | NR | 0.6-2.5 | 1.0-6.2 |
| F1B4E | FC1B4 | NR | NR | 0.6-2.5 | 1.0-6.2 |
| F1C4E | FC1C4 | NR | NR | 0.6-2.5 | 1.0-6.2 |
| F1D4E | FC1D4 | NR | NR | 0.6-2.5 | 1.0-6.2 |
| F1E4E | FC1E4 | NR | NR | 0.6-2.5 | 1.0-6.2 |
| F1A5E | FC1A5 | NR | NR | 0.6-2.5 | 1.0-6.2 |
| F1B5E | FC1B5 | NR | NR | 0.6-2.5 | 1.0-6.2 |
| F1C5E | FC1C5 | NR | NR | 0.6-2.5 | 1.0-6.2 |
| F1D5E | FC1D5 | NR | NR | 0.6-2.5 | 1.0-6.2 |
| F1E5E | FC1E5 | NR | NR | 0.6-2.5 | 1.0-6.2 |
| F1A6E | FC1A6 | NR | NR | 0.6-2.5 | 1.0-6.2 |
| F1B6E | FC1B6 | NR | NR | 0.6-2.5 | 1.0-6.2 |
| F1C6E | FC1C6 | NR | NR | 0.6-2.5 | 1.0-6.2 |
| F1D6E | FC1D6 | NR | NR | 0.6-2.5 | 1.0-6.2 |
| F1E6E | FC1E6 | NR | NR | 0.6-2.5 | 1.0-6.2 |
| F2A1E | FC2A1 | NR | NR | 0.6-2.5 | 1.0-6.2 |
| F2B1E | FC2B1 | NR | NR | 0.6-2.5 | 1.0-6.2 |
| F2C1E | FC2C1 | NR | NR | 0.6-2.5 | 1.0-6.2 |
| F2D1E | FC2D1 | NR | NR | 0.6-2.5 | 1.0-6.2 |
| F2E1E | FC2E1 | NR | NR | 0.6-2.5 | 1.0-6.2 |
| F2A2E | FC2A2 | NR | NR | 0.6-2.5 | 1.0-6.2 |
| F2B2E | FC2B2 | NR | NR | 0.6-2.5 | 1.0-6.2 |
| F2C2E | FC2C2 | NR | NR | 0.6-2.5 | 1.0-6.2 |
| F2D2E | FC2D2 | NR | NR | 0.6-2.5 | 1.0-6.2 |
| F2E2E | FC2E2 | NR | NR | 0.6-2.5 | 1.0-6.2 |
| F2A3E | FC2A3 | NR | NR | 0.6-2.5 | 1.0-6.2 |
| F2B3E | FC2B3 | NR | NR | 0.6-2.5 | 1.0-6.2 |
| F2C3E | FC2C3 | NR | NR | 0.6-2.5 | 1.0-6.2 |
| F2D3E | FC2D3 | NR | NR | 0.6-2.5 | 1.0-6.2 |
| F2E3E | FC2E3 | NR | NR | 0.6-2.5 | 1.0-6.2 |
| F2A4E | FC2A4 | NR | NR | 0.6-2.5 | 1.0-6.2 |
| F2B4E | FC2B4 | NR | NR | 0.6-2.5 | 1.0-6.2 |
| F2C4E | FC2C4 | NR | NR | 0.6-2.5 | 1.0-6.2 |
| F2D4E | FC2D4 | NR | NR | 0.6-2.5 | 1.0-6.2 |
| F2E4E | FC2E4 | NR | NR | 0.6-2.5 | 1.0-6.2 |
| F2A5E | FC2A5 | NR | NR | 0.6-2.5 | 1.0-6.2 |
| F2B5E | FC2B5 | NR | NR | 0.6-2.5 | 1.0-6.2 |
| F2C5E | FC2C5 | NR | NR | 0.6-2.5 | 1.0-6.2 |
| F2D5E | FC2D5 | NR | NR | 0.6-2.5 | 1.0-6.2 |
| F2E5E | FC2E5 | NR | NR | 0.6-2.5 | 1.0-6.2 |
| F2A6E | FC2A6 | NR | NR | 0.6-2.5 | 1.0-6.2 |
| F2B6E | FC2B6 | NR | NR | 0.6-2.5 | 1.0-6.2 |
| F2C6E | FC2C6 | NR | NR | 0.6-2.5 | 1.0-6.2 |
| F2D6E | FC2D6 | NR | NR | 0.6-2.5 | 1.0-6.2 |
| F2E6E | FC2E6 | NR | NR | 0.6-2.5 | 1.0-6.2 |
| F3A1E | FC3A1 | NR | NR | 0.6-2.5 | 1.0-6.2 |
| F3B1E | FC3B1 | NR | NR | 0.6-2.5 | 1.0-6.2 |
| F3C1E | FC3C1 | NR | NR | 0.6-2.5 | 1.0-6.2 |
| F3D1E | FC3D1 | NR | NR | 0.6-2.5 | 1.0-6.2 |
| F3E1E | FC3E1 | NR | NR | 0.6-2.5 | 1.0-6.2 |
| F3A2E | FC3A2 | NR | NR | 0.6-2.5 | 1.0-6.2 |
| F3B2E | FC3B2 | NR | NR | 0.6-2.5 | 1.0-6.2 |
| F3C2E | FC3C2 | NR | NR | 0.6-2.5 | 1.0-6.2 |
| F3D2E | FC3D2 | NR | NR | 0.6-2.5 | 1.0-6.2 |
| F3E2E | FC3E2 | NR | NR | 0.6-2.5 | 1.0-6.2 |
| F3A3E | FC3A3 | NR | NR | 0.6-2.5 | 1.0-6.2 |
| F3B3E | FC3B3 | NR | NR | 0.6-2.5 | 1.0-6.2 |
| F3C3E | FC3C3 | NR | NR | 0.6-2.5 | 1.0-6.2 |
| F3D3E | FC3D3 | NR | NR | 0.6-2.5 | 1.0-6.2 |
| F3E3E | FC3E3 | NR | NR | 0.6-2.5 | 1.0-6.2 |
| F3A4E | FC3A4 | NR | NR | 0.6-2.5 | 1.0-6.2 |
| F3B4E | FC3B4 | NR | NR | 0.6-2.5 | 1.0-6.2 |
| F3C4E | FC3C4 | NR | NR | 0.6-2.5 | 1.0-6.2 |
| F3D4E | FC3D4 | NR | NR | 0.6-2.5 | 1.0-6.2 |
| F3E4E | FC3E4 | NR | NR | 0.6-2.5 | 1.0-6.2 |
| F3A5E | FC3A5 | NR | NR | 0.6-2.5 | 1.0-6.2 |
| F3B5E | FC3B5 | NR | NR | 0.6-2.5 | 1.0-6.2 |
| F3C5E | FC3C5 | NR | NR | 0.6-2.5 | 1.0-6.2 |
| F3D5E | FC3D5 | NR | NR | 0.6-2.5 | 1.0-6.2 |
| F3E5E | FC3E5 | NR | NR | 0.6-2.5 | 1.0-6.2 |
| F3A6E | FC3A6 | NR | NR | 0.6-2.5 | 1.0-6.2 |
| F3B6E | FC3B6 | NR | NR | 0.6-2.5 | 1.0-6.2 |
| F3C6E | FC3C6 | NR | NR | 0.6-2.5 | 1.0-6.2 |
| F3D6E | FC3D6 | NR | NR | 0.6-2.5 | 1.0-6.2 |
| F3E6E | FC3E6 | NR | NR | 0.6-2.5 | 1.0-6.2 |
| F4A1E | FC4A1 | NR | NR | 0.6-2.5 | 1.0-6.2 |
| F4B1E | FC4B1 | NR | NR | 0.6-2.5 | 1.0-6.2 |
| F4C1E | FC4C1 | NR | NR | 0.6-2.5 | 1.0-6.2 |
| F4D1E | FC4D1 | NR | NR | 0.6-2.5 | 1.0-6.2 |
| F4E1E | FC4E1 | NR | NR | 0.6-2.5 | 1.0-6.2 |
| F4A2E | FC4A2 | NR | NR | 0.6-2.5 | 1.0-6.2 |
| F4B2E | FC4B2 | NR | NR | 0.6-2.5 | 1.0-6.2 |
| F4C2E | FC4C2 | NR | NR | 0.6-2.5 | 1.0-6.2 |
| F4D2E | FC4D2 | NR | NR | 0.6-2.5 | 1.0-6.2 |
| F4E2E | FC4E2 | NR | NR | 0.6-2.5 | 1.0-6.2 |
| F4A3E | FC4A3 | NR | NR | 0.6-2.5 | 1.0-6.2 |
| F4B3E | FC4B3 | NR | NR | 0.6-2.5 | 1.0-6.2 |
| F4C3E | FC4C3 | NR | NR | 0.6-2.5 | 1.0-6.2 |
| F4D3E | FC4D3 | NR | NR | 0.6-2.5 | 1.0-6.2 |
| F4E3E | FC4E3 | NR | NR | 0.6-2.5 | 1.0-6.2 |
| F4A4E | FC4A4 | NR | NR | 0.6-2.5 | 1.0-6.2 |
| F4B4E | FC4B4 | NR | NR | 0.6-2.5 | 1.0-6.2 |
| F4C4E | FC4C4 | NR | NR | 0.6-2.5 | 1.0-6.2 |
| F4D4E | FC4D4 | NR | NR | 0.6-2.5 | 1.0-6.2 |
| F4E4E | FC4E4 | NR | NR | 0.6-2.5 | 1.0-6.2 |
| F4A5E | FC4A5 | NR | NR | 0.6-2.5 | 1.0-6.2 |
| F4B5E | FC4B5 | NR | NR | 0.6-2.5 | 1.0-6.2 |
| F4C5E | FC4C5 | NR | NR | 0.6-2.5 | 1.0-6.2 |
| F4D5E | FC4D5 | NR | NR | 0.6-2.5 | 1.0-6.2 |
| F4E5E | FC4E5 | NR | NR | 0.6-2.5 | 1.0-6.2 |
| F4A6E | FC4A6 | NR | NR | 0.6-2.5 | 1.0-6.2 |
| F4B6E | FC4B6 | NR | NR | 0.6-2.5 | 1.0-6.2 |
| F4C6E | FC4C6 | NR | NR | 0.6-2.5 | 1.0-6.2 |
| F4D6E | FC4D6 | NR | NR | 0.6-2.5 | 1.0-6.2 |
| F4E6E | FC4E6 | NR | NR | 0.6-2.5 | 1.0-6.2 |
| F5A1E | FC5A1 | NR | NR | 0.6-2.5 | 1.0-6.2 |
| F5B1E | FC5B1 | NR | NR | 0.6-2.5 | 1.0-6.2 |
| F5C1E | FC5C1 | NR | NR | 0.6-2.5 | 1.0-6.2 |
| F5D1E | FC5D1 | NR | NR | 0.6-2.5 | 1.0-6.2 |
| F5E1E | FC5E1 | NR | NR | 0.6-2.5 | 1.0-6.2 |
| F5A2E | FC5A2 | NR | NR | 0.6-2.5 | 1.0-6.2 |
| F5B2E | FC5B2 | NR | NR | 0.6-2.5 | 1.0-6.2 |
| F5C2E | FC5C2 | NR | NR | 0.6-2.5 | 1.0-6.2 |
| F5D2E | FC5D2 | NR | NR | 0.6-2.5 | 1.0-6.2 |
| F5E2E | FC5E2 | NR | NR | 0.6-2.5 | 1.0-6.2 |
| F5A3E | FC5A3 | NR | NR | 0.6-2.5 | 1.0-6.2 |
| F5B3E | FC5B3 | NR | NR | 0.6-2.5 | 1.0-6.2 |
| F5C3E | FC5C3 | NR | NR | 0.6-2.5 | 1.0-6.2 |
| F5D3E | FC5D3 | NR | NR | 0.6-2.5 | 1.0-6.2 |
| F5E3E | FC5E3 | NR | NR | 0.6-2.5 | 1.0-6.2 |
| F5A4E | FC5A4 | NR | NR | 0.6-2.5 | 1.0-6.2 |
| F5B4E | FC5B4 | NR | NR | 0.6-2.5 | 1.0-6.2 |
| F5C4E | FC5C4 | NR | NR | 0.6-2.5 | 1.0-6.2 |
| F5D4E | FC5D4 | NR | NR | 0.6-2.5 | 1.0-6.2 |
| F5E4E | FC5E4 | NR | NR | 0.6-2.5 | 1.0-6.2 |
| F5A5E | FC5A5 | NR | NR | 0.6-2.5 | 1.0-6.2 |
| F5B5B | FC5E5 | NR | NR | 0.6-2.5 | 1.0-6.2 |
| F5C5E | FC5C5 | NR | NR | 0.6-2.5 | 1.0-6.2 |
| F5D5E | FC5D5 | NR | NR | 0.6-2.5 | 1.0-6.2 |
| F5E5E | FC5E5 | NR | NR | 0.6-2.5 | 1.0-6.2 |
| F5A6E | FC5A6 | NR | NR | 0.6-2.5 | 1.0-6.2 |
| F5B6E | FC5B6 | NR | NR | 0.6-2.5 | 1.0-6.2 |
| F5C6E | FC5C6 | NR | NR | 0.6-2.5 | 1.0-6.2 |
| F5D6E | FC5D6 | NR | NR | 0.6-2.5 | 1.0-6.2 |
| F5E6E | FC5E6 | NR | NR | 0.6-2.5 | 1.0-6.2 |
| F6A1E | FC6A1 | NR | NR | 0.6-2.5 | 1.0-6.2 |
| F6B1E | FC6B1 | NR | NR | 0.6-2.5 | 1.0-6.2 |
| F6C1E | FC6C1 | NR | NR | 0.6-2.5 | 1.0-6.2 |
| F6D1E | FC6D1 | NR | NR | 0.6-2.5 | 1.0-6.2 |
| F6E1E | FC6E1 | NR | NR | 0.6-2.5 | 1.0-6.2 |
| F6A2E | FC6A2 | NR | NR | 0.6-2.5 | 1.0-6.2 |
| F6B2E | FC6E2 | NR | NR | 0.6-2.5 | 1.0-6.2 |
| F6C2E | FC6C2 | NR | NR | 0.6-2.5 | 1.0-6.2 |
| F6D2E | FC6D2 | NR | NR | 0.6-2.5 | 1.0-6.2 |
| F6E2E | FC6E2 | NR | NR | 0.6-2.5 | 1.0-6.2 |
| F6A3E | FC6A3 | NR | NR | 0.6-2.5 | 1.0-6.2 |
| F6B3E | FC6B3 | NR | NR | 0.6-2.5 | 1.0-6.2 |
| F6C3E | FC6C3 | NR | NR | 0.6-2.5 | 1.0-6.2 |
| F6D3E | FC6D3 | NR | NR | 0.6-2.5 | 1.0-6.2 |
| F6E3E | FC6E3 | NR | NR | 0.6-2.5 | 1.0-6.2 |
| F6A4E | FC6A4 | NR | NR | 0.6-2.5 | 1.0-6.2 |
| F6B4E | FC6B4 | NR | NR | 0.6-2.5 | 1.0-6.2 |
| F6C4E | FC6C4 | NR | NR | 0.6-2.5 | 1.0-6.2 |
| F6D4E | FC6D4 | NR | NR | 0.6-2.5 | 1.0-6.2 |
| F6E4E | FC6E4 | NR | NR | 0.6-2.5 | 1.0-6.2 |
| F6A5E | FC6A5 | NR | NR | 0.6-2.5 | 1.0-6.2 |
| F6B5E | FC6B5 | NR | NR | 0.6-2.5 | 1.0-6.2 |
| F6C5E | FC6C5 | NR | NR | 0.6-2.5 | 1.0-6.2 |
| F6D5E | FC6D5 | NR | NR | 0.6-2.5 | 1.0-6.2 |
| F6E5E | FC6E5 | NR | NR | 0.6-2.5 | 1.0-6.2 |
| F6A6E | FC6A6 | NR | NR | 0.6-2.5 | 1.0-6.2 |
| F6B6E | FC6B6 | NR | NR | 0.6-2.5 | 1.0-6.2 |
| F6C6E | FC6C6 | NR | NR | 0.6-2.5 | 1.0-6.2 |
| F6D6E | FC6D6 | NR | NR | 0.6-2.5 | 1.0-6.2 |
| F6E6E | FC6E6 | NR | NR | 0.6-2.5 | 1.0-6.2 |
| F7A1E | FC7A1 | NR | NR | 0.6-2.5 | 1.0-6.2 |
| F7B1E | FC7B1 | NR | NR | 0.6-2.5 | 1.0-6.2 |
| F7C1E | FC7C1 | NR | NR | 0.6-2.5 | 1.0-6.2 |
| F7D1E | FC7D1 | NR | NR | 0.6-2.5 | 1.0-6.2 |
| F7E1E | FC7E1 | NR | NR | 0.6-2.5 | 1.0-6.2 |
| F7A2E | FC7A2 | NR | NR | 0.6-2.5 | 1.0-6.2 |
| F7B2E | FC7B2 | NR | NR | 0.6-2.5 | 1.0-6.2 |
| F7C2E | FC7C2 | NR | NR | 0.6-2.5 | 1.0-6.2 |
| F7D2E | FC7D2 | NR | NR | 0.6-2.5 | 1.0-6.2 |
| F7E2E | FC7E2 | NR | NR | 0.6-2.5 | 1.0-6.2 |
| F7A3E | FC7A3 | NR | NR | 0.6-2.5 | 1.0-6.2 |
| F7B3E | FC7B3 | NR | NR | 0.6-2.5 | 1.0-6.2 |
| F7C3E | FC7C3 | NR | NR | 0.6-2.5 | 1.0-6.2 |
| F7D3E | FC7D3 | NR | NR | 0.6-2.5 | 1.0-6.2 |
| F7E3E | FC7E3 | NR | NR | 0.6-2.5 | 1.0-6.2 |
| F7A4E | FC7A4 | NR | NR | 0.6-2.5 | 1.0-6.2 |
| F7B4E | FC7B4 | NR | NR | 0.6-2.5 | 1.0-6.2 |
| F7C4E | FC7C4 | NR | NR | 0.6-2.5 | 1.0-6.2 |
| F7D4E | FC7D4 | NR | NR | 0.6-2.5 | 1.0-6.2 |
| F7E4E | FC7E4 | NR | NR | 0.6-2.5 | 1.0-6.2 |
| F7A5E | FC7A5 | NR | NR | 0.6-2.5 | 1.0-6.2 |
| F7B5E | FC7B5 | NR | NR | 0.6-2.5 | 1.0-6.2 |
| F7C5E | FC7C5 | NR | NR | 0.6-2.5 | 1.0-6.2 |
| F7D5E | FC7D5 | NR | NR | 0.6-2.5 | 1.0-6.2 |
| F7E5E | FC7E5 | NR | NR | 0.6-2.5 | 1.0-6.2 |
| F7A6E | FC7A6 | NR | NR | 0.6-2.5 | 1.0-6.2 |
| F7B6E | FC7B6 | NR | NR | 0.6-2.5 | 1.0-6.2 |
| F7C6E | FC7C6 | NR | NR | 0.6-2.5 | 1.0-6.2 |
| F7D6E | FC7D6 | NR | NR | 0.6-2.5 | 1.0-6.2 |
| F7E6E | FC7E6 | NR | NR | 0.6-2.5 | 1.0-6.2 |
| F8A1E | FC8A1 | NR | NR | 0.6-2.5 | 1.0-6.2 |
| F8B1E | FC8B1 | NR | NR | 0.6-2.5 | 1.0-6.2 |
| F8C1E | FC8C1 | NR | NR | 0.6-2.5 | 1.0-6.2 |
| F8D1E | FC8D1 | NR | NR | 0.6-2.5 | 1.0-6.2 |
| F8E1E | FC8E1 | NR | NR | 0.6-2.5 | 1.0-6.2 |
| F8A2E | FC8A2 | NR | NR | 0.6-2.5 | 1.0-6.2 |
| F8B2E | FC8B2 | NR | NR | 0.6-2.5 | 1.0-6.2 |
| F8C2E | FC8C2 | NR | NR | 0.6-2.5 | 1.0-6.2 |
| F8D2E | FC8D2 | NR | NR | 0.6-2.5 | 1.0-6.2 |
| F8E2E | FC8E2 | NR | NR | 0.6-2.5 | 1.0-6.2 |
| F8A3E | FC8A3 | NR | NR | 0.6-2.5 | 1.0-6.2 |
| F8B3E | FC8B3 | NR | NR | 0.6-2.5 | 1.0-6.2 |
| F8C3E | FC8C3 | NR | NR | 0.6-2.5 | 1.0-6.2 |
| F8D3E | FC8D3 | NR | NR | 0.6-2.5 | 1.0-6.2 |
| F8E3E | FC8E3 | NR | NR | 0.6-2.5 | 1.0-6.2 |
| F8A4E | FC8A4 | NR | NR | 0.6-2.5 | 1.0-6.2 |
| F8B4E | FC8B4 | NR | NR | 0.6-2.5 | 1.0-6.2 |
| F8C4E | FC8C4 | NR | NR | 0.6-2.5 | 1.0-6.2 |
| F8D4E | FC8D4 | NR | NR | 0.6-2.5 | 1.0-6.2 |
| F8E4E | FC8E4 | NR | NR | 0.6-2.5 | 1.0-6.2 |
| F8A5E | FC8A5 | NR | NR | 0.6-2.5 | 1.0-6.2 |
| F8B5E | FC8B5 | NR | NR | 0.6-2.5 | 1.0-6.2 |
| F8C5E | FC8C5 | NR | NR | 0.6-2.5 | 1.0-6.2 |
| F8D5E | FC8D5 | NR | NR | 0.6-2.5 | 1.0-6.2 |
| F8E5E | FC8E5 | NR | NR | 0.6-2.5 | 1.0-6.2 |
| F8A6E | FC8A6 | NR | NR | 0.6-2.5 | 1.0-6.2 |
| F8B6E | FC8B6 | NR | NR | 0.6-2.5 | 1.0-6.2 |
| F8C6E | FC8C6 | NR | NR | 0.6-2.5 | 1.0-6.2 |
| F8D6E | FC8D6 | NR | NR | 0.6-2.5 | 1.0-6.2 |
| F8E6E | FC8E6 | NR | NR | 0.6-2.5 | 1.0-6.2 |

The foams of the present invention have wide utility. The present foams, including each of Foams 1-6 and foams F1-F8, have unexpected advantage in applications requiring low density and/or good compression and/or tensile and/or shear properties, and/or long-term stability, and/or sustainable sourcing, and/or being made from recycled material and being recyclable. In particular, the present foams, including each of Foams 1-6 and each of foams F1-F8, have unexpected advantage in: wind energy applications (wind turbine blades (shear webs, shells, cores, and root); marine applications (hulls, decks, superstructures, bulkheads, stringers, and interiors); industrial low weight applications; automotive and transport applications (interior and exterior of cars, trucks, trains, aircraft, and spacecraft).

### EXAMPLES

### Example 1A-PEF Preparation at Mw 114,000 with PMDA Chain Extender and SSP

A bio-based polyethylene furanoate homopolymer was prepared by esterification and polycondensation of 2,5-furandicarboxylic acid with mono ethylene glycol according to known methods to produce PEF homopolymer, which is then treated according to techniques corresponding to the techniques described in detail in Examples 47, 49 and 51 below, with the chain extender PMDA at 0.6% by weight and then subject to solid state polymerization according to known techniques to produce a PEF homopolymer. The PEF polymer was tested and found to have the following characteristics¹: ¹ Molecular weight as determined and referenced herein refers to molecular weight determination by diffusion ordered nuclear magnetic resonance spectroscopy (DOSY NMR) as per the description contained in “Application of 1H DOSY NMR in Measurement of Polystyrene Molecular Weights,” VNU Journal of Science: Natural Sciences and Technology, Vol. 36, No. 2 (2020) 16-21 Jun. 2020, Nam et al., with final fitting performed by two functions: log D=α log M+log A (as per Grubb's Group, Macromolecules 2012, 45, 9595-9603) R2=0.977 and log D=α log M+β [log (M)]2+A (R2=0.998) with a final fit of the data as follows: α: 0.4816276533; β: −0.064669629A: −21.74524435. Decomposition temperature was determined by thermogravimetric analysis (TGA) based on ASTM E1131. Density of the polymer was measured in accordance with ASTM D71). The remaining properties, including crystallinity, were determined in accordance ASTM D3418 and ASTM E1356.
Molecular Weight—114,000
Density (g/cc)—1.43
Glass Transition Temperature—86° C.
Melt Temperature—214° C.
Decomposition Temperature—347° C.
Crystallinity—46%

The PEF polymer so produced is referred to in these Examples as PEX1.

### Example 1B—Closed Cell PEF Foams from PEX1 Over a Range of Relative Densities and Blowing Agents

The present invention includes the advantages formation of PEF foams having a high volume percentage of closed cells over a range of relative foam densities (RFDs) and using a range of blowing agents. Although applicant is not bound by any theory of operation, it is believed that one or more of the advantageous foam properties of the present invention arise, at least in part, as a result of the ability to form foams with high closed cell content. In particular, the following Table E1B illustrates the volume percent closed cells for several foams made by applicant:

TABLE E1B
FOAM CLOSED CELL CONTENT

| FOAM COMPONENTS | | FOAM PROPERTIES | | |
|---|---|---|---|---|
| | Blowing | | Volume % | DETAILED |
| Polymer | Agent | RFD | Closed Cells* | EXAMPLE |
| PEX1 | 1243ze(E) | 0.078 | 91 | Example 4B |
| PEX1 | 1243ze(E) | 0.036 | 92 | Example 6 |
| PEX1 | 1336mzz(Z) | 0.14 | 76 | Example 26B |
| PEX1 | 1336mzz(Z) | 0.13 | 67 | Example 26B |
| PEX1 | 1233zd(E) | 0.15 | 46 | |
| PEX1 | isopentane | 0.13 | 40 | Example C2 |

*Volume % closed cells is determined herein by ASTM D6226.

### Comparative Example 1—PEF Foam Preparation Using PEX1 and CO₂ as Blowing Agent

1 gram of PEX1 in a glass container was loaded into a 60 cc autoclave and then dried under vacuum for six (6) hours at 130° C. The dried polymer was then cooled to room temperature and placed in a glass container inside an autoclave. About 0.25 moles (11 grams) of CO₂ blowing agent was then pumped into the autoclave containing the dried polymer, and then the autoclave was heated to bring the polymer to a melt state at a temperature of about 240° C. and a pressure above about 610 psig. The polymer/CO₂ blowing agent was maintained in this melt state for about 1 hour and the temperature and pressure of the melt/blowing agent was then reduced over a period of about 5-15 minutes to about 190° C. and 610 psig (hereinafter referred to for convenience as pre-foaming temperature and pre-foaming pressure, respectively), and then maintained at about this temperature and pressure for a period of about 30 minutes to allow the amount of blowing agent incorporated into the melt under such conditions to reach equilibrium. The temperature and pressure in the autoclave were then reduced rapidly (over a period of about 10 seconds for the pressure reduction and about 1-10 minutes for the temperature reduction using chilled water)) to ambient conditions (approximately 22° C. and 1 atmosphere) and foaming occurred. The foam thus produced was tested to determine the following properties:
compressive strength (“CS”) (measured perpendicular to the plane (that was in direct contact with the blowing agent) in accordance with ISO 844)
compressive modulus (“CM”) (measured perpendicular to the plane (that was in direct contact with the blowing agent) in accordance with ISO 844)
tensile strength (“TS”) (measured perpendicular to the plane (that was in direct contact with the blowing agent) in accordance with ASTM C297)
tensile modulus (“TM”) (measured perpendicular to the plane (that was in direct contact with the blowing agent) in accordance with ASTM C297)
relative foam density (“RFD”).
   As used herein, RFD is the density of the foam produced divided by the density of the starting polymer. Density is measured in these Examples using a method which corresponds generally to ASTM D71, except that hexane is used for displacement instead of water.

The foam produced in this Comparative Example 1 was tested and found to have the properties as reported in Table C1 below:

TABLE C1

| | |
|---|---|
| RFD | 0.25 |
| TS, Megapascal (Mpa) | 0.74 |
| CS, Mpa | 0.5 |
| TM, Mpa | 32 |
| CM, Mpa | 8 |

As reported above, the foam made using CO₂ under the reported conditions had an RFD of 0.25, that is, a density that was only 25% of the density of the starting polymer. This is a foam density that is too high for many important applications.

### Examples 2-4—PEF Foam Preparation Using PEX1 and trans-1234ze, trans-1233zd and trans-1336mzz as Blowing Agent

Comparative Example 1 was repeated, except the CO₂ blowing agent was replaced, on a molar equivalent basis in a separate run with each of trans-1234ze, trans-1233zd and trans-1336mzz, with the pre-foaming pressure for each run being maintained within a similar pre-foaming pressure (not more than about 50 psig greater than the 610 psig pre-foaming pressure used in Comparative Example 1). The foams thus produced were observed to be good, high-quality foam, and were then tested and found to have the properties reported in Table E2-4 below:

TABLE E2-4

| | | | Avg. | RELATIVE MECHANICAL | | | |
|---|---|---|---|---|---|---|---|
| | Blowing | | Cell | PROPERTIES* | | | |
| Ex | Agent | RFD | Size, μm | RTS | RTM | RCS | RCM |
| 2 | trans- | 0.1 | 108 | 1 | 1 | 1 | 1 |
| | 1233zd | | | | | | |
| 3 | trans- | 0.13 | 65 | 2.48 | 5.31 | 1.81 | 2.98 |
| | 1336mzz | | | | | | |
| 4A | trans- | 0.07 | 80 | 6.08 | 7.18 | 1.07 | 1.92 |
| | 1234ze | | | | | | |

*-For convenience and unless otherwise indicated in these Examples, the comparative strength and modulus results in the Examples hereof are reported based on trans-1233zd as the base-line value of 1 and are identified as RTS, RCS, RTM and RCM. Thus, for example, the tensile strength using trans-1234z blowing agent in Example 4 is 6.08 times greater than the tensile strength measured in Example 2. Tensile properties were determined based on ASTM C297 and compressive properties were determined based on ASTM C365 and ASTM D1621/ISO844.

As can be seen from the results reported in Table E2-4 above, each of the HFO compounds tested as blowing agents produced a foam that had a dramatically and unexpectedly improved density compared to CO₂, that is, in each case the density of the foam produced with the tested HFO resulted in density value that is at least about 1.9 times less than the density of the CO₂ blown foam. Furthermore, from among the foams produced, the trans-1234ze produced a foam that was more than 3.5 times less than the density of the CO₂ blown foam, and the use of the trans-1234ze also unexpectedly produced a foam that was dramatically superior to even the other HFO blowing agents in terms of the important tensile properties, with the 1234ze foam being at least 2.7 times better in tensile strength than the 1233zd foam.

The foam formed with 1234ze(E) in Example 4A produced a high-quality, low-density foam with an excellent uniform distribution of cells, as illustrated in FIG. 2. FIG. 2 is an SEM micrograph of a thin slice of the foam produced, thus showing cell walls having been removed from the side of the cell facing the viewer, allowing visibility into the cell, and showing that well-formed closed cells comprise the foam.

### Example 5—PEF Foam Preparation Using PEX1 and cis1224yd as Blowing Agent

Comparative Example 1 was repeated, except the CO₂ blowing agent was replaced in the process with cis1224yd and the process conditions were modified in a manner to produce a foam having within an amount of moles of blowing agent in the foam that is within 15% of the moles of blowing agent in Comparative Example 1. In particular, the foam thus produced using cis1224yd according to this Example was observed to be an acceptable foam and to have an RFD that was within about 15 relative percent of the RFD produced using CO₂ in Comparative Example 1, and therefore the foam of this example had a density that is too high for many important applications. However, for applications for which it is acceptable to have such a density, the foam produced in this Example was tested compared to CO₂ and was found to be dramatically superior in the strength and modulus properties, as reported in Table E5 below:

TABLE E5

| | | | Avg. | | | | |
|---|---|---|---|---|---|---|---|
| | | | Cell | RELATIVE MECHANICAL | | | |
| | Blowing | | Size, | PROPERTIES* | | | |
| Ex | Agent | RFD | μm | RTS | RTM | RCS | RCM |
| C1 | CO2 | 0.25 | 189 | 1 | 1 | 1 | 1 |
| 3 | Cis1224yd | 0.22 | 128 | 1.61 | 2.02 | 1.68 | 2.38 |

*The relative mechanical properties reported in this Table E5 are compared to the properties from the foam produced with CO₂ as the blowing agent in Comparative Example 1.

As can be seen from TABLE E5 above, on an equivalent molar blowing agent basis (i.e., within 15%), the foams made using cis1224yd were surprisingly superior to the foam made using CO₂ based on each of the physical strength and modulus properties tested. For example, the foam made with cis1224yd produced a foam with both tensile and compressive modulus that is twice the value produced using CO₂, while at the same time having compressive and tensile strengths that are more than 60% better than CO₂. This result is unexpected.

### Example 6—PEF Foam Preparation Using PEX1 and trans-1234ze as Blowing Agent

Comparative Example 1 was repeated, except: (1) the CO₂ blowing agent was replaced with trans-1234ze and with an increase in molar amount of the trans-1234ze (by about 2.5 more moles than Comparative Example 1) to raise the pre-foaming pressure to 1590 psig. The foam thus produced was observed to be a good, high-quality foam, and was then tested and found to have the properties reported in Table E6 below (with the value of the mechanical properties again being reported as a ratio of the values for 1233zd in Example 2 as baseline of 1):

TABLE E6

| | | | | Avg. | | | | |
|---|---|---|---|---|---|---|---|---|
| | | | Vol % | Cell | RELATIVE MECHANICAL | | | |
| | Blowing | | Closed | Size | PROPERTIES | | | |
| Example | Agent | RFD | Cells | (μm) | RTS | RTM | RCS | RCM |
| 6 | trans- | 0.04 | 92.1 | 22 | 4.3 | 3.02 | 0.7 | 0.52 |
| | 1234ze | | | | | | | |

### Example 7—PEF Foam Preparation Using PEX1 and cis-1336mzz as Blowing Agent

Comparative Example 1 was repeated, except: (1) the CO₂ blowing agent was replaced with cis1336mzz and with a decrease in molar amount of the cis-1336mzz (using about 0.33 times the moles than Comparative Example 1) to decrease the pre-foaming pressure to 190 psig. The foam thus produced was observed to be a good, high-quality foam, and was then tested and found to have the properties as reported in Table E7 below (with the value of the mechanical properties being reported as a ratio of the values for 1233zd in Example 2 as baseline of 1):

TABLE E7

| | | | Avg. | | | | |
|---|---|---|---|---|---|---|---|
| | | | Cell | RELATIVE MECHANICAL | | | |
| | Blowing | | Size, | PROPERTIES | | | |
| Example | Agent | RFD | (μm) | RTS | RTM | RCS | RCM |
| 7 | cis1336mzz | 0.11 | 177 | 5.87 | 6.46 | 0.79 | 1.21 |

### Example 8—PEF Foam Preparation Using PEX1 and Trans-1336mzz as Blowing Agent

Comparative Example 1 was repeated, except: (1) the CO₂ blowing agent was replaced, on a molar equivalent basis with trans-1336ze; and (2) the pre-foaming pressure was decreased to 170 psig. The foam thus produced was observed to be a good, high-quality foam, and was then tested and found to have the properties as reported in Table E8 below (with the value of the mechanical properties again being reported as a ratio of the values for 1233zd in Example 2 as baseline of 1):

TABLE E8

| | | | Avg. | | | | |
|---|---|---|---|---|---|---|---|
| | | | Cell | RELATIVE MECHANICAL | | | |
| | Blowing | | Size, | PROPERTIES | | | |
| Example | Agent | RFD | (μm) | RTS | RTM | RCS | RCM |
| 8 | trans | 0.12 | 130 | 6.52 | 5.32 | 2.55 | 2.65 |
| | 1336mzz | | | | | | |

### Example 9—PEF Preparation at MW 56,000 with PMDA Chain Extender and SSP

A bio-based polyethylene furanoate homopolymer was prepared by esterification and polycondensation of 2,5-furandicarboxylic acid with mono ethylene glycol according to known methods to produce PEF homopolymer, which is then treated according to known techniques with the chain extender PMDA at 0.6% by weight and then subject to solid state polymerization according to known techniques to produce a PEF homopolymer. The PEF polymer was tested and found to have the following characteristics:
Molecular Weight—56,000
Density, g/cc—1.43
Glass Transition Temperature—91° C.
Melt Temperature—222° C.
Decomposition Temperature—347° C.
Crystallinity—46%

The PEF polymer so produced is referred to in these Examples as PEX9.

### Examples 10 and 11—PEF Foam Preparation Using PEX9 and 1234yf and trans-1234ze as Blowing Agent

PEX9 was processed in two runs in an autoclave according to essentially the same procedure described in Comparative Example 1 except that 1234yf and trans1234ze (respectively Example 10 and Example 11) were each used as the blowing agent and except as noted below. The polymer/blowing agent was then heated (without pre-drying the polymer) to a melt state at a temperature of about 240° C. and a pressure of about 2380 psig in the case of 1234yf as the blowing agent and of about 2250 psig in the case of trans1234ze as the blowing agent, and then the polymer/blowing agent was maintained in this melt state for about 1 hour. The temperature and pressure of the melt were then reduced over a period of about 5-15 minutes to about 190° C. and about 1580 psig for trans1234ze and 1720 psig for 1234yf, and then maintained at about this temperature and pressure for a period of about 30 minutes to dissolve the blowing agent in the polymer, and then the temperature and pressure of the polymer were reduced rapidly as described in Comparative Example 1 to ambient conditions (approximately 22° C. and 1 atmosphere). The foams thus produced were observed to be good, high-quality foam, and were then tested and have the properties identified below in Table E10-11:

TABLE E10-11

| | | | Avg. Cell Size, |
|---|---|---|---|
| Example | Blowing Agent | RFD | (μm) |
| 10 | 1234yf | 0.19 | 73 |
| 11 | trans1234ze | 0.09 | 45 |

### Example 12—PEF Foam Preparation Using PEX9 and using trans1234ze as Blowing Agent

PEX9 was processed in an autoclave according to essentially the same procedure describe in Comparative Example 1 except that: (1) trans-1234ze was used as the blowing agent and in an increased molar amount (using about 2.6 times the moles used in Comparative Example 1) to produce a pre-foaming pressure was about 1590 psig; and depressurization to ambient occurred over about 2 seconds. The foam thus produced was observed to be good, high-quality foam, and was tested and found to have an RFD of 0.05, an average cell size of 41 (μm) and about 92%.

### Example 13—PEF Preparation at MW 25,000 with SSP

A bio-based polyethylene furanoate homopolymer was prepared by esterification and polycondensation of 2,5-furandicarboxylic acid with mono ethylene glycol according to known methods to produce PEF homopolymer, which is then subject to solid state polymerization according to known techniques to produce a PEF homopolymer. The PEF polymer was tested and found to have the following characteristics:
Molecular Weight—25,000
Glass Transition Temperature—89° C.
Melt Temperature—217° C.
Decomposition Temperature—347° C.
Crystallinity—41%

The PEF polymer so produced is referred to in these Examples as PEX13.

### Example 14—PEF Foam Preparation Using PEX13 and trans-1234ze as Blowing Agent

Comparative Example 1 was repeated, except: (1) PEX13 was used instead of PEX1; (2) the CO₂ blowing agent was replaced with trans-1234ze (at an increased in molar amount of about 2.8 times the moles used in Comparative Example 1,) to produce a pre-foaming pressure of about 1718 psig and the pre-foaming temperature was about 200° C. The foam thus produced was observed to be a good, high-quality foam, and was then tested and found to have an RFD of 0.26, which is too high for many important applications, and an average cell size of 69 (μm).

### Example 15—PEF Foam Preparation Using PEX13 and trans-1233zd as Blowing Agent

Comparative Example 1 was repeated, except: (1) PEX13 was used instead of PEX1, (2) the CO₂ blowing agent was replaced, on a molar equivalent basis (i.e., within 15%) with trans-1233zd; and (3) the pre-foaming pressure was about 645 psig. The foam thus produced was observed to be good, high-quality foam, and was then tested and found to have an RFD of 0.24 and an average cell size of 136 (μm).

### Examples 16-20—PEF Foam Preparation Using PEF with MW OF 25,000-125,000

Comparative Example 1 is repeated, except that the conditions and materials are altered as indicted below in Table E16 through Table E20, using blowing agents shown in the table on a molar equivalent (i.e., within 15%) basis (with all values understood to be “about” the indicated value).

TABLE E16

| | Thermoplastic | | | | | | |
|---|---|---|---|---|---|---|---|
| | Properties* | | | Foam Properties ** | | | |
| | WT % | | Blowing | | | | Vol % Closed |
| Example | PEF | MW | Agent | RFD | Strength | Modulus | Cells |
| 16A | 50 | 25,000 | 1234ze(E) | <0.2 | A | A | 50 |
| 16B | 60 | 25,000 | 1234yf | <0.2 | A | A | 50 |
| 16C | 70 | 25,000 | 1233zd(E) | <0.2 | A | A | 50 |
| 16D | 80 | 25,000 | 1336mzz(E) | <0.2 | A | A | 50 |
| 16E | 90 | 25,000 | 1336mzz(Z) | <0.2 | A | A | 50 |
| 16F | 100 | 25,000 | 1224yd(Z) | <0.2 | A | A | 50 |
| 16G | 50 | 25,000 | 1234ze(E) | <0.2 | A | A | 75 |
| 16H | 60 | 25,000 | 1234yf | <0.2 | A | A | 75 |
| 16I | 70 | 25,000 | 1233zd(E) | <0.2 | A | A | 75 |
| 16J | 80 | 25,000 | 1336mzz(E) | <0.2 | A | A | 75 |
| 16K | 90 | 25,000 | 1336mzz(Z) | <0.2 | A | A | 75 |
| 16L | 100 | 25,000 | 1224yd(Z) | <0.2 | A | A | 75 |
| 16M | 50 | 25,000 | 1234ze(E) | <0.2 | A | A | 90 |
| 16N | 60 | 25,000 | 1234yf | <0.2 | A | A | 90 |
| 16O | 70 | 25,000 | 1233zd(E) | <0.2 | A | A | 90 |
| 16P | 80 | 25,000 | 1336mzz(E) | <0.2 | A | A | 90 |
| 16Q | 90 | 25,000 | 1336mzz(Z) | <0.2 | A | A | 90 |
| 16R | 100 | 25,000 | 1224yd(Z) | <0.2 | A | A | 90 |
| 16S | 50 | 25,000 | 1234ze(E) | <0.2 | A | A | 100 |
| 16T | 60 | 25,000 | 1234yf | <0.2 | A | A | 100 |
| 16U | 70 | 25,000 | 1233zd(E) | <0.2 | A | A | 100 |
| 16V | 80 | 25,000 | 1336mzz(E) | <0.2 | A | A | 100 |
| 16W | 90 | 25,000 | 1336mzz(Z) | <0.2 | A | A | 100 |
| 16X | 100 | 25,000 | 1224yd(Z) | <0.2 | A | A | 100 |

*WT % PEF moieties in the polymer
**A-acceptable

TABLE E17

| | Thermoplastic | | | | | | |
|---|---|---|---|---|---|---|---|
| | Properties | | | Foam Properties** | | | |
| | WT % | | Blowing | | | | Vol % Closed |
| Example | PEF* | MW | Agent | RFD | Strength | Modulus | Cells |
| 17A | 50 | 50,000 | 1234ze(E) | <0.2 | A | A | 50 |
| 17B | 60 | 50,000 | 1234yf | <0.2 | A | A | 50 |
| 17C | 70 | 50,000 | 1233zd(E) | <0.2 | A | A | 50 |
| 17D | 80 | 50,000 | 1336mzz(E) | <0.2 | A | A | 50 |
| 17E | 90 | 50,000 | 1336mzz(Z) | <0.2 | A | A | 50 |
| 17F | 100 | 50,000 | 1224yd(Z) | <0.2 | A | A | 50 |
| 17G | 50 | 50,000 | 1234ze(E) | <0.2 | A | A | 75 |
| 17H | 60 | 50,000 | 1234yf | <0.2 | A | A | 75 |
| 17I | 70 | 50,000 | 1233zd(E) | <0.2 | A | A | 75 |
| 17J | 80 | 50,000 | 1336mzz(E) | <0.2 | A | A | 75 |
| 17K | 90 | 50,000 | 1336mzz(Z) | <0.2 | A | A | 75 |
| 17L | 100 | 50,000 | 1224yd(Z) | <0.2 | A | A | 75 |
| 17M | 50 | 50,000 | 1234ze(E) | <0.2 | A | A | 90 |
| 17N | 60 | 50,000 | 1234yf | <0.2 | A | A | 90 |
| 17O | 70 | 50,000 | 1233zd(E) | <0.2 | A | A | 90 |
| 17P | 80 | 50,000 | 1336mzz(E) | <0.2 | A | A | 90 |
| 17Q | 90 | 50,000 | 1336mzz(Z) | <0.2 | A | A | 90 |
| 17R | 100 | 50,000 | 1224yd(Z) | <0.2 | A | A | 90 |
| 17S | 50 | 50,000 | 1234ze(E) | <0.2 | A | A | 100 |
| 17T | 60 | 50,000 | 1234yf | <0.2 | A | A | 100 |
| 17U | 70 | 50,000 | 1233zd(E) | <0.2 | A | A | 100 |
| 17V | 80 | 50,000 | 1336mzz(E) | <0.2 | A | A | 100 |
| 17W | 90 | 50,000 | 1336mzz(Z) | <0.2 | A | A | 100 |
| 17X | 100 | 50,000 | 1224yd(Z) | <0.2 | A | A | 100 |

*WT % PEF moieties in the polymer
**A-acceptable

TABLE E18

| | Thermoplastic | | | | | | |
|---|---|---|---|---|---|---|---|
| | Properties | | | Foam Properties** | | | |
| | WT % | | Blowing | | | | Vol % Closed |
| Example | PEF* | MW | Agent | RFD | Strength | Modulus | Cells |
| 18A | 50 | 75,000 | 1234ze(E) | <0.2 | A | A | 50 |
| 18B | 60 | 75,000 | 1234yf | <0.2 | A | A | 50 |
| 18C | 70 | 75,000 | 1233zd(E) | <0.2 | A | A | 50 |
| 18D | 80 | 75,000 | 1336mzz(E) | <0.2 | A | A | 50 |
| 18E | 90 | 75,000 | 1336mzz(Z) | <0.2 | A | A | 50 |
| 18F | 100 | 75,000 | 1224yd(Z) | <0.2 | A | A | 50 |
| 18G | 50 | 75,000 | 1234ze(E) | <0.2 | A | A | 75 |
| 18H | 60 | 75,000 | 1234yf | <0.2 | A | A | 75 |
| 18I | 70 | 75,000 | 1233zd(E) | <0.2 | A | A | 75 |
| 18J | 80 | 75,000 | 1336mzz(E) | <0.2 | A | A | 75 |
| 18K | 90 | 75,000 | 1336mzz(Z) | <0.2 | A | A | 75 |
| 18L | 100 | 75,000 | 1224yd(Z) | <0.2 | A | A | 75 |
| 18M | 50 | 75,000 | 1234ze(E) | <0.2 | A | A | 90 |
| 18N | 60 | 75,000 | 1234yf | <0.2 | A | A | 90 |
| 18O | 70 | 75,000 | 1233zd(E) | <0.2 | A | A | 90 |
| 18P | 80 | 75,000 | 1336mzz(E) | <0.2 | A | A | 90 |
| 18Q | 90 | 75,000 | 1336mzz(Z) | <0.2 | A | A | 90 |
| 18R | 100 | 75,000 | 1224yd(Z) | <0.2 | A | A | 90 |
| 18S | 50 | 75,000 | 1234ze(E) | <0.2 | A | A | 100 |
| 18T | 60 | 75,000 | 1234yf | <0.2 | A | A | 100 |
| 18U | 70 | 75,000 | 1233zd(E) | <0.2 | A | A | 100 |
| 18V | 80 | 75,000 | 1336mzz(E) | <0.2 | A | A | 100 |
| 18W | 90 | 75,000 | 1336mzz(Z) | <0.2 | A | A | 100 |
| 18X | 100 | 75,000 | 1224yd(Z) | <0.2 | A | A | 100 |

*WT % PEF moieties in the polymer
**A-acceptable

TABLE E19

| | Thermoplastic | | | | | | |
|---|---|---|---|---|---|---|---|
| | Properties | | | Foam Properties** | | | |
| | WT % | | Blowing | | | | Vol % Closed |
| Example | PEF* | MW | Agent | RFD | Strength | Modulus | Cells |
| 19A | 50 | 100,000 | 1234ze(E) | <0.2 | A | A | 50 |
| 19B | 60 | 100,000 | 1234yf | <0.2 | A | A | 50 |
| 19C | 70 | 100,000 | 1233zd(E) | <0.2 | A | A | 50 |
| 19D | 80 | 100,000 | 1336mzz(E) | <0.2 | A | A | 50 |
| 19F | 90 | 100,000 | 1336mzz(Z) | <0.2 | A | A | 50 |
| 19F | 100 | 100,000 | 1224yd(Z) | <0.2 | A | A | 50 |
| 19G | 50 | 100,000 | 1234ze(E) | <0.2 | A | A | 75 |
| 19H | 60 | 100,000 | 1234yf | <0.2 | A | A | 75 |
| 19I | 70 | 100,000 | 1233zd(E) | <0.2 | A | A | 75 |
| 19J | 80 | 100,000 | 1336mzz(E) | <0.2 | A | A | 75 |
| 19K | 90 | 100,000 | 1336mzz(Z) | <0.2 | A | A | 75 |
| 19L | 100 | 100,000 | 1224yd(Z) | <0.2 | A | A | 75 |
| 19M | 50 | 100,000 | 1234ze(E) | <0.2 | A | A | 90 |
| 19N | 60 | 100,000 | 1234yf | <0.2 | A | A | 90 |
| 19O | 70 | 100,000 | 1233zd(E) | <0.2 | A | A | 90 |
| 19P | 80 | 100,000 | 1336mzz(E) | <0.2 | A | A | 90 |
| 19Q | 90 | 100,000 | 1336mzz(Z) | <0.2 | A | A | 90 |
| 19R | 100 | 100,000 | 1224yd(Z) | <0.2 | A | A | 90 |
| 19S | 50 | 100,000 | 1234ze(E) | <0.2 | A | A | 100 |
| 19T | 60 | 100,000 | 1234yf | <0.2 | A | A | 100 |
| 19U | 70 | 100,000 | 1233zd(E) | <0.2 | A | A | 100 |
| 19V | 80 | 100,000 | 1336mzz(E) | <0.2 | A | A | 100 |
| 19W | 90 | 100,000 | 1336mzz(Z) | <0.2 | A | A | 100 |
| 19X | 100 | 100,000 | 1224yd(Z) | <0.2 | A | A | 100 |

*WT % PEF moieties in the polymer
**A-acceptable

TABLE E20

| | Thermoplastic | | | | | | |
|---|---|---|---|---|---|---|---|
| | Properties | | | Foam Properties** | | | |
| | WT % | | Blowing | | | | Vol % Closed |
| Example | PEF* | MW | Agent | RFD | Strength | Modulus | Cells |
| 20A | 50 | 125,000 | 1234ze(E) | <0.2 | A | A | 50 |
| 20B | 60 | 125,000 | 1234yf | <0.2 | A | A | 50 |
| 20C | 70 | 125,000 | 1233zd(E) | <0.2 | A | A | 50 |
| 20D | 80 | 125,000 | 1336mzz(E) | <0.2 | A | A | 50 |
| 20E | 90 | 125,000 | 1336mzz(Z) | <0.2 | A | A | 50 |
| 20F | 100 | 125,000 | 1224yd(Z) | <0.2 | A | A | 50 |
| 20G | 50 | 125,000 | 1234ze(E) | <0.2 | A | A | 75 |
| 20H | 60 | 125,000 | 1234yf | <0.2 | A | A | 75 |
| 20I | 70 | 125,000 | 1233zd(E) | <0.2 | A | A | 75 |
| 20J | 80 | 125,000 | 1336mzz(E) | <0.2 | A | A | 75 |
| 20K | 90 | 125,000 | 1336mzz(Z) | <0.2 | A | A | 75 |
| 20L | 100 | 125,000 | 1224yd(Z) | <0.2 | A | A | 75 |
| 20M | 50 | 125,000 | 1234ze(E) | <0.2 | A | A | 90 |
| 20N | 60 | 125,000 | 1234yf | <0.2 | A | A | 90 |
| 20O | 70 | 125,000 | 1233zd(E) | <0.2 | A | A | 90 |
| 20P | 80 | 125,000 | 1336mzz(E) | <0.2 | A | A | 90 |
| 20Q | 90 | 125,000 | 1336mzz(Z) | <0.2 | A | A | 90 |
| 20R | 100 | 125,000 | 1224yd(Z) | <0.2 | A | A | 90 |
| 20S | 50 | 125,000 | 1234ze(E) | <0.2 | A | A | 100 |
| 20T | 60 | 125,000 | 1234yf | <0.2 | A | A | 100 |
| 20U | 70 | 125,000 | 1233zd(E) | <0.2 | A | A | 100 |
| 20V | 80 | 125,000 | 1336mzz(E) | <0.2 | A | A | 100 |
| 20W | 90 | 125,000 | 1336mzz(Z) | <0.2 | A | A | 100 |
| 20X | 100 | 125,000 | 1224yd(Z) | <0.2 | A | A | 100 |

In each case in Tables E16-E20 above, the thermoplastic polymer used to make the foam had characteristics (measured in accordance with same procedures as identified above in Comparative Example 1) within the ranges indicated below:
Glass Transition Temperature—75-95° C.
Melt Temperature—190-240° C.
Decomposition Temperature—320-400° C.
Crystallinity—30-60%

All foams thus produced according to these examples are observed to be foams of acceptable quality.

### Examples 21-22 PEF Foam Preparation Using PEX1 and Blowing Agent Consisting of trans-1234ze and Co-Blowing Agents

Example 4 is repeated in a series of runs, except that in each run the blowing agent consisting of 0.25 moles of trans1234ze used in Example 4 is replaced by a combination consisting of about 0.125 moles of trans1234ze and 0.125 moles of a co-blowing agent. The blowing agent combinations used in each of Examples 21-22 are shown in Table E21-22, with the relative mechanical property results being presented in this table based on the result from Example 4 as the base line of 1.

TABLE E21-22

| | Co-Blowing | | | RELATIVE MECHANICAL PROPERTIES (Based on | | | |
|---|---|---|---|---|---|---|---|
| | Agent (50 | Foaming | | Example 4 Results with 1234ze with no co-blowing | | | |
| | mole % with | Pressure, | | agent as the base of 1) | | | |
| Ex | trans-1234ze) | psig | RFD | RTS | RTM | RCS | RCM |
| 21 | Cyclopentane | 485 | 0.05 | 0.14 | 0.1 | 0.26 | 0.0045 |
| 22 | trans1233zd | 608 | 0.1 | 0.34 | 0.21 | 0.53 | 0.37 |

As can be seen from the results reported in Table E21-22 above, in each case the replacement of 0.125 moles of trans-1234ze (50 mole % of the total blowing agent used) with an equivalent molar amount of the indicated co-blowing agent causes highly detrimental and substantial reduction in the tensile properties of the foam. By way of example, the tensile modulus of the foam blowing with cyclopentane co-blowing agent is only about 3% of the tensile modulus achieved by trans1234ze alone, and every mechanical property measured in Example 21 is 20% or less than the value achieved by Example 4.

### Comparative Example 2—PEF Foam Preparation Using PEX1 and HFC-134a as Blowing Agent

1 gram of PEX1 in a glass container was loaded into an autoclave and then dried for under vacuum for six (6) hours at 130° C. The dried polymer was then cooled to room temperature and placed in a glass container inside an autoclave. About 0.25 moles (25.3 grams) of R-134a blowing agent was then pumped into the autoclave containing the dried polymer, and then the autoclave was heated to bring the polymer to a melt state at a temperature of about 240° C. and a pressure above about 570 psig. The polymer/R134a blowing agent was maintained in this melt state for about 1 hour and the temperature and pressure of the melt/blowing agent was then reduced over a period of about 5-15 minutes to about 190° C. and 570 psig (hereinafter referred to for convenience as pre-foaming temperature and pre-foaming pressure, respectively), and then maintained at about this temperature and pressure for a period of about 30 minutes to allow the amount of blowing agent incorporated into the melt under such conditions to reach equilibrium. The temperature and pressure in the autoclave were then reduced rapidly (over a period of about 10 seconds for the pressure reduction and about 1-10 minutes for the temperature reduction using chilled water)) to ambient conditions (approximately 22° C. and 1 atmosphere) and foaming occurred. The foam thus produced had a relatively acceptable foam structure and was tested to determine relative foam density (RFD) and strength and modulus properties. The RFD of the foam was 0.12.

### Example 23—PEF Foam Preparation Using PEX1 and trans-1336mzz as Blowing Agent

Comparative Example 2 was repeated, except: (i) the HFC-134a blowing agent was replaced in the process with trans1336mmzz in two separate runs; and (ii) the process conditions were modified in a manner to produce a foam having a density similar to the density of the foam produced in Comparative Example 2. In particular, the foams thus produced using trans1336mzz according to this Example were observed to be acceptable foams and had RFD values that were within about 15% of the RFD produced using HFC-134a in Comparative Example 2. The foams produced were tested to determine various properties, including strength and modulus properties, and were found to be dramatically superior to the foam made with HFC-134a in each of the measured properties, as reported in Table E23 below:

TABLE E23

| | | | Avg. | | | | |
|---|---|---|---|---|---|---|---|
| | | | Cell | RELATIVE MECHANICAL | | | |
| | Blowing | | Size, | PROPERTIES* | | | |
| Ex | Agent | RFD | μm | RTS | RTM | RCS | RCM |
| C2 | 134a | 0.12 | | 1 | 1 | 1 | 1 |
| 23A | trans1336mzz | 0.12 | 130 | 150 | 10.7 | 35.6 | 15.2 |
| 23B | trans1336mzz | 0.13 | 65 | 57 | 10.7 | 25.3 | 16.9 |

*The relative mechanical properties reported in this Table E23 are compared to the properties from the foam produced with HFC-134a as the blowing agent in Comparative Example 2.

As can be seen from TABLE E23 above, the foams made using trans1336mzz were surprisingly and dramatically superior to the foam made using HFC-134a in terms of all the physical strength and modulus properties tested. For example, the foam made with trans1336mzz produced a foam with both tensile and compressive strengths that were more than 10 times better than the strength of foam made with HFC-134a, while at the same time having compressive and tensile modulus that are more 3 times better than foam made using HFC-134a. This result shows a dramatic and unexpected improvement in physical properties of the foam.

### Comparative Example 3—PEF Foam Preparation Using PEX1 and Isopentane as Blowing Agent

1 gram of PEX1 in a glass container was loaded into an autoclave and then dried for under vacuum for six (6) hours at 130° C. The dried polymer was then cooled to room temperature and placed in a glass container inside an autoclave. About 0.25 moles (27.8 grams) of isopentane blowing agent was then pumped into the autoclave containing the dried polymer, and then the autoclave was heated to bring the polymer to a melt state at a temperature of about 240° C. and a pressure above about 443 psig. The polymer/isopentane blowing agent was maintained in this melt state for about 1 hour and the temperature and pressure of the melt/blowing agent was then reduced over a period of about 5-15 minutes to about 190° C. and 443 psig (hereinafter referred to for convenience as pre-foaming temperature and pre-foaming pressure, respectively), and then maintained at about this temperature and pressure for a period of about 30 minutes to allow the amount of blowing agent incorporated into the melt under such conditions to reach equilibrium. The temperature and pressure in the autoclave were then reduced rapidly (over a period of about 10 seconds for the pressure reduction and about 1-10 minutes for the temperature reduction using chilled water)) to ambient conditions (approximately 22° C. and 1 atmosphere) and foaming occurred. The foam thus produced had a relatively acceptable foam structure and was tested to determine relative foam density (RFD) and strength and modulus properties. The RFD of the foam was 0.13.

### Examples 24-25—PEF Foam Preparation Using PEX1 and trans-1336mzz as Blowing Agent

Comparative Example 3 was repeated, except the isopentane blowing agent was replaced in the process with trans1336mmzz(E). The process conditions were modified in a manner to produce a foam having RFD values that were within about 15% of the RFD produced using isopentane in Comparative Example 3. The foam produced was tested to determine various properties, including strength and modulus properties, and was found to be dramatically superior in each of the measured property, as reported in Table E24-25 below:

TABLE E24-25

| | | | | Avg. | | | | |
|---|---|---|---|---|---|---|---|---|
| | | | Vol % | Cell | RELATIVE MECHANICAL | | | |
| | Blowing | | Closed | Size, | PROPERTIES* | | | |
| Ex | Agent | RFD | Cells | μm | RTS | RTM | RCS | RCM |
| C3 | isopentane | 0.12 | 40 | NA | 1 | 1 | 1 | 1 |
| 24 | trans1336mzz | 0.12 | NA | 130 | 1.57 | 17.8 | 1.2 | 7.6 |
| 25 | trans1336mzz | 0.13 | 67.3 | 65 | 0.6 | 1.2 | 1.1 | 0.76 |
| | AVG | 0.125 | | 97.5 | 1.09 | 9.5 | 1.15 | 4.2 |

*The relative mechanical properties reported in this Table E26 are compared to the properties from the foam produced with isopentane as the blowing agent in Comparative Example 3.

As can be seen from TABLE E24-25 above, the foams made using trans1336mzz were surprisingly superior, on average, to the foam made using isopentane in terms of the physical strength and modulus properties tested. This result is unexpected.

### Example 26—PEF Foam Preparation Using PEX1 and cis-1336mzz as Blowing Agent

Comparative Example 3 was repeated, except: (i) the isopentane blowing agent was replaced in the process with cis1336mmzz(E); and (ii) the process conditions were modified in a manner to produce a foam having an RFD that was within about 18% of the RFD produced using isopentane in Comparative Example 3. The foam produced was tested to determine various properties and was found to be dramatically superior in tensile strength and tensile modulus, as reported in Table E26 below:

TABLE E26

| | | | | Avg. | | | | |
|---|---|---|---|---|---|---|---|---|
| | | | Vol % | Cell | | | | |
| | Blowing | | Closed | Size, | RELATIVE MECHANICAL PROPERTIES* | | | |
| Ex | Agent | RFD | Cells | μm | RTS | RCS | RTM | RCM |
| C3 | isopentane | 0.13 | 40 | NA | 1 | 1 | 1 | 1 |
| | | | | | (0.95) | (.69) | (42.4) | (22.2) |
| 26A | Cis1336mzz | 0.11 | NA | 177 | 1.42 | 0.48 | 1.46 | 0.31 |
| 26B | Cis1336mzz | 0.14 | 75.8 | 169 | 1.62 | 2.8 | 2.14 | 1.2 |

*The relative mechanical properties reported in this Table E26 are compared to the properties from the foam produced with isopentane as the blowing agent in Comparative Example 3.

As can be seen from TABLE E26 above, the foam made with cis1336mzz produced a foam with tensile strengths that were at least 40% better than foam made using isopentane. This result shows that dramatic and unexpected improvement in physical properties of the foam can be achieved according to the present invention.

### Comparative Example 4—PEF Foam Preparation Using PEX1 and Cyclopentane as Blowing Agent

1 gram of PEX1 in a glass container was loaded into an autoclave and then dried for under vacuum for six (6) hours at 130° C. The dried polymer was then cooled to room temperature and placed in a glass container inside an autoclave. About 0.25 moles (32.9 grams) of cyclopentane blowing agent was then pumped into the autoclave containing the dried polymer, and then the autoclave was heated to bring the polymer to a melt state at a temperature of about 240° C. and a pressure above about 320 psig. The polymer/cyclopentane blowing agent combination was maintained in this melt state for about 1 hour, and the temperature and pressure of the melt/blowing agent were then reduced over a period of about 5-15 minutes to about 190° C. and 320 psig (hereinafter referred to for convenience as pre-foaming temperature and pre-foaming pressure, respectively), and then maintained at about this temperature and pressure for a period of about 30 minutes to allow the amount of blowing agent incorporated into the melt under such conditions to reach equilibrium. The temperature and pressure in the autoclave were then reduced rapidly (over a period of about 10 seconds for the pressure reduction and about 1-10 minutes for the temperature reduction using chilled water)) to ambient conditions (approximately 22° C. and 1 atmosphere) and foaming occurred. The foam thus produced had a relatively acceptable foam structure and was tested to determine relative foam density (RFD) and strength and modulus properties. The RFD of the foam was 0.2.

### Example 27—PEF Foam Preparation Using PEX1 and cis1224yd as Blowing Agent

Comparative Example 4 was repeated, except: (i) the cyclopentane blowing agent was replaced in the process with cis1224yd; and (ii) the process conditions were modified in a manner to produce a foam having and RFD value that was within about 15% of the RFD produced using cyclopentane in Comparative Example 4. The foam produced was tested to determine various properties, including strength and modulus properties, and was found to be dramatically superior in each of the measured property, as reported in Table E27 below:

TABLE E27

| | | | Avg. | | | | |
|---|---|---|---|---|---|---|---|
| | | | Cell | RELATIVE MECHANICAL | | | |
| | Blowing | | Size, | PROPERTIES* | | | |
| Ex | Agent | RFD | μm | RTS | RCS | RTM | RCM |
| C2 | cyclopentane | 0.2 | | 1 | 1 | 1 | 1 |
| 27 | cis1224yd | 0.22 | 130 | 2.16 | 1.42 | 1.05 | 1.45 |

*The relative mechanical properties reported in this Table E26 are compared to the properties from the foam produced with isopentane as the blowing agent in Comparative Example 4.

As can be seen from TABLE E27 above, the foam made using cis1224yd were surprisingly superior to the foam made using cyclopentane in terms of all physical strength and modulus properties tested. For example, the foam made with cis1224yd produced a foam with a tensile strength more than 2 times better than the values achieved using cyclopentane. This result shows that dramatic and unexpected improvement in physical properties of the foam can be achieved according to the present invention.

### Example 28—PEF Preparation at MW about 33,000 with PMDA Chain Extender and SSP

A bio-based polyethylene furanoate homopolymer was prepared by esterification and polycondensation of 2,5-furandicarboxylic acid with mono ethylene glycol according to known methods to produce PEF homopolymer, which is then treated according to known techniques with the chain extender PMDA at 0.7% by weight and then subject to solid state polymerization according to known techniques to produce a PEF homopolymer. The PEF polymer was tested and found to have the following characteristics, using the same measurement techniques as described in Example 1:
Molecular Weight—≈433,000
Glass Transition Temperature—90.5° C.
Melt Temperature—224° C.
Decomposition Temperature—341° C.
Crystallinity—45%

The PEF polymer so produced is referred to in these Examples as PEX28.

### Comparative Example 5—PEF Foam Preparation Using PEX28 and CO₂ as Blowing Agent

1 gram of PEX28 in a glass container was loaded into an autoclave and then dried under vacuum for six (6) hours at 130° C. The dried polymer was then cooled to room temperature and placed in a glass container inside an autoclave. About 0.25 moles (11 grams) of CO₂ blowing agent was then pumped into the autoclave containing the dried polymer, and then the autoclave was heated to bring the polymer to a melt state at a temperature of about 240° C. and a pressure above about 242 psig. The polymer/CO₂ blowing agent was maintained in this melt state for about 1 hour and the temperature and pressure of the melt/blowing agent was then reduced over a period of about 5-15 minutes to about 180° C. and 242 psig (hereinafter referred to for convenience as pre-foaming temperature and pre-foaming pressure, respectively), and then maintained at about this temperature and pressure for a period of about 30 minutes to allow the amount of blowing agent incorporated into the melt under such conditions to reach equilibrium. The temperature and pressure in the autoclave were then reduced rapidly (over a period of about 10 seconds for the pressure reduction and about 1-10 minutes for the temperature reduction using chilled water)) to ambient conditions (approximately 22° C. and 1 atmosphere) and foaming occurred. The foam thus produced had a relatively acceptable foam structure and was tested to determine density, strength and modulus properties using the same procedure as described in Comparative Example 1. The foam produced in this Comparative Example 5 had an RFD of 0.09.

### Example 29-31—PEF Foam Preparation Using PEX31 and trans1234ze as Blowing Agent

Comparative Example 5 was repeated, except the CO₂ blowing agent was replaced in the process with trans1234ze in three separate runs. The foam thus produced using trans1234ze according to this Example was observed to be an acceptable foam and to have an RFD that was within about 15 relative percent of the RFD produced using CO₂ in Comparative Example 5. The foams produced were tested to determine various properties, including strength and modulus properties, and were found to be dramatically superior in each of the measured properties, as reported in Table E29-31 below:

TABLE E29-31

| | | | Avg. | RELATIVE MECHANICAL | | | |
|---|---|---|---|---|---|---|---|
| | Blowing | | Cell | PROPERTIES* | | | |
| Ex | Agent | RFD | Size, μm | RTS | RCS | RTM | RCM |
| C5 | CO₂ | 0.09 | NA | 1 | 1 | 1 | 1 |
| 29 | trans1234ze | 0.08 | 149 | 145 | 16.5 | 35.2 | 4 |
| 30 | trans1234ze | 0.08 | 297 | 144 | 33.5 | 32.67 | 5 |
| 31 | trans1234ze | 0.09 | NA | 81 | 25 | 17.4 | 5.8 |

As can be seen from TABLE E29-31 above the foams made using trans1234ze were surprisingly superior to the foam made in Comparative Example 5 using CO₂ for all of the physical strength and modulus properties tested. For example, the foam made with trans1234ze produced a foam with both tensile and compressive modulus that is at least 4 times the value produced using CO₂. This result is unexpected.

### Examples 32-43— PEF Foam Preparation Using PEF with MW OF 25,000-125,000 and Blowing Agent Comprising trans1234ze and Co-Blowing Agents

The foams made with 1234ze(E) in Example 16 having a volume of closed cells being 90% or greater are repeated, except that instead of using a blowing agent consisting of 1234ze(E), a co-blowing as indicated the following table is used to replace portions of the 1234ze(E) ranging from 5% to 45% on a molar basis, as indicated below in Table E32-43 (with all values understood to be “about” the indicated value).

TABLE E32-43

| | Thermoplastic | | Co-Blowing | Foam Properties*** | | | |
|---|---|---|---|---|---|---|---|
| | Properties | | Agent/amount | | | | Vol % |
| | WT % | | (mole % of total | | | | Closed |
| Example | PEF | MW | blowing agent) | RFD | Strength | Modulus | Cells |
| 32A | 10 | 25,000- | CO₂/5%-45% | <0.2 | A | A | =>90 |
| | | 125,000 | | | | | |
| 32B | 20 | 25,000- | CO₂/5%-45% | CO₂/5%- | A | A | =>90 |
| | | 125,000 | | 45% | | | |
| 32C | 30 | 25,000- | CO₂/5%-45% | CO₂/5%- | A | A | =>90 |
| | | 125,000 | | 45% | | | |
| 32D | 40 | 25,000- | CO₂/5%-45% | CO₂/5%- | A | A | =>90 |
| | | 125,000 | | 45% | | | |
| 32E | 50 | 25,000- | CO₂/5%-45% | CO₂/5%- | A | A | =>90 |
| | | 125,000 | | 45% | | | |
| 32F | 60 | 25,000- | CO₂/5%-45% | CO₂/5%- | A | A | =>90 |
| | | 125,000 | | 45% | | | |
| 32G | 70 | 25,000- | CO₂/5%-45% | CO₂/5%- | A | A | =>90 |
| | | 125,000 | | 45% | | | |
| 32H | 80 | 25,000- | CO₂/5%-45% | CO₂/5%- | A | A | =>90 |
| | | 125,000 | | 45% | | | |
| 32I | 90 | 25,000- | CO₂/5%-45% | CO₂/5%- | A | A | =>90 |
| | | 125,000 | | 45% | | | |
| 32J | 100 | 25,000- | CO₂/5%-45% | CO₂/5%- | A | A | =>90 |
| | | 125,000 | | 45% | | | |
| 33A | 10 | 25,000- | Butane*/5%-45% | <0.2 | A | A | =>90 |
| | | 125,000 | | | | | |
| 33B | 20 | 25,000- | Butane*/5%-45% | <0.2 | A | A | =>90 |
| | | 125,000 | | | | | |
| 33C | 30 | 25,000- | Butane*/5%-45% | <0.2 | A | A | =>90 |
| | | 125,000 | | | | | |
| 33D | 40 | 25,000- | Butane*/5%-45% | <0.2 | A | A | =>90 |
| | | 125,000 | | | | | |
| 33E | 50 | 25,000- | Butane*/5%-45% | <0.2 | A | A | =>90 |
| | | 125,000 | | | | | |
| 33F | 60 | 25,000- | Butane*/5%-45% | <0.2 | A | A | =>90 |
| | | 125,000 | | | | | |
| 33G | 70 | 25,000- | Butane*/5%-45% | <0.2 | A | A | =>90 |
| | | 125,000 | | | | | |
| 33H | 80 | 25,000- | Butane*/5%-45% | <0.2 | A | A | =>90 |
| | | 125,000 | | | | | |
| 33I | 90 | 25,000- | Butane*/5%-45% | <0.2 | A | A | =>90 |
| | | 125,000 | | | | | |
| 33J | 100 | 25,000- | Butane*/5%-45% | <0.2 | A | A | =>90 |
| | | 125,000 | | | | | |
| 34A | 10 | 25,000- | Pentane**/5%- | <0.2 | A | A | =>90 |
| | | 125,000 | 45% | | | | |
| 34B | 20 | 25,000- | Pentane**/5%- | <0.2 | A | A | =>90 |
| | | 125,000 | 45% | | | | |
| 34C | 30 | 25,000- | Pentane**/5%- | <0.2 | A | A | =>90 |
| | | 125,000 | 45% | | | | |
| 34D | 40 | 25,000- | Pentane**/5%- | <0.2 | A | A | =>90 |
| | | 125,000 | 45% | | | | |
| 34E | 50 | 25,000- | Pentane**/5%- | <0.2 | A | A | =>90 |
| | | 125,000 | 45% | | | | |
| 34F | 60 | 25,000- | Pentane**/5%- | <0.2 | A | A | =>90 |
| | | 125,000 | 45% | | | | |
| 34G | 70 | 25,000- | Pentane**/5%- | <0.2 | A | A | =>90 |
| | | 125,000 | 45% | | | | |
| 34H | 80 | 25,000- | Pentane**/5%- | <0.2 | A | A | =>90 |
| | | 125,000 | 45% | | | | |
| 34I | 90 | 25,000- | Pentane**/5%- | <0.2 | A | A | =>90 |
| | | 125,000 | 45% | | | | |
| 34J | 100 | 25,000- | Pentane**/5%- | <0.2 | A | A | =>90 |
| | | 125,000 | 45% | | | | |
| 35A | 10 | 25,000- | Methanol/5%- | <0.2 | A | A | =>90 |
| | | 125,000 | 45% | | | | |
| 35B | 20 | 25,000- | Methanol/5%- | <0.2 | A | A | =>90 |
| | | 125,000 | 45% | | | | |
| 35C | 30 | 25,000- | Methanol/5%- | <0.2 | A | A | =>90 |
| | | 125,000 | 45% | | | | |
| 35D | 40 | 25,000- | Methanol/5%- | <0.2 | A | A | =>90 |
| | | 125,000 | 45% | | | | |
| 35E | 50 | 25,000- | Methanol/5%- | <0.2 | A | A | =>90 |
| | | 125,000 | 45% | | | | |
| 35F | 60 | 25,000- | Methanol/5%- | <0.2 | A | A | =>90 |
| | | 125,000 | 45% | | | | |
| 35G | 70 | 25,000- | Methanol/5%- | <0.2 | A | A | =>90 |
| | | 125,000 | 45% | | | | |
| 35H | 80 | 25,000- | Methanol/5%- | <0.2 | A | A | =>90 |
| | | 125,000 | 45% | | | | |
| 35I | 90 | 25,000- | Methanol/5%- | <0.2 | A | A | =>90 |
| | | 125,000 | 45% | | | | |
| 35J | 100 | 25,000- | Methanol/5%- | <0.2 | A | A | =>90 |
| | | 125,000 | 45% | | | | |
| 36A | 10 | 25,000- | Ethanol/5%-45% | <0.2 | A | A | =>90 |
| | | 125,000 | | | | | |
| 36B | 20 | 25,000- | Ethanol/5%-45% | <0.2 | A | A | =>90 |
| | | 125,000 | | | | | |
| 36C | 30 | 25,000- | Ethanol/5%-45% | <0.2 | A | A | =>90 |
| | | 125,000 | | | | | |
| 36D | 40 | 25,000- | Ethanol/5%-45% | <0.2 | A | A | =>90 |
| | | 125,000 | | | | | |
| 36E | 50 | 25,000- | Ethanol/5%-45% | <0.2 | A | A | =>90 |
| | | 125,000 | | | | | |
| 36F | 60 | 25,000- | Ethanol/5%-45% | <0.2 | A | A | =>90 |
| | | 125,000 | | | | | |
| 36G | 70 | 25,000- | Ethanol/5%-45% | <0.2 | A | A | =>90 |
| | | 125,000 | | | | | |
| 36H | 80 | 25,000- | Ethanol/5%-45% | <0.2 | A | A | =>90 |
| | | 125,000 | | | | | |
| 36I | 90 | 25,000- | Ethanol/5%-45% | <0.2 | A | A | =>90 |
| | | 125,000 | | | | | |
| 36J | 100 | 25,000- | Ethanol/5%-45% | <0.2 | A | A | =>90 |
| | | 125,000 | | | | | |
| 37A | 50 | 25,000- | Methyl | <0.2 | A | A | =>90 |
| | | 125,000 | formate/5%-45% | | | | |
| 37B | 60 | 25,000- | Methyl | <0.2 | A | A | =>90 |
| | | 125,000 | formate/5%-45% | | | | |
| 37C | 70 | 25,000- | Methyl | <0.2 | A | A | =>90 |
| | | 125,000 | formate/5%-45% | | | | |
| 37D | 80 | 25,000- | Methyl | <0.2 | A | A | =>90 |
| | | 125,000 | formate/5%-45% | | | | |
| 37E | 90 | 25,000- | Methyl | <0.2 | A | A | =>90 |
| | | 125,000 | formate/5%-45% | | | | |
| 37F | 100 | 25,000- | Methyl | <0.2 | A | A | =>90 |
| | | 125,000 | formate/5%-45% | | | | |
| 38A | 10 | 25,000- | Dimethyl | <0.2 | A | A | =>90 |
| | | 125,000 | ether (DME)/5%- | | | | |
| | | | 45% | | | | |
| 38B | 20 | 25,000- | Dimethyl | <0.2 | A | A | =>90 |
| | | 125,000 | ether (DME)/5%- | | | | |
| | | | 45% | | | | |
| 38C | 30 | 25,000- | Dimethyl | <0.2 | A | A | =>90 |
| | | 125,000 | ether (DME)/5%- | | | | |
| | | | 45% | | | | |
| 38D | 40 | 25,000- | Dimethyl | <0.2 | A | A | =>90 |
| | | 125,000 | ether (DME)/5%- | | | | |
| | | | 45% | | | | |
| 38E | 50 | 25,000- | Dimethyl | <0.2 | A | A | =>90 |
| | | 125,000 | ether (DME)/5%- | | | | |
| | | | 45% | | | | |
| 38F | 60 | 25,000- | DME/5%-45% | <0.2 | A | A | =>90 |
| | | 125,000 | | | | | |
| 38G | 70 | 25,000- | DME/5%-45% | <0.2 | A | A | =>90 |
| | | 125,000 | | | | | |
| 38H | 80 | 25,000- | DME/5%-45% | <0.2 | A | A | =>90 |
| | | 125,000 | | | | | |
| 38I | 90 | 25,000- | DME/5%-45% | <0.2 | A | A | =>90 |
| | | 125,000 | | | | | |
| 38J | 100 | 25,000- | DME/5%-45% | <0.2 | A | A | =>90 |
| | | 125,000 | | | | | |
| 39A | 10 | 25,000- | HFC-134a/5%- | <0.2 | A | A | =>90 |
| | | 125,000 | 45% | | | | |
| 39B | 20 | 25,000- | HFC-134a/5%- | <0.2 | A | A | =>90 |
| | | 125,000 | 45% | | | | |
| 39C | 30 | 25,000- | HFC-134a/5%- | <0.2 | A | A | =>90 |
| | | 125,000 | 45% | | | | |
| 39D | 40 | 25,000- | HFC-134a/5%- | <0.2 | A | A | =>90 |
| | | 125,000 | 45% | | | | |
| 39E | 50 | 25,000- | HFC-134a/5%- | <0.2 | A | A | =>90 |
| | | 125,000 | 45% | | | | |
| 39F | 60 | 25,000- | HFC-134a/5%- | <0.2 | A | A | =>90 |
| | | 125,000 | 45% | | | | |
| 39G | 70 | 25,000- | HFC-134a/5%- | <0.2 | A | A | =>90 |
| | | 125,000 | 45% | | | | |
| 39H | 80 | 25,000- | HFC-134a/5%- | <0.2 | A | A | =>90 |
| | | 125,000 | 45% | | | | |
| 39I | 90 | 25,000- | HFC-134a/5%- | <0.2 | A | A | =>90 |
| | | 125,000 | 45% | | | | |
| 39J | 100 | 25,000- | HFC-134a/5%- | <0.2 | A | A | =>90 |
| | | 125,000 | 45% | | | | |
| 40A | 10 | 25,000- | 1336mzz(E)/5%-45% | <0.2 | A | A | =>90 |
| | | 125,000 | | | | | |
| 40B | 20 | 25,000- | 1336mzz(E)/5%-45% | <0.2 | A | A | =>90 |
| | | 125,000 | | | | | |
| 40C | 30 | 25,000- | 1336mzz(E)/5%-45% | <0.2 | A | A | =>90 |
| | | 125,000 | | | | | |
| 40D | 40 | 25,000- | 1336mzz(E)/5%-45% | <0.2 | A | A | =>90 |
| | | 125,000 | | | | | |
| 40E | 50 | 25,000- | 1336mzz(E)/5%- | <0.2 | A | A | =>90 |
| | | 125,000 | 45% | | | | |
| 40F | 60 | 25,000- | 1336mzz(E)/5%-45% | <0.2 | A | A | =>90 |
| | | 125,000 | | | | | |
| 40G | 70 | 25,000- | 1336mzz(E)/5%-45% | <0.2 | A | A | =>90 |
| | | 125,000 | | | | | |
| 40H | 80 | 25,000- | 1336mzz(E)/5%-45% | <0.2 | A | A | =>90 |
| | | 125,000 | | | | | |
| 40I | 90 | 25,000- | 1336mzz(E)/5%-45% | <0.2 | A | A | =>90 |
| | | 125,000 | | | | | |
| 40J | 100 | 25,000- | 1336mzz(E)/5%- | <0.2 | A | A | =>90 |
| | | 125,000 | 45% | | | | |
| 41A | 10 | 25,000- | 1336mzz(Z)/5%- | <0.2 | A | A | =>90 |
| | | 125,000 | 45% | | | | |
| 41B | 20 | 25,000- | 1336mzz(Z)/5%- | <0.2 | A | A | =>90 |
| | | 125,000 | 45% | | | | |
| 41C | 30 | 25,000- | 1336mzz(Z)/5%-45% | <0.2 | A | A | =>90 |
| | | 125,000 | | | | | |
| 41D | 40 | 25,000- | 1336mzz(Z)/5%-45% | <0.2 | A | A | =>90 |
| | | 125,000 | | | | | |
| 41E | 50 | 25,000- | 1336mzz(Z)/5%- | <0.2 | A | A | =>90 |
| | | 125,000 | 45% | | | | |
| 41F | 60 | 25,000- | 1336mzz(Z)/5%-45% | <0.2 | A | A | =>90 |
| | | 125,000 | | | | | |
| 41G | 70 | 25,000- | 1336mzz(Z)/5%-45% | <0.2 | A | A | =>90 |
| | | 125,000 | | | | | |
| 41H | 80 | 25,000- | 1336mzz(Z)/5%- | <0.2 | A | A | =>90 |
| | | 125,000 | 45% | | | | |
| 41I | 90 | 25,000- | 1336mzz(Z)/5%-45% | <0.2 | A | A | =>90 |
| | | 125,000 | | | | | |
| 41J | 100 | 25,000- | 1336mzz(Z)/5%-45% | <0.2 | A | A | =>90 |
| | | 125,000 | | | | | |
| 42A | 10 | 25,000- | 1233zd(E)/5%- | <0.2 | A | A | =>90 |
| | | 125,000 | 45% | | | | |
| 42B | 20 | 25,000- | 1233zd(E)/5%- | <0.2 | A | A | =>90 |
| | | 125,000 | 45% | | | | |
| 42C | 30 | 25,000- | 1233zd(E)/5%- | <0.2 | A | A | =>90 |
| | | 125,000 | 45% | | | | |
| 42D | 40 | 25,000- | 1233zd(E)/5%- | <0.2 | A | A | =>90 |
| | | 125,000 | 45% | | | | |
| 42E | 50 | 25,000- | 1233zd(E)/5%- | <0.2 | A | A | =>90 |
| | | 125,000 | 45% | | | | |
| 42F | 60 | 25,000- | 1233zd(E)/5%- | <0.2 | A | A | =>90 |
| | | 125,000 | 45% | | | | |
| 42G | 70 | 25,000- | 1233zd(E)/5%- | <0.2 | A | A | =>90 |
| | | 125,000 | 45% | | | | |
| 42H | 80 | 25,000- | 1233zd(E)/5%- | <0.2 | A | A | =>90 |
| | | 125,000 | 45% | | | | |
| 42I | 90 | 25,000- | 1233zd(E)/5%- | <0.2 | A | A | =>90 |
| | | 125,000 | 45% | | | | |
| 42J | 100 | 25,000- | 1233zd(E)/5%- | <0.2 | A | A | =>90 |
| | | 125,000 | 45% | | | | |
| 43A | 10 | 25,000- | 1224yd(Z)/5%- | <0.2 | A | A | =>90 |
| | | 125,000 | 45% | | | | |
| 43B | 20 | 25,000- | 1224yd(Z)/5%- | <0.2 | A | A | =>90 |
| | | 125,000 | 45% | | | | |
| 43C | 30 | 25,000- | 1224yd(Z)/5%- | <0.2 | A | A | =>90 |
| | | 125,000 | 45% | | | | |
| 43D | 40 | 25,000- | 1224yd(Z)/5%- | <0.2 | A | A | =>90 |
| | | 125,000 | 45% | | | | |
| 43E | 50 | 25,000- | 1224yd(Z)/5%- | <0.2 | A | A | =>90 |
| | | 125,000 | 45% | | | | |
| 43F | 60 | 25,000- | 1224yd(Z)/5%- | <0.2 | A | A | =>90 |
| | | 125,000 | 45% | | | | |
| 43G | 70 | 25,000- | 1224yd(Z)/5%- | <0.2 | A | A | =>90 |
| | | 125,000 | 45% | | | | |
| 43H | 80 | 25,000- | 1224yd(Z)/5%- | <0.2 | A | A | =>90 |
| | | 125,000 | 45% | | | | |
| 43I | 90 | 25,000- | 1224yd(Z)/5%- | <0.2 | A | A | =>90 |
| | | 125,000 | 45% | | | | |
| 43J | 100 | 25,000- | 1224yd(Z)/5%- | <0.2 | A | A | =>90 |
| | | 125,000 | 45% | | | | |

*butane refers separately and independently to each of iso and normal butane
**pentane refers separately and independently to each of iso, normal, neo and cyclo-pentane
***A-acceptable

### Example 44A and 44B—PEF Homopolymer Preparation with MW of about 75 Kg/Mol and 90.8 Kg/Mol with PMDA and SSP

Two homopolymers of PEF were with polymer molecular weights of about 75,000 g/mol and about 91,000 g/mol. In particular, the 75 kg/mol PEF homopolymer was formed by esterification and polycondensation of 350 grams of 2,5-furandicarboxylic acid (FDCA) with 279 grams of mono-ethylene glycol (EG). The reactants were added to a 1-liter cylindrical steel reactor equipped with an overhead stirrer and a distillation/condensation apparatus. After pulling vacuum and back filling with nitrogen, 0.288 gram of titanium (IV) isopropoxide catalyst was added to the flask. The flask was then lowered into a 180° C. salt bath and overhead mixing was started at 200 rpm under a nitrogen atmosphere. After 2.5 hours, the bath temperature was increased to 210° C. After 30 minutes at this temperature under nitrogen, vacuum was started. After 40 minutes under vacuum, the temperature was increased to 230° C. and was continued for 1 hour. Under a stream of nitrogen, PMDA (2.73 g-0.7% by weight) was slowly added over the span of about 5 minutes. An additional 30 minutes of mixing at temperature were allowed before stopping the reaction. To perform SSP, an aliquot (30 g) of the product was ground and heated at 180° C. under vacuum for 3 days on a rotary evaporator to produce the PEF homopolymer as reported below.

For the 90.8 kg/mol MW polymer, FDCA (75 g) and EG (59.6 g) were added to a 500 mL cylindrical steel reactor equipped with an overhead stirrer and a distillation/condensation apparatus. After pulling vacuum and back filling with nitrogen, 0.100 gram of titanium (IV) isopropoxide catalyst was added to the flask. The flask was then lowered into a 180° C. salt bath and overhead mixing was started at 200 rpm under a nitrogen atmosphere. After 2.5 hours, the bath temperature was increased to 210° C. After 30 minutes at this temperature under nitrogen, vacuum was started. After 40 min under vacuum, the temperature was increased to 250° C. and was continued for 2 hours. Under a stream of nitrogen, PMDA (0.587 g) was slowly added over the span of about 5 minutes. The reaction was stopped after an additional 30 minutes of mixing at temperature. The product was removed from the vessel. Gamma-valerolactone was added to dissolve the polymer that was remaining in the reactor and on the impeller. The mixture was stirred for several hours at 190° C. The gamma-valerolactone was distilled from the polymer under vacuum resulting in a solid. To perform SSP, an aliquot (30 g) of the product was ground and heated at 180° C. under vacuum for 3 days on a rotary evaporator to produce the PEF homopolymer as reported below. The polymer was then subject to solid state polymerization according to known techniques to produce the PEF homopolymer as reported below.

The PEF polymers thus produced were tested using the measurement protocols as described above and found to have the characteristics reported in Table E44 below:

TABLE E44

| | Example 44A | Example 44B |
|---|---|---|
| | (PEF44A) | (PEF44B) |
| Molecular Weight, g/mol | 75,000 | 90,800 |
| Glass Transition | 90.2 | 92 |
| Temperature, ° C. | | |
| Melt Temperature, ° C. | 222 | 202 |
| Decomposition | 346 | 335 |
| Temperature, ° C. | | |
| Crystallinity, % | 42 | 54 |

The PEF polymers produced in these examples are referred to in Table E47 above and hereinafter as PEF44A and PEF44B.

### Examples 45A-45G—PEF Foam Preparation Using PEF44A and PEF44B with Trans1234ze Blowing Agent

Three foams were made from PEF44A, and four foams were made using PEF44B as described herein using foaming processes that were designed using the same criteria as described in Example 1. The foams thus produced were tested and found to have the properties as reported in Table E45 below.

TABLE E45

| Example→ | E45A | E45B | E45C | E45D | E45E | E45F | E45G |
|---|---|---|---|---|---|---|---|
| MATERIALS | | | | | | | |
| Polymer (MW, | PEF44A | PEF44A | PEF44A | PEF44 B | PEF44B | PEF44B | PEF44B |
| K) | (75) | (75) | (75) | (90.8) | (90.8) | (90.8) | (90.8) |
| Blowing Agent* | 1234ze | 1234ze | 1234ze(E) | 1234ze(E) | 1234ze(E) | 1234ze(E) | 1234ze(E) |
| | (E) | (E) | | | | | |
| Blowing Agent, | 0.35 | 0.26 | 0.35 | 0.22 | 0.26 | 0.22 | 0.22 |
| (moles) | | | | | | | |
| CONDITION | | | | | | | |
| Melt Temp., ° C. | 240 | 240 | 240 | 240 | 240 | 240 | 240 |
| Melt Press., | 1408 | 948 | 1417 | 665 | 881 | 604 | 609 |
| psig | | | | | | | |
| Pre-foaming | 190 | 190 | 190 | 190 | 190 | 190 | 190 |
| Temp., ° C. | | | | | | | |
| Pre-foaming | 1080 | 764 | 1080 | 548 | 722 | 508 | 508 |
| Press., psig | | | | | | | |
| FOAM | | | | | | | |
| PROPERTIES | | | | | | | |
| RFD | 0.046 | 0.061 | 0.077 | 0.077 | 0.08 | 0.082 | 0.084 |
| Avg. RFD | .0535 | | 0.08 | | | | |
| Tensile | 1.25 | 0.99 | 2.09 | 2.97 | 2.64 | 2.81 | 3.09 |
| Strength, | | | | | | | |
| megapascal | | | | | | | |
| Avg. TS | 1.12 | | 2.7 | | | | |
| Compressive | 0.64 | 0.4 | 0.4 | 0.8 | 0.41 | 1.29 | 0.97 |
| Strength, | | | | | | | |
| megapascal | | | | | | | |

| | | |
|---|---|---|
| Avg. CS | 0.52 | 0.78 |

The tensile strength and compressive strength of the PEF foams of this example are determined and found to be unexpectedly high. For example, even though the foam made with CO₂ in Comparative Example 1 had a much higher density and with a polymer of higher molecular weight, the foams of this Example have a tensile strength that is, on average, at least 1.5 times the strength of the foams made with CO₂ of Comparative Example 1.

### Example 46A and 46B—PEF Homopolymer Preparation with MW of about 49 Kg/Mol with PMDA and SSP

A homopolymer of PEF was made using the same additives and basic polymer formation procedures as were in Example 45 to achieve polymer molecular weight of about 49,000 g/mol. In particular, the 49 kg/mol MW PEF homopolymer was formed by esterification and polycondensation of 75 grams of 2,5-furandicarboxylic acid (FDCA) with 59.8 grams of mono ethylene glycol (EG). The reactants were added to a 500 mL cylindrical steel reactor equipped with an overhead stirrer and a distillation/condensation apparatus. After pulling vacuum and back filling with nitrogen, 0.067 gram of titanium (IV) isopropoxide catalyst was added to the flask. The flask was then lowered into a 180° C. salt bath and overhead mixing was started at 200 rpm under a nitrogen atmosphere. After 2.5 hours, the bath temperature was increased to 210° C. After 30 minutes at this temperature under nitrogen, vacuum was started. After 40 minutes under vacuum, the temperature was increased to 230° C. and was continued for 1 hour. Under a stream of nitrogen, 0.59 gram (0.7% by weight) of PMDA wase slowly added over a time of about 5 minutes. To perform SSP, an aliquot (30 g) of the product was ground and heated at 180° C. under vacuum for 3 days on a rotary evaporator to produce the PEF homopolymer as reported below. The PEF homopolymer was tested using the same measurement techniques as described in Example 1 and found to have the characteristics reported in Table E46 below:

TABLE E46

| | Example 46 (PEF45) |
|---|---|
| Molecular Weight, g/mol | 49,000 |
| Glass Transition Temperature, ° C. | 92 |
| Melt Temperature, ° C. | 220 |
| Decomposition Temperature, ° C. | 340 |
| Crystallinity, % | 43 |

The PEF polymer so produced is referred to in Table E45 and in the Examples hereinafter as PEF45.

### Examples 47A-47C: PEF Foam Preparation Using PEF45 and Trans1234ze as Blowing Agent

Three foams were made from PEF45 as described herein using foaming processes that were designed using the same criteria as described in Example 1. The foams thus produced were tested and found to have the properties as reported in Table E47 below:

TABLE E47

| | Example | | |
|---|---|---|---|
| MATERIALS | E47A | E47B | E47C |
| Polymer (MW, K) | PEF45 (49) | PEF45 (49) | PEF45 (49) |
| Blowing Agent* | 1234ze(E) | 1234ze(E) | 1234ze(E) |
| Blowing Agent, (moles) | 0.22 | 0.26 | 0.26 |
| CONDITION | | | |
| Melt Temp., ° C. | 240 | 240 | 240 |
| Melt Press., | 680 | 933 | 925 |
| Pre-foaming Temp., ° C. | 190 | 190 | 190 |
| Pre-foaming Press., psig | 560 | 746 | 746 |
| FOAM PROP | | | |
| RFD | 0.08 | 0.094 | 0.064 |
| Avg. RFD | 0.079 | | |
| Tensile Strength, | 0.82 | 2.07 | 1.46 |
| megapascal | | | |
| Avg. TS | 1.45 | | |
| Compressive Strength, | 0.81 | 0.73 | 0.33 |
| megapascal | | | |

| | |
|---|---|
| Avg. CS | 0.62 |

The tensile strength and compressive strength of the PEF foams of this example are determined and found to be unexpectedly high. For example, even though the foam made with CO₂ in Comparative Example 1 had a much higher density and was made from a polymer having a much higher molecular weight, the foams of this Example have a tensile strength that is, on average, about 2 times the strength of the foams made with CO₂ of Comparative Example 1.

### Example 48—PEF Homopolymer Preparation with MW of 33 Kg/Mol with PMDA and SSP

A homopolymer of PEF was made using the same additives and basic polymer formation procedures as were used to form the PEF homopolymer of Example 45 to achieve polymer molecular weight of about 30,000 kg/mol. In particular, the PEF homopolymer was formed by esterification and polycondensation of 2,5-furandicarboxylic acid with mono-ethylene glycol according to methods consistent with those described herein to produce PEF homopolymer, which is then treated according to known techniques with PMDA at 0.7% by weight. The polymer then undergoes solid state polymerization consistent with the prior examples to produce a PEF homopolymer. The PEF polymer was tested using the same measurement techniques as described in Example 1 and found to have the characteristics reported in Table E48 below:

TABLE E48

| | Example 48 |
|---|---|
| Designation | PEF48 |
| Molecular Weight, g/mol | 33,000 |
| Glass Transition Temperature, ° C. | 90.5 |
| Melt Temperature, ° C. | 224 |
| Decomposition Temperature, ° C. | 341 |
| Crystallinity, % | 45 |

The PEF polymer produced in this Example is referred to Table E48 above and hereinafter as PEF48.

### Examples 49A and 49B: PEF Foam Preparation Using PEF48 and Trans1234ze as Blowing Agent

Two foams were made from PEF48 using foaming processes that were designed using the same criteria as described in these examples. The foams thus produced were tested and found to have the properties as reported in Table E49 below:

TABLE E49

Example

| MATERIALS | E49A | E49B |
|---|---|---|
| Polymer (MW, kg/mol) | PEF48 (33) | PEF48 (33) |
| Blowing Agent* | 1234ze(E) | 1234ze(E) |
| Blowing Agent, (moles) | 0.21 | 0.12 |
| CONDITION | | |
| Melt Temp., ° C. | 240 | 240 |
| Melt Press., | 553 | 268 |
| Pre-foaming Temp., ° C. | 190 | 190 |
| Pre-foaming Press., psig | 474 | 240 |
| FOAM PROP | | |
| RFD | 0.08 | 0.081 |

| | |
|---|---|
| Avg. RFD | 0.0805 |

| | | |
|---|---|---|
| Tensile Strength, megapascal | 1.45 | 1.44 |

| | |
|---|---|
| Avg. TS | 1.445 |

| | | |
|---|---|---|
| Compressive Strength, | 0.33 | 0.67 |
| megapascal | | |

| | |
|---|---|
| Avg. CS | 0.5 |

The tensile strength and compressive strength of the PEF foams of this example were tested and found to be unexpectedly high. For example, even though the foam made with CO₂ in Comparative Example 1 had a much higher density and was made from a polymer having a much higher molecular weight, the foams of this Example have a tensile strength that is, on average, about 2 times the strength of the foams made with CO₂ of Comparative Example 1.

### Example 50—PEF Homopolymer Preparation with MW of 58 Kg/Mol with PMDA and SSP

A homopolymer of PEF was made using the same additives and basic polymer formation procedures as were used to form the PEF homopolymer of Example 45 to achieve polymer molecular weight of about 58,000 kg/mol. In particular, the PEF homopolymer was formed by esterification and polycondensation of 2,5-furandicarboxylic acid with mono-ethylene glycol according to methods consistent with those described herein to produce PEF homopolymer, which is then treated according to known techniques with PMDA at 0.7% by weight. The polymer then undergoes solid state polymerization consistent with the prior examples to produce a PEF homopolymer. The PEF polymer was tested using the same measurement techniques as described in Example 1 and found to have the characteristics reported in Table E49 below:

TABLE E50

| | Example 50 |
|---|---|
| Designation | PEF50 |
| Molecular Weight, g/mol | 58,000 |
| Glass Transition Temperature, ° C. | 90.6 |
| Melt Temperature, ° C. | 222 |
| Decomposition Temperature, ° C. | 347 |
| Crystallinity, % | 46 |

The PEF polymer produced in this Example is referred to Table E50 above and hereinafter as PEF50.

### Examples 51A and 51B: PEF Foam Preparation Using PEF49 and Trans1233zd and Trans1234ze+Trans1233zd as Blowing Agent

Two foams were made from PEF50 using foaming processes that were designed using the same criteria as described in these examples. The foam E51B in the table below was made with a 50:50 molar ratio of trans1233zd(E):1234zd(E). The foams thus produced were tested and found to have the properties as reported in Table E51 below:

TABLE E51

Example

| MATERIALS | E51A | E51B |
|---|---|---|
| Polymer (MW, kg/mol) | PEF50 (58) | PEF50 (58) |
| Blowing Agent* | 1233zd(E) | 1233zd(E) + |
| | | 1234ze(E) |
| Blowing Agent, (moles) | 0.4 | 0.29 |
| CONDITION | | |
| Melt Temp., ° C. | 240 | 240 |
| Melt Press., | 725 | 705 |
| FOAM PROP. | | |
| RFD | 0.182 | 0.150 |
| Tensile Strength, | 0.51 | 0.75 |
| megapascal | | |
| Compressive Strength, | 0.26 | 1.04 |
| megapascal | | |

As can be seen from the Table E51 above, the foam of the present invention made using 1233zd(E) as the sole blowing agent (Example E51A) formed a foam with an RFD of 0.182 and had a tensile strength of 0.51 megapascals and a compressive strength of 0.26 megapascals. The foam made by adding 1234ze(E) as a blowing agent (Example 51B) produced a foam with a foam with a lower density, but which unexpectedly and surprisingly is much stronger in terms of both tensile strength and the compressive strength. This example thus provides further evidence of the unexpected advantage provided by using 1234ze(E) as a blowing agent according to the present invention. Furthermore, even though the foam made with CO₂ in Comparative Example 1 had a much higher density and was made from a polymer having a much higher molecular weight than Example 51B, the foams of Example 51B have a comparable tensile strength and a compressive strength that is more than 2 times the compressive strength of the foams made with CO₂ of Comparative Example 1.

The following clauses provide descriptions within the scope of the present invention.

Clause 1. A low-density, thermoplastic foam comprising:
(a) thermoplastic polymer cells comprising cell walls forming closed cells, wherein ethylene furanoate moieties are at least 50% by weight of the thermoplastic polymer; and
(b) one or more HFOs having three or four carbon atoms and/or one or more HFCOs having three or four carbon atoms contained in the closed cells.

Clause 2. The foam of clause 1 wherein said cell walls consisting essentially of polyethylene furanoate that has been treated with a chain extender.

Clause 3. The foam of clause 1 wherein said cell walls consist essentially of polyethylene furanoate having a molecular weight of greater than 25,000.

Clause 4. The foam of clause 1 wherein ethylene furanoate moieties are at least 70% by weight of the thermoplastic polymer.

Clause 5. The foam of clause 1 wherein ethylene furanoate moieties are at least 90% by weight of the thermoplastic polymer.

Clause 6. The foam of clause 1 wherein said foam has a relative foam density (RFD) of about 0.2 or less.

Clause 7. The foam of clause 1 wherein said foam has a foam density of less than 0.4 g/cc.

Clause 8. The foam of clause 1 wherein said foam has a foam density of less than 0.2 g/cc.

Clause 9. The foam of clause 1 wherein said one or more blowing agents contained in said closed cells comprise one or more of 1224yd, 1233zd(E), 1234yf, 1234ze(E), 1336mzz(E) and 1336mzz(Z).

Clause 10. The foam of clause 9 wherein said cell walls consist essentially of polyethylene furanoate having a molecular weight of greater than 100,000.

Clause 11. The foam of clause 1 wherein said one or more blowing agents contained in said closed cells comprise at least 1234ze(E).

Clause 12. The foam of clause 11 wherein said cell walls consist essentially of polyethylene furanoate having a molecular weight of greater than 100,000 and wherein said foam has a relative foam density (RFD) of about 0.2 or less.

Clause 13. The foam of clause 1 wherein said one or more blowing agents contained in said closed cells comprise at least 1336mzz(Z).

Clause 14. The foam of clause 13 wherein said cell walls consist essentially of polyethylene furanoate having a molecular weight of greater than 100,000 and wherein said foam has a relative foam density (RFD) of about 0.2 or less.

Clause 15. The foam of clause 1 wherein said one or more blowing agents contained in said closed cells comprise at least 1336mzz(Z) and/or 1234ze(E).

Clause 16. The foam of clause 15 wherein said cell walls consist essentially of polyethylene furanoate having a molecular weight of greater than 100,000 and wherein said foam has a relative foam density (RFD) of about 0.2 or less.

Clause 17. A wind energy turbine blade and/or nacelle comprising a foam according to anyone of clauses 1-16.

Clause 18. An automobile car wall comprising a foam according to anyone of clauses 1-16.

Clause 19. A marine vessel comprising a foam according to anyone of clauses 1-16.

Clause 20. An aircraft or aerospace vessel comprising a foam according to anyone of clauses 1-16.

Clause 21. A low-density, thermoplastic foam comprising:
(a) thermoplastic polymer cells comprising cell walls forming closed cells, wherein ethylene furanoate moieties are at least 50% by weight of the thermoplastic polymer; and
(b) one or more HFOs having three or four carbon atoms and/or one or more HFCOs having three or four carbon atoms contained in the closed cells.

Clause 22. A low-density, thermoplastic foam comprising:
(a) closed thermoplastic cells comprising cell walls forming closed cells, said cell walls consisting essentially of polyethylene furanoate that has been treated with a chain extender and that has a molecular weight of greater than 25,000; and
(b) one or more HFOs having three or four carbon atoms and/or one or more HFCOs having three or four carbon atoms contained in the closed cells.

Clause 23. A low-density, thermoplastic foam comprising:
(a) closed thermoplastic cells comprising cell walls comprising polyethylene furanoate that has been treated with a chain extender and that has a molecular weight of greater than 25,000, wherein ethylene furanoate moieties are at least 70% by weight of the thermoplastic polymer; and
(b) one or more HFOs having three or four carbon atoms and/or one or more HFCOs having three or four carbon atoms contained in the closed cells.

Clause 24. A low-density, closed-cell thermoplastic foam comprising:
(a) closed thermoplastic cells comprising cell walls comprising polyethylene furanoate that has been treated with a chain extender and that has a molecular weight of greater than 25,000, wherein ethylene furanoate moieties are at least 90% of the thermoplastic contains ethylene furanoate moieties; and
(b) one or more HFOs having three or four carbon atoms and/or one or more HFCOs having three or four carbon atoms contained in the closed cells.

Clause 25A. A includes low-density, closed-cell thermoplastic foam comprising:
(a) closed thermoplastic cells comprising cell walls consisting essentially of polyethylene furanoate that has been treated with a chain extender; and
(b) a blowing agent contained in said closed cells,
   wherein said foam has a relative foam density (RFD) of about 0.2 or less and a foam density of less than 0.3 g/cc.

Clause 25B. A includes low-density, thermoplastic foam comprising:
(a) thermoplastic polymer cells comprising cell walls wherein at least about 50% by volume of the cells are closed cells and wherein ethylene furanoate moieties are at least 50% by weight of the thermoplastic polymer; and
(b) one or more HFOs having three or four carbon atoms and/or one or more HFCOs having three or four carbon atoms contained in the closed cells.

Clause 25C. A includes low-density, thermoplastic foam comprising:
(a) thermoplastic polymer cells comprising cell walls comprising polyethylene furanoate that has been treated with a chain extender and that has a molecular weight of greater than 25,000, wherein ethylene furanoate moieties are at least 50% of the thermoplastic and wherein at least about 50% by volume of the cells are closed cells; and
(b) one or more HFOs having three or four carbon atoms and/or one or more HFCOs having three or four carbon atoms contained in the closed cells.

Clause 25D. A includes low-density, thermoplastic foam comprising:
(a) thermoplastic polymer cells comprising cell walls comprising polyethylene furanoate that has been treated with a chain extender and that has a molecular weight of greater than 25,000, wherein ethylene furanoate moieties are at least 50% of the thermoplastic and wherein at least about 75% by volume of the cells are closed cells; and
(b) one or more HFOs having three or four carbon atoms and/or one or more HFCOs having three or four carbon atoms contained in the closed cells.

Clause 25E. A includes low-density, thermoplastic foam comprising:
(a) thermoplastic polymer cells comprising cell walls comprising polyethylene furanoate that has been treated with a chain extender and that has a molecular weight of greater than 25,000, wherein ethylene furanoate moieties are at least 50% of the thermoplastic and wherein at least about 90% by volume of the cells are closed cells; and
(b) one or more HFOs having three or four carbon atoms and/or one or more HFCOs having three or four carbon atoms contained in the closed cells.

Clause 26. A includes low-density, closed-cell thermoplastic foam comprising:
(a) closed thermoplastic cells comprising cell walls consisting essentially of polyethylene furanoate that has been treated with a chain extender; and
(b) a blowing agent contained in said closed cells,
   wherein said foam has an RFD of about 0.2 or less and a density of less than 0.3 g/cc.

Clause 27. A low-density, closed-cell thermoplastic foam comprising:
(a) closed thermoplastic cells comprising cell walls consisting essentially of polyethylene furanoate that has been treated with a chain extender; and
(b) a blowing agent contained in said closed cells,
   wherein said foam has a density of less than 0.25 g/cc.

Clause 28A. A low-density, closed-cell thermoplastic foam comprising:
(a) thermoplastic polymer cells comprising cell walls comprising polyethylene furanoate that has been treated with a chain extender and that has a molecular weight of greater than 50,000, wherein ethylene furanoate moieties are at least 50% of the thermoplastic and wherein at least about 50% by volume of the cells are closed cells; and
(b) one or more HFOs having three or four carbon atoms and/or one or more HFCOs having three or four carbon atoms contained in the closed cells.

Clause 28B. A low-density, closed-cell thermoplastic foam comprising:
(a) thermoplastic polymer cells comprising cell walls comprising polyethylene furanoate that has been treated with a chain extender and that has a molecular weight of greater than 50,000, wherein ethylene furanoate moieties are at least 50% of the thermoplastic and wherein at least about 75% by volume of the cells are closed cells; and
(b) one or more HFOs having three or four carbon atoms and/or one or more HFCOs having three or four carbon atoms contained in the closed cells.

Clause 28C. A low-density, closed-cell thermoplastic foam comprising:
(a) closed thermoplastic cells comprising cell walls consisting essentially of polyethylene furanoate that has been treated with a chain extender and that has a molecular weight of greater than 100,000; and
(b) a blowing agent contained in said closed cells, wherein said foam has a density of less than 0.3 g/cc.

Clause 29 A low-density, closed-cell thermoplastic foam comprising:
(a) closed thermoplastic cells comprising cell walls consisting essentially of polyethylene furanoate that has been treated with a chain extender; and
(b) a blowing agent contained in said closed cells and comprising one or more HFOs having three or four carbon atoms and/or one or more HFCOs having three or four carbon atoms, wherein said foam has a density of less than 0.3 g/cc.

Clause 30. A low-density, closed-cell thermoplastic foam comprising:
(a) closed thermoplastic cells comprising cell walls consisting essentially of polyethylene furanoate that has been treated with a chain extender; and
(b) a blowing agent contained said closed cells and comprising one or more HFOs having three or four carbon atoms and/or one or more HFCOs having three or four carbon atoms, wherein said foam has a density of less than 0.25 g/cc.

Clause 31. A low-density, closed-cell thermoplastic foam comprising:
(a) thermoplastic polymer cells comprising cell walls forming closed cells, wherein ethylene furanoate moieties are at least 50% by weight of the thermoplastic polymer and wherein said thermoplastic comprises polyethylene furanoate-based polymer that has been treated with a chain extender and that has a molecular weight of greater than 25,000; and
(b) one or more blowing agents contained in said closed cells, said blowing agent comprising one or more of 1224yd, 1233zd(E), 1234yf, 1234ze(E), 1336mzz(E) and 1336mzz(Z).

Clause 32. A low-density, closed-cell thermoplastic foam comprising:
(a) thermoplastic polymer cells comprising cell walls forming closed cells, wherein ethylene furanoate moieties are at least 70% by weight of the thermoplastic polymer and wherein said thermoplastic comprises polyethylene furanoate-based polymer that has been treated with a chain extender and that has a molecular weight of greater than 100,000; and
(b) one or more blowing agents contained in said closed cells, said blowing agent comprising one or more of 1224yd, 1233zd(E), 1234yf, 1234ze(E), 1336mzz(E) and 1336mzz(Z).

Clause 33. A low-density, closed-cell thermoplastic foam comprising:
(a) thermoplastic polymer cells comprising cell walls forming closed cells, wherein ethylene furanoate moieties are at least 90% by weight of the thermoplastic polymer and wherein said thermoplastic comprises polyethylene furanoate-based polymer that has been treated with a chain extender and that has a molecular weight of greater than 100,000; and
(b) one or more blowing agents contained in said closed cells, said blowing agent comprising one or more of 1224yd, 1233zd(E), 1234yf, 1234ze(E), 1336mzz(E) and 1336mzz(Z).

Clause 34. A low-density, closed-cell thermoplastic foam comprising:
(a) thermoplastic polymer cells comprising cell walls forming closed cells, wherein ethylene furanoate moieties are at least 90% by weight of the thermoplastic polymer and wherein said thermoplastic comprises has a molecular weight of greater than 100,000; and
(b) one or more blowing agents contained in said closed cells, said blowing agent comprising one or more of 1234ze(E), 1336mzz(E) and 1336mzz(Z).

Clause 35. A low-density, closed-cell thermoplastic foam comprising:
(a) thermoplastic polymer cells comprising cell walls forming closed cells, wherein ethylene furanoate moieties are at least 90% by weight of the thermoplastic polymer and wherein said thermoplastic comprises has a molecular weight of greater than 100,000; and
(b) one or more blowing agents contained in said closed cells, said blowing agent consisting essentially of 1234ze(E).

Clause 36. A includes low-density, closed-cell thermoplastic foam comprising:
(a) thermoplastic polymer cells comprising cell walls forming closed cells, wherein ethylene furanoate moieties are at least 90% by weight of the thermoplastic polymer and wherein said thermoplastic comprises has a molecular weight of greater than 100,000; and
(b) one or more blowing agents contained in said closed cells, said blowing agent consisting essentially of 1336mzz(E).

Clause 37. A low-density, closed-cell thermoplastic foam comprising:
(a) closed thermoplastic cells comprising cell walls consisting essentially of polyethylene furanoate; and
(b) trans-1234ze contained in said closed cells,
   wherein said foam has a density of less than 0.3 g/cc.

Clause 38. A low-density, closed-cell thermoplastic foam comprising:
(a) closed thermoplastic cells comprising cell walls consisting essentially of polyethylene furanoate; and
(b) HFO-1234yf contained in said closed cells,
   wherein said foam has a density of less than 0.3 g/cc.

Clause 39. A low-density, closed-cell thermoplastic foam comprising:
(a) closed thermoplastic cells comprising cells walls consisting essentially of polyethylene furanoate; and
(b) 1336mzz(E) contained in said closed cells,
   wherein said foam has a density of less than 0.3 g/cc.

Clause 40. A low-density, closed-cell thermoplastic foam comprising:
(a) closed thermoplastic cells comprising cells walls consisting essentially of polyethylene furanoate; and
(b) 1336mzz(Z) contained in said closed cells,
   wherein said foam has a density of less than 0.3 g/cc.

Clause 41. A low-density, closed-cell thermoplastic foam comprising:
(a) closed thermoplastic cells comprising cells walls consisting essentially of polyethylene furanoate; and
(b) 1224yd contained in said closed cells,
   wherein said foam has a density of less than 0.3 g/cc.

Clause 42. A foamable thermoplastic compositions comprising:
(a) thermoplastic material consisting essentially of polyethylene furanoate that has been treated with a chain extender and that has a molecular weight of greater than 25,000, wherein at least 50% of the thermoplastic contains ethylene furanoate moieties; and
(b) one or more HFOs having three or four carbon atoms and/or one or more HFCOs having three or four carbon atoms.

Clause 43. A foamable thermoplastic compositions comprising:
(a) thermoplastic material consisting essentially of polyethylene furanoate having a molecular weight of greater than 100,000, wherein at least 50% of the thermoplastic contains ethylene furanoate moieties;
(b) one or more HFOs having three or four carbon atoms and/or one or more HFCOs having three or four carbon atoms.

Clause 44. A foamable thermoplastic compositions comprising:
(a) thermoplastic material consisting essentially of chain-extended polyethylene furanoate having a molecular weight of greater than 100,000, wherein at least 90% of the thermoplastic contains ethylene furanoate moieties; and
(b) one or more HFOs having three or four carbon atoms and/or one or more HFCOs having three or four carbon atoms contained in said closed cells.

Clause 45. Methods for forming thermoplastic foam comprising foaming a foamable composition of the present invention, including each of Clauses 42-44.

Clause 46. Methods for forming extruded thermoplastic foam comprising extruding a foamable composition of the present invention, including each of Clauses 42-44.

What is claimed is:

1.-30. (canceled)

31. A low-density, thermoplastic foam comprising:
(a) thermoplastic polymer cells comprising cell walls comprising polyethylene furanoate, wherein at least about 50% by volume of the cells are closed cells; and
(b) at least HFO-1234ze(E) contained in said closed cells.

32. The foam of claim 31 wherein the density of the foam is from about 0.05 to less than 0.2 g/cc.

33. The foam of claim 32 wherein the tensile strength of the foam is from about 1.5 to about 3.5 Mpa.

34. The foam of claim 32 wherein the compressive strength of the foam is from about 0.65 to about 1.5 Mpa.

35. The foam of claim 33 wherein the compressive strength of the foam is from about 0.65 to about 1.5 Mpa.

36. The foam of claim 32 wherein the foam has a density of from about 0.05 to less than 0.1 g/cc.

37. The foam of claim 35 wherein the foam has a density of from about 0.05 to less than 0.1 g/cc.

38. The foam of claim 32 wherein ethylene furanoate moieties are at least 50% by weight of said thermoplastic polymer.

39. The foam of claim 32 wherein said cell walls consist essentially of polyethylene furanoate.

40. The foam of claim 32 wherein said cell walls consist essentially of polyethylene furanoate having a molecular weight of at least about 90,000.

41. The foam of claim 32 wherein ethylene furanoate moieties are at least 85% by weight of said thermoplastic polymer.

42. The foam of claim 32 wherein at least about 75% of the cells are closed cells.

43. A thermoplastic foam comprising:
(a) thermoplastic polymer cells comprising cell walls comprising polyethylene furanoate having a crystallinity of at least 10%, wherein at least about 50% by volume of the cells are closed cells and wherein said thermoplastic polymer contains no tannin moieties or tannin moieties in an amount of less than 20% by weight; and
(b) gas in said closed cells comprising one or more HFOs having three or four carbon atoms and/or one or more HFCOs having three or four carbon atoms contained in the closed cells.

44. The foam of claim 43 wherein said gas in said closed cells comprising one or more of 1234ze(E), 1336mzz(E), 1336mzz(Z), 1224yd(E), 1224yd(Z), 1233zd(E), 1234yf, and combinations of two or more of these.

45. The foam of claim 43 wherein said gas in said closed cells comprises at least 60% by weight of 1234ze(E) and wherein said cell walls consist essentially of polyethylene furanoate having a molecular weight of at least about 90,000.

46. A wind energy turbine blade and/or nacelle, or an automobile car wall, or an aircraft or aerospace vessel comprising the foam of claim 45.

47. The foamable composition of claim 45 wherein said polyethylene furanoate has a crystallinity of from 30% to 60% by volume.

48. The foamable composition of claim 43 wherein said polyethylene furanoate has a molecular weight of from about 90,000 to about 120,000 and has a crystallinity of from 30% to 60% by volume and wherein said blowing agent comprises at least about 60% by weight of 1234ze(E).

49. The foamable composition of claim 43 wherein said blowing does not comprise 1336mzz.

50. The foamable composition of claim 49 wherein said polyethylene furanoate has a molecular weight of from about 25,000 to about 180,000 and has a crystallinity of from 30% to 60% by volume.
and has a crystallinity of from 30% to 60% by volume and wherein said blowing agent comprises at least about 60% by weight of 1234ze(E).
